(19) United States
(12) Patent Application Publication
(10) Pub. No.: US 2025/0154049 A1
(43) Pub. Date: May 15, 2025

(54) METHODS OF FORMING A FOLDABLE APPARATUS

(71) Applicant: CORNING INCORPORATED, CORNING, NY (US)

(72) Inventors: Indrani Bhattacharyya, Hayward, CA (US); Ling Chen, Shanghai (CN); Wanghui Chen, Shanghai (CN); Jiangwei Feng, Newtown, PA (US); Sushmit Sunil Kumar Goyal, Painted Post, NY (US); Yuhui Jin, Painted Post, NY (US); Peter Joseph Lezzi, Corning, NY (US); Yousef Kayed Qaroush, Painted Post, NY (US)

(21) Appl. No.: 18/839,092

(22) PCT Filed: Feb. 27, 2023
(86) PCT No.: PCT/US2023/013918

§ 371 Date: Aug. 16, 2024

Related U.S. Application Data
(60) Provisional application No. 63/314,588, filed on Feb. 28, 2022.

(51) Int. Cl. C03C 15/00; C03C 23/00

(52) U.S. Cl. CPC C03C 15/00; C03C 23/0075

(57) ABSTRACT

Methods of forming a foldable apparatus can involve contacting an existing first major surface of a foldable substrate with an alkaline solution to remove an outer layer to form a new first major surface. In aspects, the alkaline solution comprises about 10 weight % or more of a hydroxide-containing base and/or a pH of about 14 or more. Methods of forming a foldable apparatus can comprise contacting a first major surface of a foldable substrate with a first alkaline detergent solution under sonication. Methods of forming a foldable apparatus can comprise contacting an existing first major surface of a foldable substrate with an acidic solution having a pH from about 3.3 to about 3.5 and a fluorine-containing compound. Methods of forming a foldable apparatus can comprise contacting an existing first major surface of a foldable substrate with a solution comprising fluorosilicic acid.

### CROSS-REFERENCE TO RELATED APPLICATION

This application claims the benefit of priority under 35 U.S.C. § 119 of U.S. Provisional Application Ser. No. 63/314,588 filed on Feb. 28, 2022, the content of which is relied upon and incorporated herein by reference in its entirety.

### FIELD

The present disclosure relates generally to methods of forming foldable apparatus and, more particularly, to methods of forming foldable apparatus comprising chemically strengthening a first major surface of a foldable substrate.

### BACKGROUND

Glass-based substrates are commonly used, for example, in display devices, e.g., liquid crystal displays (LCDs), electrophoretic displays (EPD), organic light-emitting diode displays (OLEDs), plasma display panels (PDPs), or the like.

There is a desire to develop foldable versions of displays as well as foldable protective covers to mount on foldable displays. Foldable displays and covers should have good impact and puncture resistance. At the same time, foldable displays and covers should have small minimum bend radii (e.g., about 10 millimeters (mm) or less). Plastic displays and covers with small minimum bend radii tend to have poor impact resistance and/or puncture resistance. Furthermore, conventional wisdom suggests that ultra-thin glass-based sheets (e.g., about 75 micrometers (μm or microns) or less thick) with small minimum bend radii tend to have poor impact resistance and/or puncture resistance. Still further, thicker glass-based sheets (e.g., greater than 125 micrometers) with good impact resistance and/or puncture resistance tend to have relatively large minimum bend radii (e.g., about 30 millimeters or more). Consequently, there is a need to develop foldable apparatus that have low minimum bend radii, good impact resistance, and good puncture resistance.

### SUMMARY

There are set forth herein methods of forming a foldable apparatus with improved impact resistance and/or good folding performance. Providing a glass-based substrate and/or a ceramic-based substrate can provide good dimensional stability, reduced incidence of mechanical instabilities, and/or good impact and puncture resistance. Methods of the aspects of the disclosure can increase a pen drop height that the foldable apparatus and/or foldable substrate can withstand (e.g., from about 20% to about 1000%, from about 20% to about 500%, from about 20% to about 100%). Methods of the aspects of the disclosure can use an alkaline solution and/or an alkaline detergent solution that is substantially free from fluorine, which can reduce materials handling costs both during treatment and for disposal of the solution. Solution of methods of the disclosure can be easily applied and then removed (e.g., rinsed away), for example, when the solution is substantially free of rheology modifiers. Methods of the disclosure can improve properties of the glass-based substrate by removing an outer layer without substantially reducing a substrate thickness of the foldable substrate (e.g., removing less than 500 nanometers (nm), less than 100 nanometers). Removal of a substantially uniform outer layer while minimizing a treatment time can be facilitated through the choice of solution composition and concentrations therein.

In aspects, the foldable substrate can be contacted with an alkaline solution comprising a hydroxide-containing base before the foldable substrate is chemically strengthened. Providing the alkaline solution comprising the hydroxide-containing base can remove a layer from the surface of the foldable substrate, which can remove flaws from the surface and/or change a surface chemistry of the surface. The alkaline solution comprising the hydroxide-containing base can remove flaws extending more than 10 nm into the foldable substrate, for example, by removing a corresponding thickness from the surface. Contacting the foldable substrate with the alkaline solution comprising the hydroxide-containing base before the chemical strengthening can reduce the growth of flaws during the chemical strengthening, which can result in increased impact resistance and/or puncture resistance of the chemically strengthened foldable substrate while simultaneously facilitating good folding performance of the chemically strengthened foldable substrate. Removing a low thickness (e.g., about 100 nanometers or less) from the surface of the foldable substrate may improve properties of the surface with reduced processing expenses than removing a deeper thickness.

In aspects, the foldable substrate can be contacted with an alkaline detergent solution before the foldable substrate is chemically strengthened. Providing the alkaline detergent solution after an etching step can neutralize residual etchant, which can prevent surface defects and/or produce a more uniform thickness of the foldable substrate. Providing the alkaline detergent solution (e.g., after an etching step and/or before a chemical strengthening process) can neutralize and/or remove hydrogen (e.g., hydronium) enrichment at the surface of the foldable substrate, which might otherwise lead to large flaws as a result of stress corrosion during a subsequent chemical strengthening process. Providing the alkaline detergent solution (e.g., after an etching step and/or before a chemical strengthening process) may selectively act on surface flaws (e.g., removing, rounding, blunting) before removing material from other parts of the surface, which can increase the impact resistance and/or puncture resistance of the chemically strengthened foldable substrate without removing a substantial thickness from the surface of the foldable substrate. Removing a low thickness (e.g., about 100 nanometers or less) from the surface of the foldable substrate may improve properties of the surface with reduced processing expenses than removing a deeper thickness.

In aspects, the foldable substrate can be contacted with an alkaline detergent solution (e.g., second alkaline detergent solution) after the foldable substrate is chemically strengthened. Providing the second alkaline detergent solution after the chemical strengthening can remove residual material from the chemical strengthening, which can enable more even and complete treatment of the surface in subsequent processing. Providing the second alkaline detergent solution after the chemical strengthening can change a surface chemistry (e.g., neutralize and/or remove hydrogen (e.g., hydronium) enrichment that may be present as a result of the chemical strengthening) of the foldable substrate, which can increase an impact resistance and/or a puncture resistance of the chemically strengthened foldable substrate while simultaneously facilitating good folding performance of the chemically strengthened foldable substrate. Providing the second alkaline detergent solution after the chemical strengthening may selectively act on surface flaws (e.g., removing, rounding, blunting) before removing material from other parts of the surface, which can increase the impact resistance and/or the puncture resistance of the substrate without removing a substantial thickness from the surface of the foldable substrate. Removing a low thickness (e.g., about 100 nanometers or less) from the surface of the foldable substrate may improve properties of the surface with reduced processing expenses than removing a deeper thickness.

In aspects, the foldable substrate can be contacted with an alkaline detergent solution before the foldable apparatus is assembled. For example, the foldable substrate may not be further treated between being contacted with the alkaline detergent solution and the foldable apparatus being assembled, which can minimize complexity of the processing and associated costs. Providing the alkaline detergent solution at this position in methods can facilitate good bonding to the surface, for example, by providing a surface substantially free from contaminants, with desirable surface chemistry, and/or with a reduced extent and/or density of flaws. In further aspects, assembling the foldable apparatus can have the treated surface be opposite a display device (e.g., facing a user). In further aspects, a release liner, a display device, and/or a coating can be disposed over (e.g., attached using an adhesive, directly contacting) the treated surface of the foldable substrate.

The inventors of the present disclosure have unexpectedly discovered that increasing the pH of an acidic solution can reduce the formation of leached layer. Without wishing to be bound by theory, the acidic solution can leach cations (e.g., alkali metal ions, transition metal ions, metallic ions) from the surface to produce a leached layer. The fluorine-containing compound in the acidic solution of the present disclosure can etch match from the surface by removing material. Consequently, a leached layer may not be formed when the rate of etching is substantially equal to or greater to the rate of leaching. At the same time, fluorine-containing crystals can be deposited when the pH of the acidic solution is too high, and the fluorine-containing crystals can cause portions of the surface to be etched (or leached) unevenly. In view of the above considerations and as shown in the Examples below, it has been unexpectedly discovered that providing the acidic solution with a pH of about 3 or more (e.g., from about 3.3 to about 3.5) can provide a foldable substrate that is substantially free from a leached surface layer.

Also, the inventors of the present disclosure have unexpectedly discovered methods for decreasing the redeposition of silica when etching with a fluorosilicic acid solution. For example, the formation of a silica layer during treatment with a fluorosilicic acid solution can be minimized by (1) reducing the concentration of SiF₆⁻ anions (e.g., by increasing a concentration of H⁺ or hydronium ions and/or by decreasing the temperature of the solution), (2) reducing the water content of solution (e.g., using a solution containing an organic glycol), or (3) decreasing supersaturation of silica-like compounds near the surface (e.g., through agitation and/or rinsing the substrate). Without wishing to be bound by theory, increasing the concentration of H⁺ or hydronium ions can reduce the concentration of SiF₆⁻ anions by shifting the equilibrium between H₂SiF₆ and 2H⁺+SiF₆⁻ towards H₂SiF₆. Without wishing to be bound by theory, decreasing the temperature of solution can decrease the concentration of SiF₆⁻ anions since the reaction from H₂SiF₆ and 2H⁺+SiF₆⁻ is endothermic. Without wishing to be bound by theory, agitating the foldable substrate during step 3933 can decrease a supersaturation of silica-like compounds near the surface.

Some example aspects of the disclosure are described below with the understanding that any of the features of the various aspects may be used alone or in combination with one another.

Aspect 1. A method of forming a foldable apparatus comprising:
contacting an existing first major surface of a foldable substrate with an alkaline solution comprising a first temperature for a first period of time to remove an outer layer from the existing first major surface to form a new first major surface, the outer layer comprising a thickness ranging from about 1 nanometer to about 500 nanometers, the first temperature ranges from about 60° C. to about 150° C., and the alkaline solution comprises about 10 weight % (wt %) or more of a hydroxide-containing base; and then
chemically strengthening the new first major surface of the foldable substrate to form a first compressive stress region extending to a first depth of compression from the new first major surface of the foldable substrate.

Aspect 2. The method of aspect 1, wherein the alkaline solution comprises a pH of about 14 or more.

Aspect 3. A method of forming a foldable apparatus comprising:
contacting an existing first major surface of a foldable substrate with an alkaline solution comprising a first temperature for a first period of time to remove an outer layer from the existing first major surface to form a new first major surface, the outer layer comprising a thickness ranging from about 1 nanometer to about 500 nanometers, the first temperature ranges from about 60° C. to about 150° C., and the alkaline solution comprises a hydroxide-containing base and a pH of about 14 or more; and then
chemically strengthening the new first major surface of the new first major surface of the foldable substrate to form a first compressive stress region extending to a first depth of compression from the new first major surface of the foldable substrate.

Aspect 4. The method of any one of aspects 1-3, wherein the new first major surface is not further treated between the contacting the existing first major surface with the alkaline solution and the chemically strengthening the new first major surface.

Aspect 5. The method of any one of aspects 1-4, wherein the hydroxide-containing base comprises one or more of sodium hydroxide, potassium hydroxide, and/or ammonium hydroxide.

Aspect 6. The method of any one of aspects 1-5, wherein the alkaline solution comprises from about 20 wt % to about 50 wt % of the hydroxide-containing base.

Aspect 7. The method of any one of aspects 1-5, wherein the alkaline solution comprises a concentration of the hydroxide-containing base ranges from about 3 molar to about 14 molar.

Aspect 8. The method of any one of aspects 1-7, wherein the alkaline solution is fluoride-free.

Aspect 9. The method of any one of aspects 1-8, wherein the first temperature ranges from about 80° C. to about 110° C.

Aspect 10. The method of any one of aspects 1-9, wherein the first period of time ranges from about 5 minutes to about 120 minutes.

Aspect 11. The method of aspect 10, wherein the first period of time ranges from about 10 minutes to about 30 minutes.

Aspect 12. The method of any one of aspects 1-11, wherein the thickness of the outer layer removed by the contacting the existing first major surface with the alkaline solution ranges from about 10 nanometers to about 100 nanometers.

Aspect 13. The method of any one of aspects 1-12, wherein a first pen drop threshold height of the foldable substrate contacted with the alkaline solution followed by the chemically strengthening is from about 50% to about 500% more than a second pen drop threshold height of a second foldable substrate that is subject to the chemically strengthening but is not contacted with the alkaline solution, and the second foldable substrate is otherwise identical to the foldable substrate.

Aspect 14. The method of any one of aspects 1-12, wherein a first pen drop threshold height of the foldable substrate contacted with the alkaline solution followed by the chemically strengthening is from about 20% to about 100% more than a third pen drop threshold height of a third foldable substrate that is neither chemically strengthened nor contacted by the alkaline solution. The third foldable substrate is otherwise identical to the foldable substrate.

Aspect 15. The method of any one of aspects 1-14, further comprising:
after the chemically strengthening the new first major surface, one or more of: attaching an adhesive layer to the new first major surface and
disposing a release liner over the adhesive layer;
   attaching a display device to the new first major surface; or
   disposing a coating over the new first major surface.

Aspect 16. The method of aspect 15, wherein the new first major surface is not further treated between the chemically strengthening the new first major surface and the attaching the adhesive layer, the attaching the display device, or the disposing the coating.

Aspect 17. The method of any one of aspects 1-15, further comprising, after the chemically strengthening the new first major surface, contacting the new first major surface with an alkaline detergent solution comprising a second temperature for a second period of time under sonication.

Aspect 18. The method of aspect 17, wherein the second period of time ranges from about 3 minutes to about 10 minutes.

Aspect 19. The method of any one of aspects 17-18, wherein the second temperature ranges from about 20° C. to about 65° C.

Aspect 20. The method of any one of aspects 17-19, wherein a concentration of an alkaline detergent in the alkaline detergent solution ranges from about 1 wt % to about 4 wt %.

Aspect 21. The method of any one of aspects 17-20, wherein the alkaline detergent solution comprises a pH ranges from about 12 to about 14.

Aspect 22. The method of any one of aspects 1-21, wherein the foldable substrate comprises a first thickness defined between the existing first major surface and an existing second major surface ranges from about 25 micrometers to about 200 micrometers.

Aspect 23. The method of any one of aspects 1-22, wherein the foldable substrate comprises a glass-based substrate.

Aspect 24. The method of any one of aspects 1-23, wherein the first compressive stress region comprises a maximum first compressive stress of about 500 MegaPascals or more.

Aspect 25. A method of forming a foldable apparatus comprising:
contacting a first major surface of a foldable substrate with a first alkaline detergent solution comprising a first temperature for a first period of time under sonication; then,
chemically strengthening the first major surface of the foldable substrate to form a first compressive stress region extending to a first depth of compression from the first major surface of the foldable substrate; and then
contacting the first major surface with a second alkaline detergent solution comprising a second temperature for a second period of time under sonication,
wherein the foldable substrate comprises a substrate thickness defined between the first major surface and a second major surface opposite the first major surface.

Aspect 26. The method of aspect 25, further comprising, before the contacting the first major surface of the foldable substrate with a first alkaline detergent solution, etching the foldable substrate by contacting at least an existing first major surface of the foldable to reduce an existing thickness of the foldable substrate defined between the existing first major surface and an existing second major surface.

Aspect 27. The method of aspect 26, wherein the first major surface is not further treated between the etching the foldable substrate and the contacting the first major surface of the foldable substrate with the first alkaline detergent solution.

Aspect 28. The method of any one of aspects 25-27, wherein the first major surface is not further treated between the contacting the first major surface of the foldable substrate with the first alkaline detergent solution and the chemically strengthening the first major surface.

Aspect 29. The method of any one of aspects 25-28, wherein the first major surface is not further treated between the chemically strengthening the first major surface and the contacting the first major surface with the second alkaline detergent solution.

Aspect 30. The method of any one of aspects 25-29, wherein the first period of time ranges from about 1 minute to about 60 minutes.

Aspect 31. The method of aspect 30, wherein the first period of time ranges from about 3 minutes to about 10 minutes.

Aspect 32. The method of any one of aspects 25-31, wherein the second period of time ranges from about 1 minute to about 60 minutes.

Aspect 33. The method of aspect 32, wherein the second period of time ranges from about 3 minutes to about 10 minutes.

Aspect 34. The method of any one of aspects 25-33, wherein the first temperature ranges from about 20° C. to about 65° C.

Aspect 35. The method of any one of aspects 25-34, wherein the second temperature ranges from about 20° C. to about 65° C.

Aspect 36. The method of any one of aspects 25-35, wherein a concentration of an alkaline detergent in the first alkaline detergent solution ranges from about 1 wt % to about 4 wt %.

Aspect 37. The method of any one of aspects 25-35, wherein a concentration of an alkaline detergent in the second alkaline detergent solution ranges from about 1 wt % to about 4 wt %.

Aspect 38. The method of any one of aspects 25-37, wherein the first alkaline detergent solution comprises a pH ranges from about 12 to about 14.

Aspect 39. The method of any one of aspects 25-38, wherein the second alkaline detergent solution comprises a pH ranges from about 12 to about 14.

Aspect 40. The method of any one of aspects 25-39, further comprising:
after the contacting the first major surface with the second alkaline detergent solution, one or more of:
   attaching an adhesive layer to the new first major surface and disposing a release liner over the adhesive layer;
   attaching a display device to the new first major surface; or
   disposing a coating over the new first major surface.

Aspect 41. The method of aspect 40, wherein the first major surface is not further treated between the contacting the first major surface with the second alkaline detergent solution and the attaching the adhesive layer, the attaching the display device, or the disposing the coating.

Aspect 42. The method of any one of aspects 25-41, wherein the substrate thickness ranges from about 25 micrometers to about 200 micrometers.

Aspect 43. The method of any one of aspects 25-42, wherein the foldable substrate comprises a glass-based substrate.

Aspect 44. The method of any one of aspects 25-43, wherein the first compressive stress region comprises a maximum first compressive stress of about 500 MegaPascals or more.

Aspect 45. The method of any one of aspects 25-44, wherein a first pen drop threshold height of the foldable substrate after the contacting the first major surface of the foldable substrate with the first alkaline detergent solution, the chemically strengthening the first major surface, and the contacting the first major surface with the second alkaline detergent solution is from about 20% to about 1,000% more than a second pen drop threshold height of a second foldable substrate that is subject to the chemically strengthened but is not contacted with the first alkaline detergent solution and the second alkaline detergent solution. The second foldable substrate is otherwise identical to the foldable substrate.

Aspect 46. A method of forming a foldable apparatus comprising:
chemically strengthening an existing first major surface of a foldable substrate to form a first compressive stress region extending to a first depth of compression from the existing first major surface of the foldable substrate; and then contacting the existing first major surface of the foldable substrate with an acidic solution comprising a first temperature for a first period of time to remove an outer layer from the existing first major surface to form a new first major surface, the outer layer comprising a thickness ranging from about 1 nanometer to about 3 micrometers, the first temperature ranges from about 20° C. to about 55° C., and the acidic solution comprises a pH ranging from about 3.3 to about 3.5 and a fluorine-containing compound.

Aspect 47. The method of aspect 46, wherein the fluorine-containing compound comprises one or more of HF, NH₄F, or combinations thereof.

Aspect 48. The method of any one of aspects 46-47, wherein the fluorine-containing compound comprises HF and NH₄F.

Aspect 49. The method of any one of aspects 46-48, wherein a weight percent (wt %) of the fluorine-containing compound in the acidic solution ranges from about 1 wt % to about 10 wt %.

Aspect 50. The method of any one of aspects 46-49, wherein an average transmittance of the foldable apparatus from 360 nm to 400 nm is less than 93%.

Aspect 51. The method of any one of aspects 46-49, wherein an absolute value of a difference between a first average transmittance between 360 nm to 400 nm and a second average transmittance between 700 nm and 750 nm is 1% or less.

Aspect 52. The method of any one of aspects 46-51, wherein the foldable apparatus comprises a CIE a* value from about −0.01 to about 0.01, a CIE b* value from about −0.15 to about 0.1, or combinations thereof.

Aspect 53. The method of any one of aspects 46-52, wherein a color difference ΔE of the foldable apparatus to an identical foldable substrate subjected to the chemically strengthening but not further treated is about 0.3 or less.

Aspect 54. The method of any one of aspects 46-53, wherein the thickness of the outer layer ranges from about 0.7 micrometers to about 1.5 micrometers.

Aspect 55. The method of any one of aspects 46-54, wherein the foldable substrate comprises a first thickness defined between the existing first major surface and an existing second major surface ranges from about 25 micrometers to about 200 micrometers.

Aspect 56. The method of any one of aspects 46-55, wherein the foldable substrate comprises a glass-based substrate.

Aspect 57. The method of any one of aspects 46-56, wherein the first compressive stress region comprises a maximum first compressive stress of about 500 MegaPascals or more.

Aspect 58. A method of forming a foldable apparatus comprising:
contacting an existing first major surface of a foldable substrate with a solution comprising fluorosilicic acid at a first temperature for at least a first period of time to remove an outer layer from the existing first major surface to form a new first major surface, the outer layer comprising a thickness ranging from about 1 nanometer to about 3 micrometers, the first temperature ranges from about 20° C. to about 55° C., wherein a concentration of the fluorosilicic acid is 0.3 molar or more; and
agitating the foldable substrate during the contacting.

Aspect 59. The method of aspect 58, wherein the concentration of the fluorosilicic acid is from about 0.5 molar to about 1 molar.

Aspect 60. The method of any one of aspects 58-59, wherein the first temperature is from about 24° C. to about 40° C.

Aspect 61. A method of forming a foldable apparatus comprising:
contacting an existing first major surface of a foldable substrate with a solution comprising fluorosilicic acid at a first temperature for at least a first period of time to remove an outer layer from the existing first major surface to form a new first major surface, the outer layer comprising a thickness ranging from about 1 nanometer to about 3 micrometers, the first temperature is about 32° C. or less; and
agitating the foldable substrate during the contacting.

Aspect 62. The method of aspect 61, wherein a concentration of the fluorosilicic acid is about 0.01 molar or more.

Aspect 63. The method of any one of aspects 58-62, further comprising rinsing the foldable substrate with deionized water at least once during the contacting. Aspect 64. A method of forming a foldable apparatus comprising:

contacting an existing first major surface of a foldable substrate with a solution comprising fluorosilicic acid at a first temperature for at least a first period of time to remove an outer layer from the existing first major surface to form a new first major surface, the outer layer comprising a thickness ranging from about 1 nanometer to about 3 micrometers;
agitating the foldable substrate during the contacting; and
rinsing the foldable substrate with deionized water at least once during the contacting.

Aspect 65. The method of aspect 64, wherein a concentration of the fluorosilicic acid is about 0.01 molar or more.

Aspect 66. The method of aspect 64, wherein a concentration of the fluorosilicic acid is from about 0.5 molar to about 1 molar.

Aspect 67. The method of any one of aspects 64-66, wherein the first temperature is from about 24° C. to about 40° C.

Aspect 68. The method of any one of aspects 63-67, wherein the rinsing occurs at least every 10 minutes during the contacting.

Aspect 69. The method of any one of aspects 63-67, wherein the rinsing occurs at least every 5 minutes during the contacting.

Aspect 70. The method of any one of aspects 58-69, wherein the first period of time ranges from about 5 minutes to about 30 minutes.

Aspect 71. The method of any one of aspects 58-70, wherein the first period of time ranges from 10 minutes to 20 minutes.

Aspect 72. The method of any one of aspects 58-71, wherein the solution further comprises 1 molar or more of a mineral acid.

Aspect 73. The method of any one of aspects 58-72, wherein the solution comprises a pH or 2 or less.

Aspect 74. The method of any one of aspects 58-73, wherein the solution further comprises an organic glycol, wherein a ratio of water to the organic glycol is about 0.5 or less.

Aspect 75. The method of any one of aspects 58-74, wherein the thickness of the outer layer ranges from about 0.7 micrometers to about 1.5 micrometers.

Aspect 76. The method of any one of aspects 58-75, wherein the foldable substrate comprises a first thickness defined between the existing first major surface and an existing second major surface ranges from about 25 micrometers to about 200 micrometers.

Aspect 77. The method of any one of aspects 58-76, wherein the foldable substrate comprises a glass-based substrate.

Aspect 78. The method of any one of aspects 46-77, further comprising, after the contacting, contacting the first major surface with an alkaline detergent solution comprising a second temperature for a second period of time under agitation.

Aspect 79. The method of aspect 78, wherein the second period of time ranges from about 1 minute to about 60 minutes.

Aspect 80. The method of aspect 79, wherein the second period of time ranges from about 3 minutes to about 10 minutes.

Aspect 81. The method of any one of aspects 78-80, wherein the second temperature ranges from about 20° C. to about 65° C.

Aspect 82. The method of aspect 81, wherein the second temperature ranges from about 40° C. to about 65° C.

Aspect 83. The method of any one of aspects 78-82, wherein a concentration of an alkaline detergent in the alkaline detergent solution ranges from about 1 wt % to about 4 wt %.

Aspect 84. The method of any one of aspects 78-83, wherein the alkaline detergent solution comprises a pH ranges from about 12 to about 14.

Aspect 85. The method of any one of aspects 78-84, wherein a first pen drop threshold height of the foldable substrate after the contacting the first major surface of the foldable substrate with the alkaline detergent solution is from about 20% to about 1,000% more than a second pen drop threshold height of a second foldable substrate that is subject treated identically to the foldable substrate but is not contacted with the alkaline detergent solution.

Aspect 86. The method of any one of aspects 58-85, further comprising, before the contacting, chemically strengthening the foldable substrate.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### BRIEF DESCRIPTION OF THE DRAWINGS

The above and other features and advantages of aspects of the present disclosure are better understood when the following detailed description is read with reference to the accompanying drawings, in which:

FIG. 1 is a schematic view of an example foldable apparatus in a flat configuration according to aspects, wherein a schematic view of the folded configuration may appear as shown in FIG. 8;

FIGS. 2-7 are cross-sectional views of example foldable apparatus along line 2-2 of FIG. 1 according to aspects;

FIG. 8 is a schematic view of example foldable apparatus of aspects of the disclosure in a folded configuration wherein a schematic view of the flat configuration may appear as shown in FIG. 1;

FIG. 9 is a cross-sectional view of a testing apparatus to determine the minimum parallel plate distance of an example modified foldable apparatus along line 9-9 of FIG. 8;

FIG. 10 is a schematic plan view of an example consumer electronic device according to aspects;

FIG. 11 is a schematic perspective view of the example consumer electronic device of FIG. 10;

FIG. 12 is a flow chart illustrating example methods making a foldable substrate and/or foldable apparatus in accordance with aspects of the disclosure;

FIGS. 13-16 schematically illustrate steps in a method of making a foldable substrate and/or foldable apparatus;

FIG. 17 is a cross-sectional view of a foldable apparatus after the step shown in FIG. 15 and/or before the step shown in FIG. 16;

FIG. 18 schematically illustrates a step in a method of making a foldable apparatus;

FIG. 19 is a cross-sectional view of a foldable apparatus shown in FIG. 18;

FIGS. 20-21 schematically illustrate steps in a method of making a foldable apparatus;

FIG. 22 is a cross-sectional view of a foldable apparatus after the step shown in FIG. 21 and/or before the step shown in FIG. 23;

FIG. 23 schematically illustrates a step in a method of making a foldable apparatus;

FIGS. 24-26 schematically illustrate steps in a method of making a foldable apparatus;

FIGS. 27-30 illustrate concentrations measured using secondary ion mass spectrometry (SIMS);

FIG. 31 illustrates CIE color coordinates for foldable substrates treated with acidic solutions with different pHs;

FIG. 32 illustrates the color shift AE of foldable substrates as a function of foldable substrates treated with acidic solutions with different pHs;

FIG. 33 illustrates transmittances over optical wavelengths for foldable substrates treated with acidic solutions with different pHs;

FIGS. 34A and 34B schematically illustrates scanning electron microscope (SEM) images of foldable substrates treated with a 0.5 M H₂SiF₆ solution;

FIGS. 35A and 35B schematically illustrates scanning electron microscope (SEM) images of foldable substrates treated with a 0.5 M H₂SiF₆ and 4.5 M H₂SO₄ solution;

FIG. 36 schematically illustrates a scanning electron microscope (SEM) image of a foldable substrate treated at 20° C. without agitation;

FIG. 37 schematically illustrates a scanning electron microscope (SEM) image of a foldable substrate treated at 20° C. with agitation;

FIG. 38 schematically illustrates a scanning electron microscope (SEM) image of a foldable substrate treated at 30° C. with moderate agitation;

FIG. 39 is a flow chart illustrating example methods making a foldable substrate and/or foldable apparatus in accordance with aspects of the disclosure; and

FIGS. 40-42 schematically illustrate steps in a method of making a foldable substrate and/or foldable apparatus.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, claims may encompass many different aspects of various aspects and should not be construed as limited to the aspects set forth herein.

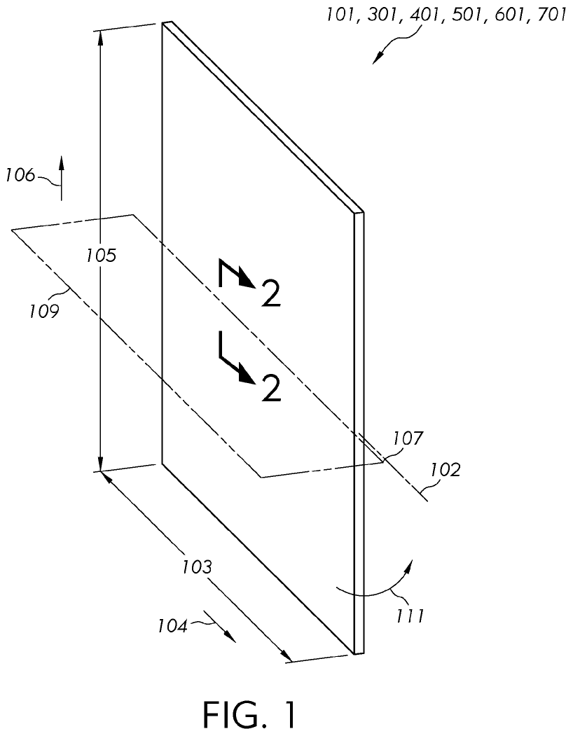

FIGS. 1-9 illustrate schematic views of foldable apparatus 101, 301, 401, 501, 601, and/or 701 or test foldable apparatus 902 comprising a foldable substrate 201 and/or 407 in accordance with aspects of the disclosure. Unless otherwise noted, a discussion of features of aspects of one foldable apparatus can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

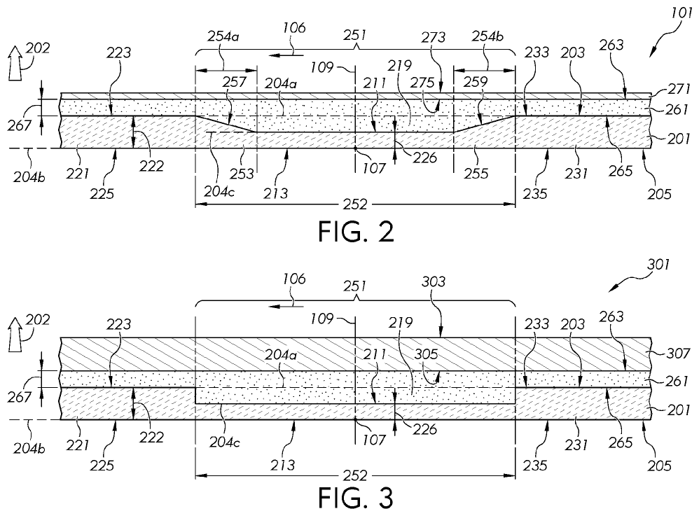

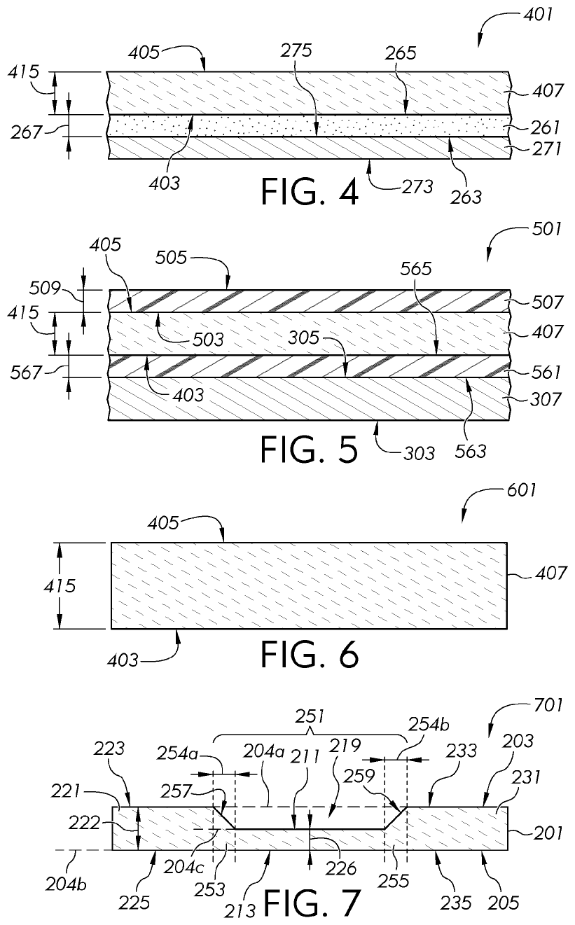

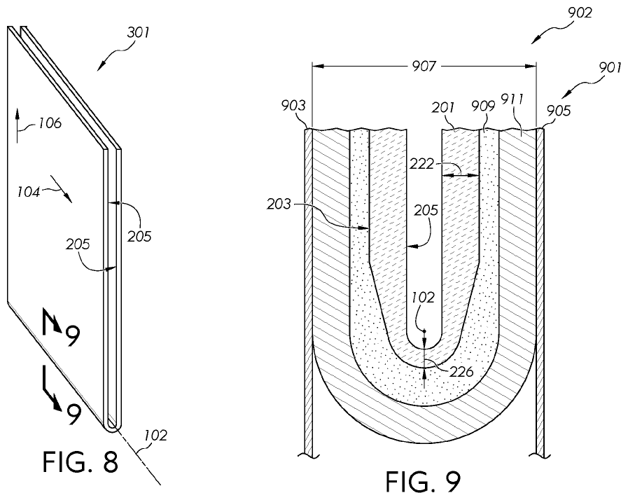

As shown in FIGS. 1-7, example aspects of foldable apparatus 101, 301, 401, 501, 601, and/or 701 can comprise the foldable substrate 201 and/or 407 in accordance with aspects of the disclosure in an unfolded (e.g., flat) configuration while FIGS. 8-9 demonstrate a foldable apparatus 301 or test foldable apparatus 902 comprising the foldable substrate 201 in accordance with aspects of the disclosure in a folded configuration. In aspects, for example, as shown in FIGS. 2-3 and 7, the foldable apparatus 101, 301, and 701 comprise a foldable substrate 201 comprising a first portion 221, a second portion 231, and a central portion 251 positioned between the first portion 221 and the second portion 231. In aspects, as shown in FIGS. 4-6, the foldable apparatus 401, 501, and 601 can comprise the foldable substrate 407. In aspects, as shown in FIGS. 2 and 4, the foldable apparatus 101 and 401 can comprise a release liner 271 although other substrates (e.g., a glass-based substrate discussed throughout the application) may be used in further aspects rather than the illustrated release liner 271. The release liner 271, or other substrates, can comprise a first major surface 273 and a second major surface 275 opposite the first major surface 273. In aspects, as shown in FIGS. 3 and 5, the foldable apparatus 301 and 501 can comprise a display device 307. The display device 307 can comprise a first major surface 303 and a second major surface 305 opposite the first major surface 303. It is to be understood that any of the foldable apparatus of the disclosure can comprise a second substrate (e.g., a glass-based substrate), the release liner 271, and/or the display device 307.

Throughout the disclosure, with reference to FIG. 1, the width 103 of the foldable apparatus 101, 301, 401, 501, 601, and/or 701 is considered the dimension of the foldable apparatus taken between opposed edges of the foldable apparatus in a direction 104 of a fold axis 102 of the foldable apparatus, wherein the direction 104 also comprises the direction of the width 103. Furthermore, throughout the disclosure, the length 105 of the foldable apparatus 101, 301, 401, 501, 601, and/or 701 is considered the dimension of the foldable apparatus 101, 301, 401, 501, 601, and/or 701 taken between opposed edges of the foldable apparatus 101, 301, 401, 501, 601, and/or 701 in a direction 106 perpendicular to the fold axis 102 of the foldable apparatus. In aspects, as shown in FIGS. 1-3, the foldable apparatus of any aspects of the disclosure can comprise a fold plane 109 that includes the fold axis 102 and the direction 202 of a substrate thickness 222 when the foldable apparatus is in the flat configuration (e.g., see FIG. 2). The fold plane 109 may comprise a central axis 107 of the foldable apparatus positioned, for example, at a second major surface 205 of the foldable apparatus 101 and 301 (see FIGS. 2-3). In aspects, the foldable apparatus can be folded in a direction 111 (e.g., see FIG. 1) about the fold axis 102 extending in the direction 104 of the width 103 to form a folded configuration (e.g., see FIGS. 8-9). In aspects, as shown in FIGS. 4-6, the foldable apparatus 401, 501, and 601 can comprise a substantially planar first major surface 403 and/or substantially planar second major surface 405, where a central portion of the foldable apparatus can be indistinguishable from adjacent portions. As shown in FIGS. 1 and 8-9, the foldable apparatus may include a single fold axis to allow the foldable apparatus to comprise a bifold wherein, for example, the foldable apparatus may be folded in half. In further aspects, the foldable apparatus may include two or more fold axes, for example, with each fold axis including a corresponding central portion similar or identical to the central portion 251 discussed herein. For example, providing two fold axes can allow the foldable apparatus to comprise a trifold wherein, for example, the foldable apparatus may be folded with the first portion 221, the second portion 231, and a third portion similar or identical to the first portion or second portion with the central portion 251 and another central portion similar to or identical to the central portion positioned between the first portion and the second portion and between the second portion and the third portion, respectively.

Foldable apparatus 101, 301, and 701 of the disclosure can comprise the foldable substrate 201. Foldable apparatus 401, 501, and 601 can comprise the foldable substrate 407. In aspects, the foldable substrate 201 and/or 407 can comprise a glass-based substrate having a pencil hardness of 8H or more, for example, 9H or more. In aspects, the foldable substrate 201 and/or 407 can comprise a glass-based substrate. As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion exchange of larger ions for smaller ions in the surface of the substrate, as discussed below. However, other strengthening methods, for example, thermal tempering, or utilizing a mismatch of the coefficient of thermal expansion between portions of the substrate to create compressive stress and central tension regions, may be utilized to form strengthened substrates. Exemplary glass-based materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass. In one or more aspects, a glass-based material may comprise, in mole percent (mol %): SiO₂ from about 40 mol % to about 80 mol %, Al₂O₃ from about 5 mol % to about 30 mol %, B₂O₃ from 0 mol % to about 10 mol %, ZrO₂ from 0 mol % to about 5 mol %, P₂O₅ from 0 mol % to about 15 mol %, TiO₂ from 0 mol % to about 2 mol %, R₂O from 0 mol % to about 20 mol %, and RO from 0 mol % to about 15 mol %. As used herein, R₂O can refer to an alkali metal oxide, for example, Li₂O, Na₂O, K₂O, Rb₂O, and Cs₂O. As used herein, RO can refer to MgO, CaO, SrO, BaO, and ZnO. In aspects, a glass-based substrate may optionally further comprise from 0 mol % to about 2 mol % of each of Na₂SO₄, NaCl, NaF, NaBr, K₂SO₄, KCl, KF, KBr, As₂O₃, Sb₂O₃, SnO₂, Fe₂O₃, MnO, MnO₂, MnO₃, Mn₂O₃, Mn₃O₄, Mn₂O₇. “Glass-ceramics” include materials produced through controlled crystallization of glass. In aspects, glass-ceramics have about 1% to about 99% crystallinity. Examples of suitable glass-ceramics may include Li₂O—Al₂O₃—SiO₂ system (i.e., LAS-System) glass-ceramics, MgO—Al₂O₃—SiO₂ system (i.e., MAS-System) glass-ceramics, ZnO×Al₂O₃×nSiO₂ (i.e., ZAS system), and/or glass-ceramics that include a predominant crystal phase including β-quartz solid solution, β-spodumene, cordierite, petalite, and/or lithium disilicate. The glass-ceramic substrates may be strengthened using the chemical strengthening processes. In one or more aspects, MAS-System glass-ceramic substrates may be strengthened in Li₂SO₄ molten salt, whereby an exchange of 2Li⁺ for Mg²⁺ can occur.

Throughout the disclosure, a tensile strength, ultimate elongation (e.g., strain at failure), and yield point of a polymeric material (e.g., adhesive, polymer-based portion) is determined using ASTM D638 using a tensile testing machine, for example, an Instron 3400 or Instron 6800, at 23° C. and 50% relative humidity with a type I dogbone shaped sample. Throughout the disclosure, an elastic modulus (e.g., Young's modulus) and/or a Poisson's ratio is measured using ISO 527-1:2019. In aspects, the foldable substrate 201 and/or 407 can comprise an elastic modulus of about 1 GigaPascal (GPa) or more, about 3 GPa or more, about 5 GPa or more, about 10 GPa or more, about 100 GPa or less, about 80 GPa or less, about 60 GPa or less, or about 20 GPa or less. In aspects, the foldable substrate 201 and/or 407 can comprise an elastic modulus ranging from about 1 GPa to about 100 GPa, from about 1 GPa to about 80 GPa, from about 3 GPa to about 60 GPa, from about 5 GPa to about 20 GPa, from about 10 GPa to about 20 GPa, or any range or subrange therebetween. In further aspects, the foldable substrate 201 and/or 407 can comprise a glass-based portion comprising an elastic modulus ranging from about 10 GPa to about 100 GPa, from about 40 GPa to about 100 GPa, from about 60 GPa to about 100 GPa, from about 80 GPa to about 100 GPa, or any range or subrange therebetween.

In aspects, the foldable substrate 201 and/or 407 can be optically transparent. As used herein, “optically transparent” or “optically clear” means an average transmittance of 70% or more in the wavelength range of 400 nm to 700 nm through a 1.0 mm thick piece of a material. In aspects, an “optically transparent material” or an “optically clear material” may have an average transmittance of 75% or more, 80% or more, 85% or more, or 90% or more, 92% or more, 94% or more, 96% or more in the wavelength range of 400 nm to 700 nm through a 1.0 mm thick piece of the material. The average transmittance in the wavelength range of 400 nm to 700 nm is calculated by measuring the transmittance of whole number wavelengths from about 400 nm to about 700 nm and averaging the measurements.

As shown in FIGS. 2-3, 7, and 9, the foldable substrate 201 can comprise a first major surface 203 and a second major surface 205 opposite the first major surface 203. As shown in FIGS. 2-3, the first major surface 203 can extend along a first plane 204a. The second major surface 205 can extend along a second plane 204b. In aspects, as shown, the second plane 204b can be parallel to the first plane 204a. As used herein, a substrate thickness 222 of the foldable substrate 201 can be defined between the first major surface 203 and the second major surface 205 as a distance between the first plane 204a and the second plane 204b.

As shown in FIGS. 4-6, the foldable substrate 407 can comprise a first major surface 403 and a second major surface 405 opposite the first major surface 403. As shown, the first major surface 403 and/or the second major surface 405 can comprise a planar surface. In aspects, the first major surface 403 can be substantially parallel to the second major surface 405. As used herein, a substrate thickness 415 of the foldable substrate 407 can be defined between the first major surface 403 and the second major surface 405.

In aspects, the substrate thickness 222 and/or 415 can be about 10 micrometers (μm) or more, about 25 μm or more, about 40 μm or more, about 60 μm or more, about 80 μm or more, about 100 μm or more, about 125 μm or more, about 150 μm or more, about 2 millimeters (mm) or less, about 1 mm or less, about 800 μm or less, about 500 μm or less, about 300 μm or less, about 200 μm or less, about 180 μm or less, or about 160 μm or less. In aspects, the substrate thickness 222 and/or 415 can range from about 10 μm to about 2 mm, from about 25 μm to about 2 mm, from about 40 μm to about 2 mm, from about 60 μm to about 2 mm, from about 80 μm to about 2 mm, from about 100 μm to about 2 mm, from about 100 μm to about 1 mm, from about 100 μm to about 800 μm, from about 100 μm to about 500 μm, from about 125 μm to about 500 μm, from about 125 μm to about 300 μm, from about 125 μm to about 200 μm, from about 150 μm to about 200 μm, from about 150 μm to about 160 μm, or any range or subrange therebetween. In aspects, the substrate thickness 222 and/or 415 can range from about 10 μm to about 800 mm, from about 25 μm to about 500 μm, from about 25 μm to about 200 μm, from about 25 μm to about 180 μm, from about 40 μm to about 180 μm, from about 60 μm to about 160 μm, from about 80 μm to about 160 mm, from about 100 μm to about 160 μm, from about 125 μm to about 160 μm, or any range or subrange therebetween.

In aspects, as shown in FIGS. 2-3 and 7, the foldable substrate can comprise the central portion 251 positioned between the first portion 221 and the second portion 231. The first portion 221 will now be described with reference to the foldable apparatus 101 of FIG. 2 with the understanding that such description of the first portion 221, unless otherwise stated, can also apply to any aspects of the disclosure, for example, the foldable apparatus 301 and/or 701 illustrated in FIGS. 3 and 7. As shown in FIG. 2, the first portion 221 can comprise a first surface area 223 and a second surface area 225 opposite the first surface area 223. In aspects, as shown, the second surface area 225 of the first portion 221 can comprise a planar surface. In further aspects, as shown, the second surface area 225 can be parallel to the first surface area 223. In aspects, as shown, the first major surface 203 can comprise the first surface area 223 and the second major surface 205 can comprise the second surface area 225. In further aspects, the first surface area 223 can extend along the first plane 204a. In further aspects, the second surface area 225 can extend along the second plane 204b. A first thickness defined between the first surface area 223 of the first portion 221 and the second surface area 225 of the first portion 221 can comprise the substrate thickness 222. In aspects, the first thickness can be substantially uniform across the first surface area 223. In aspects, the first thickness can be within one or more of the ranges discussed above with regards to the substrate thickness. In aspects, the first thickness of the first portion 221 may be substantially uniform between the first surface area 223 and the second surface area 225 across its corresponding length (i.e., in the direction 106 of the length 105 of the foldable apparatus) and/or its corresponding width (i.e., in the direction 104 of the width 103 of the foldable apparatus).

As shown in FIGS. 2-3 and 7, the foldable substrate 201 can also comprise a second portion 231 comprising a third surface area 233 and a fourth surface area 235 opposite the third surface area 233. The second portion 231 will now be described with reference to the foldable apparatus 101 of FIG. 2 with the understanding that such description of the second portion 231, unless otherwise stated, can also apply to any aspects of the disclosure, for example, the foldable apparatus 101, 301 and/or foldable substrate 201 illustrated in FIGS. 3 and 7. In aspects, as shown, the third surface area 233 of the second portion 231 can comprise a planar surface. In further aspects, the third surface area 233 of the second portion 231 can be in a common plane with the first surface area 223 of the first portion 221. In aspects, as shown, the fourth surface area 235 of the second portion 231 can comprise a planar surface. In further aspects, as shown, the fourth surface area 235 can be parallel to the third surface area 233. In further aspects, the fourth surface area 235 of the second portion 231 can be in a common plane with the second surface area 225 of the first portion 221. The second portion 231 can comprise a second thickness between the third surface area 233 of the second portion 231 and the fourth surface area 235 of the second portion 231. In aspects, as shown in FIGS. 2-3 and 7, the second thickness can comprise the substrate thickness 222. In aspects, the second thickness can be substantially uniform across the third surface area 233. In aspects, the second thickness can be within one or more of the ranges discussed above with regards to the substrate thickness. In aspects, the second thickness of the second portion 231 may be substantially uniform between the third surface area 233 and the fourth surface area 235 across its corresponding length (i.e., in the direction 106 of the length 105 of the foldable apparatus) and/or its corresponding width (i.e., in the direction 104 of the width 103 of the foldable apparatus).

In aspects, as shown in FIGS. 2-3 and 7, the foldable substrate 201 can comprise the central portion 251 comprising a first central surface area 211 and a second central surface area 213 opposite the first central surface area 211. In further aspects, the central portion 251 can comprise the first central surface area 211 positioned between the first surface area 223 and the third surface area 233. In even further aspects, as shown, the first central surface area 211 can be recessed from the first major surface 203. In further aspects, the central portion 251 can comprise the second central surface area 213 positioned between the second surface area 225 and the fourth surface area 235. In even further aspects, as shown, the second major surface 205 can comprise the second central surface area 213. In even further aspects, although not shown, a portion of the second central surface area can be recessed from the second plane.

A central thickness 226 of the central portion 251 can be defined between the first central surface area 211 and the second central surface area 213. In aspects, the first central surface area 211 can extend along a third plane 204c when the foldable apparatus 101, 301 is in a flat configuration, although the first central surface area 211 may be provided as a nonplanar area in further aspects. In further aspects, the third plane 204c can be substantially parallel to the first plane 204a and/or the second plane 204b. By providing the first central surface area 211 of the central portion 251 extending along a third plane 204c parallel to the second plane 204b, a uniform central thickness 226 may extend across the central portion 251 that can provide enhanced folding performance at a predetermined thickness for the central thickness 226. A uniform central thickness 226 across the central portion 251 can improve folding performance by preventing stress concentrations that would occur if a portion of the central portion 251 was thinner than the rest of the central portion 251.

In aspects, as shown in FIGS. 2-3 and 7, the central thickness 226 can be less than the substrate thickness 222 (e.g., first thickness of the first portion 221, second thickness of the second portion 231). In aspects, the central thickness 226 can be about 0.5% or more, about 1% or more, about 2% or more, about 5% or more, about 10% or more, about 15% or more, about 20% or more, about 25% or more, about 35% or more, about 60% or less, about 55% or less, about 50% or less, about 45% or less, about 13% or less, about 10% or less, or about 5% or less of the substrate thickness 222 (e.g., first thickness, second thickness). In aspects, the central thickness 226 as a percentage of the substrate thickness 222 (e.g., first thickness, second thickness) can range from about 0.5% to about 13%, from about 1% to about 10%, from about 1% to about 5%, from about 2% to about 13%, from about 2% to about 5%, from about 5% to about 13%, from about 5% to about 10%, or any range or subrange therebetween. In aspects, the central thickness 226 as a percentage of the substrate thickness 222 (e.g., first thickness, second thickness) can range from about 0.5% to about 60%, from about 1% to about 60%, from about 2% to about 60%, from about 5% to about 55%, from about 10% to about 50%, from about 15% to about 45%, from about 20% to about 45%, from about 25% to about 45%, from about 35% to about 45%, or any range or subrange therebetween.

In further aspects, the central thickness 226 can be within one or more of the ranges for the substrate thickness 222 (e.g., first thickness, second thickness) while being less than the substrate thickness 222. In further aspects, the central thickness 226 can be about 10 μm or more, about 25 μm or more, about 50 μm or more, about 80 μm or more, about 220 μm or less, about 125 μm or less, about 100 μm or less, about 80 μm or less, about 60 μm or less, or about 40 μm or less. In even further aspects, the central thickness 226 can range from about 10 μm to about 220 μm, from about 10 μm to about 125 μm, from about 10 μm to about 100 μm, from about 10 μm to about 80 μm, from about 25 μm to about 80 μm, from about 25 μm to about 60 μm, from about 50 μm to about 60 μm, or any range or subrange therebetween. In further aspects, the central thickness 226 can be greater than about 80 μm, for example, about 80 μm or more, about 100 μm or more, about 125 μm or more, about 220 μm or less, about 175 μm or less, or about 150 μm or less. In even further aspects, the central thickness 226 can range from about 80 μm to about 220 μm, from about 80 μm to about 175 μm, from about 80 μm to about 150 μm, from about 100 μm to about 150 μm, from about 125 μm to about 150 μm, or any range or subrange therebetween. In further aspects, the central thickness 226 can be less than about 80 μm, for example, ranging from about 10 μm to about 80 μm, from about 25 μm to about 60 μm, from about 10 μm to about 50 μm, from about 25 μm to about 50 μm, from about 10 μm to about 40 μm, from about 25 μm to about 40 μm, or any range or subrange therebetween.

As shown in FIGS. 2 and 7, the central portion 251 can comprise a first transition region 253. The first transition region 253 can attach the first portion 221 to a region of the central portion 251 comprising the central thickness 226 (e.g., region comprising the first central surface area 211). For example, a first transition surface area 257 of the first transition region 253 can attach the first surface area 223 to the first central surface area 211. A thickness of the first transition region 253 can be defined between the second plane 204b and the first transition surface area 257 in the direction 202 of the substrate thickness 222. As shown in FIGS. 2 and 7, the thickness of the first transition region 253 can continuously increase from the first central surface area 211 (e.g., the central thickness 226) to the first portion 221 (e.g., the first thickness, substrate thickness 222). In aspects, as shown, the thickness of the first transition region 253 can increase at a constant rate from the first central surface area 211 to the first portion 221. In aspects, although not shown, the thickness of the first transition region 253 may increase more slowly where the first central surface area 211 meets the first transition region 253 than in the middle of the first transition region 253. In aspects, although not shown, the thickness of the first transition region 253 may increase more slowly where the first portion 221 meets the first transition region 253 than in the middle of the first transition region 253. In aspects, as shown in FIG. 3, the central portion 251 may not comprise a first transition region.

The central portion 251 can comprise a second transition region 255. As shown in FIGS. 2 and 7, the second transition region 255 can attach the second portion 231 to a region of the central portion 251 comprising the central thickness 226 (e.g., region comprising the first central surface area 211). For example, a second transition surface area 259 of the second transition region 255 can attach the third surface area 233 to the first central surface area 211. A thickness of the second transition region 255 can be defined between the second plane 204b and the second transition surface area 259 in the direction 202 of the substrate thickness 222. As shown in FIGS. 2 and 7, the thickness of the second transition region 255 can continuously increase from the first central surface area 211 (e.g., the central thickness 226) to the second portion 231 (e.g., the first thickness, substrate thickness 222). In aspects, as shown, the thickness of the second transition region 255 can increase at a constant rate from the first central surface area 211 to the second portion 231. In aspects, although not shown, the thickness of the second transition region 255 may increase more slowly where the first central surface area 211 meets the second transition region 255 than in the middle of the second transition region 255. In aspects, although not shown, the thickness of the second transition region 255 may increase more slowly where the second portion 231 meets the second transition region 255 than in the middle of the second transition region 255. In aspects, as shown in FIG. 3, the central portion 251 may not comprise a second transition region.

As shown in FIGS. 2 and 7, a width 254a of the first transition region 253 can be defined between the first central surface area 211 and the first portion 221 in the direction 106 of the length 105 of the foldable apparatus 101. A width 254b of the second transition region 255 can be defined between the first central surface area 211 and the second portion 231 in the direction 106 of the length 105 of the foldable apparatus 101. In aspects, the width 254a of the first transition region 253 and/or the width 254b of the second transition region 255 can be sufficiently large (e.g., 0.5 mm or more) to avoid optical distortions that may otherwise occur at a step transition or small transition width (e.g., less than 0.1 mm) between the substrate thickness and central thickness. In aspects, to enhance puncture resistance of the foldable substrate while also avoiding optical distortions, the width 254a of the first transition region 253 and/or the width 254b of the second transition region 255 can be about 0.5 mm or more, about 0.6 mm or more, about 0.7 mm or more, about 0.8 mm or more, about 0.9 mm or more, about 1 mm or more, about 2 mm or more, about 3 mm or more, about 5 mm or less, about 4 mm or less, about 3 mm or less, about 1 mm or less, or about 0.8 mm or less. In aspects, the width 254a of the first transition region 253 and/or the width 254b of the second transition region 255 can range from 0.5 mm to about 5 mm, from about 0.7 mm to about 5 mm, from about 1 mm to about 5 mm, from about 2 mm to about 5 mm, from about 2 mm to about 3 mm, from about 3 mm to about 5 mm, from about 3 mm to about 4 mm, or any range or subrange therebetween. In aspects, the width 254a of the first transition region 253 and/or the width 254b of the second transition region 255 can range from 0.5 mm to about 5 mm, from about 0.5 mm to about 4 mm, from about 0.5 mm to about 3 mm, from about 0.5 mm to about 1 mm, from about 0.6 mm to about 0.8 mm, from about 0.7 mm to about 0.8 mm, or any range or subrange therebetween.

As used herein, if a first layer and/or component is described as “disposed over” a second layer and/or component, other layers may or may not be present between the first layer and/or component and the second layer and/or component. Furthermore, as used herein, “disposed over” does not refer to a relative position with reference to gravity. For example, a first layer and/or component can be considered “disposed over” a second layer and/or component, for example, when the first layer and/or component is positioned underneath, above, or to one side of a second layer and/or component. As used herein, a first layer and/or component described as “bonded to” a second layer and/or component means that the layers and/or components are bonded to each other, either by direct contact and/or bonding between the two layers and/or components or via an adhesive layer. As used herein, a first layer and/or component described as “contacting” or “in contact with” a second layer and/or components refers to direct contact and includes the situations where the layers and/or components are bonded to each other.

As shown in FIGS. 2-4, the foldable apparatus 101, 301, and/or 401 can comprise an adhesive layer 261. As shown, the adhesive layer 261 can comprise a first contact surface 263 and a second contact surface 265 that can be opposite the first contact surface 263. In aspects, as shown, the second contact surface 265 of the adhesive layer 261 can comprise a planar surface. In aspects, as shown in FIG. 4, the first contact surface 263 of the adhesive layer 261 can comprise a planar surface. An adhesive thickness 267 of the adhesive layer 261 can be defined between the first contact surface 263 and the second contact surface 265. In aspects, the adhesive thickness 267 of the adhesive layer 261 can be about 1 μm or more, about 5 μm or more, about 10 μm or more, about 100 μm or less, about 60 μm or less, about 30 μm or less, or about 20 μm or less. In aspects, the adhesive thickness 267 of the adhesive layer 261 can range from about 1 μm to about 100 μm, from about 5 μm to about 60 μm, from about 10 μm to about 30 μm, from about 10 μm to about 20 μm, or any range or subrange therebetween.

In aspects, as shown in FIGS. 2 and 4, the first contact surface 263 of the adhesive layer 261 can face and/or contact the second major surface 275 of the release liner 271. In aspects, as shown in FIG. 3, the first contact surface 263 of the adhesive layer 261 can face and/or contact the second major surface 305 of the display device 307.

In aspects, as shown in FIGS. 2-3, the second contact surface 265 of the adhesive layer 261 can face the first surface area 223 of the first portion 221. In further aspects, as shown, the second contact surface 265 of the adhesive layer 261 can contact the first surface area 223 of the first portion 221. In aspects, as shown, the second contact surface 265 of the adhesive layer 261 can face the third surface area 233 of the second portion 231. In further aspects, as shown, the second contact surface 265 of the adhesive layer 261 can contact the third surface area 233 of the second portion 231. In aspects, as shown in FIGS. 2-3, a recess 219 can be defined between the first central surface area 211 and the first plane 204a. In further aspects, the recess 219 can be defined between the third plane 204c and the first plane 204a. In further aspects, as shown, the adhesive layer 261 can be at least partially positioned in the recess 219. In further aspects, as shown, the adhesive layer 261 can fill the recess 219. In aspects, although not shown, the recess may not be totally filled, for example, to leave room for electronic devices and/or mechanical devices. In aspects, although not shown, the foldable substrate can be flipped 180 degrees such that the second contact surface of the adhesive layer contacts the second major surface of the foldable substrate.

In aspects, as shown in FIG. 4, the second contact surface 265 of the adhesive layer 261 can face and/or contact the first major surface 403 of the foldable substrate 407. In aspects, although not shown, the foldable substrate can be flipped 180 degrees such that the second contact surface of the adhesive layer contacts the second major surface of the foldable substrate.

In aspects, the adhesive layer 261 can comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and polyether ether ketone (PEEK). Example aspects of polyolefins include low molecular weight polyethylene (LDPE), high molecular weight polyethylene (HDPE), ultrahigh molecular weight polyethylene (UHMWPE), and polypropylene (PP). Example aspects of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Example aspects of elastomers include rubbers (e.g., polybutadiene, polyisoprene, chloroprene rubber, butyl rubber, nitrile rubber), and block copolymers (e.g., styrene-butadiene, high-impact polystyrene, poly(dichlorophosphazene). In further aspects, the adhesive layer 261 can comprise an optically clear adhesive. In even further aspects, the optically clear adhesive can comprise one or more optically transparent polymers: an acrylic (e.g., polymethylmethacrylate (PMMA)), an epoxy, silicone, and/or a polyurethane. Examples of epoxies include bisphenol-based epoxy resins, novolac-based epoxies, cycloaliphatic-based epoxies, and glycidylamine-based epoxies. In even further aspects, the optically clear adhesive can comprise, but is not limited to acrylic adhesives, for example, 3M 8212 adhesive, or an optically transparent liquid adhesive, for example, a LOCTITE optically transparent liquid adhesive. Exemplary aspects of optically clear adhesives comprise transparent acrylics, epoxies, silicones, and polyurethanes. For example, the optically transparent liquid adhesive could comprise one or more of LOCTITE AD 8650, LOCTITE AA 3922, LOCTITE EA E-05MR, LOCTITE UK U-09LV, which are all available from Henkel.

As shown in FIG. 5, the foldable apparatus 501 can comprise a polymer-based portion 561. In aspects, as shown, the polymer-based portion 561 can comprise a first contact surface 563 opposite a second contact surface 565. In aspects, as shown, the first contact surface 563 and/or the second contact surface 565 can comprise a planar surface. In further aspects, the second contact surface 565 may be substantially coplanar (e.g., extend along a common plane) with the first major surface 403 of the foldable substrate 407. In aspects, in addition to the second contact surface 565 being substantially coplanar with the first major surface 403, the first contact surface 563 can be substantially parallel with the second major surface 405. In aspects, a polymer thickness 567 defined between the first contact surface 563 and the second contact surface 565 can be within one or more of the ranges discussed above for the adhesive thickness 267.

In aspects, the polymer-based portion 561 comprises a polymer (e.g., optically transparent polymer). In further aspects, the polymer-based portion 561 can comprise one or more of an optically transparent: an acrylic (e.g., polymethylmethacrylate (PMMA)), an epoxy, a silicone, and/or a polyurethane. Examples of epoxies include bisphenol-based epoxy resins, novolac-based epoxies, cycloaliphatic-based epoxies, and glycidylamine-based epoxies. In further aspects, the polymer-based portion 561 can comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and polyether ether ketone (PEEK). Example aspects of polyolefins include low molecular weight polyethylene (LDPE), high molecular weight polyethylene (HDPE), ultrahigh molecular weight polyethylene (UHMWPE), and polypropylene (PP). Example aspects of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Example aspects of elastomers include rubbers (e.g., polybutadiene, polyisoprene, chloroprene rubber, butyl rubber, nitrile rubber), and block copolymers (e.g., styrene-butadiene, high-impact polystyrene, poly(dichlorophosphazene), for example, comprising one or more of polystyrene, polydichlorophosphazene, and poly(5-ethylidene-2-norbornene). In aspects, the polymer-based portion can comprise a sol-gel material. Example aspects of polyurethanes comprise thermoset polyurethanes, for example Dispurez 102 available from Incorez, and thermoplastic polyurethanes, for example, KrystalFlex PE505 available from Huntsman. In even further aspects, the second portion can comprise an ethylene acid copolymer. An exemplary aspect of an ethylene acid copolymer includes SURLYN available from Dow (e.g., Surlyn PC-2000, Surlyn 8940, Surlyn 8150). An additional exemplary aspect for the second portion comprises Eleglass w802-GL044 available from Axalta with from 1 wt % to 2 wt % cross-linker. In aspects, the polymer-based portion 561 can further comprise nanoparticles, for example, carbon black, carbon nanotubes, silica nanoparticles, or nanoparticles comprising a polymer. In aspects, the polymer-based portion can further comprise fibers to form a polymer-fiber composite.

In aspects, the polymer-based portion 561 can comprise an elastic modulus of about 0.01 MegaPascals (MPa) or more, about 1 MPa or more, about 10 MPa or more, about 20 MPa or more, about 100 MPa or more, about 200 MPa or more, about 1,000 MPa or more, about 5,000 MPa or less, about 3,000 MPa or less, about 1,000 MPa or less, about 500 MPa or less, or about 200 MPa or less. In aspects, the polymer-based portion 561 can comprise an elastic modulus ranging from about 0.001 MPa to about 5,000 MPa, from about 1 MPa to about 1,000 MPa, from about 10 MPa to about 1,000 MPa, about 20 MPa to about 200 MPa, from about 100 MPa to about 200 MPa, from about 200 MPa to about 5,000 MPa, from about 200 MPa to about 3,000 MPa, from about 200 MPa to about 1,000 MPa, or any range or subrange therebetween. In aspects, the elastic modulus of the polymer-based portion 561 can range from about 1 GPa to about 20 GPa, from about 1 GPa to about 18 GPa, from about 1 GPa to about 10 GPa, from about 1 GPa to about 5 GPa, from about 1 GPa to about 3 GPa, or any range or subrange therebetween. By providing a polymer-based portion 561 with an elastic modulus ranging from about 0.01 MPa to about 3,000 MPa (e.g., from about 20 MPa to about 3 GPa), folding of the foldable apparatus without failure can be facilitated. In aspects, the elastic modulus of the polymer-based portion 561 can be less than the elastic modulus of the foldable substrate 407. In aspects, the adhesive layer 261 may comprise an elastic modulus within the ranges listed above in this paragraph. In further aspects, the adhesive layer 261 may comprise substantially the same elastic modulus as the elastic modulus of the polymer-based portion 561. In further aspects, the elastic modulus of the adhesive layer 261 can range from about 1 GPa to about 20 GPa, from about 1 GPa to about 18 GPa, from about 1 GPa to about 10 GPa, from about 1 GPa to about 5 GPa, from about 1 GPa to about 3 GPa, or any range or subrange therebetween.

In aspects, the adhesive layer 261 can comprise an elastic modulus of about 0.001 MegaPascals (MPa) or more, about 0.01 MPa or more, about 0.1 MPa or more, about 1 MPa or less, about 0.5 MPa or less, about 0.1 MPa or less, or about 0.05 MPa or less. In aspects, the adhesive layer 261 can comprise an elastic modulus ranging from about 0.001 MPa to about 1 MPa, from about 0.01 MPa to about 0.5 MPa, from about 0.05 MPa to about 0.5 MPa, from about 0.1 MPa to about 0.5 MPa, from about 0.001 MPa to about 0.01 MPa, or any range or subrange therebetween. In aspects, the adhesive layer can comprise an elastic modulus within one or more of the ranges discussed above for the elastic modulus of the polymer-based portion 561.

In aspects, as shown in FIG. 5, a coating 507 can be disposed over the second major surface 405 of the foldable substrate 407. In aspects, although not shown, the coating can be disposed over the second major surface 205 of the foldable substrate 201. In further aspects, the coating can be disposed over the first portion 221, the second portion 231, and the central portion 251. In further aspects, as shown in FIG. 5, the coating 507 can contact the foldable substrate 407 (e.g., second major surface 405). In further aspects, as shown, the coating 507 can comprise a coating thickness 509 defined between a third major surface 503 and a fourth major surface 505 opposite the third major surface 503. In even further aspects, the coating thickness 509 of the coating 507 can be about 0.1 μm or more, about 1 μm or more, about 5 μm or more, about 10 μm or more, about 15 μm or more, about 20 μm or more, about 25 μm or more, about 40 μm or more, about 50 μm or more, about 60 μm or more, about 70 μm or more, about 80 μm or more, about 90 μm or more, about 200 μm or less, about 100 μm or less, or about 50 μm or less, about 30 μm or less, about 25 μm or less, about 20 μm or less, about 20 μm or less, about 15 μm or less, or about 10 μm or less. In even further aspects, the coating thickness 509 of the coating 507 can range from about 0.1 μm to about 200 μm, from about 1 μm to about 100 μm, from about 10 μm to about 100 μm, from about 20 μm to about 100 μm, from about 30 μm to about 100 μm, from about 40 μm to about 100 μm, from about 50 μm to about 100 μm, from about 60 μm to about 100 μm, from about 70 μm to about 100 μm, from about 80 μm to about 100 μm, from about 90 μm to about 100 μm, from about 0.1 μm to about 50 μm, from about 1 μm to about 50 μm, from about 10 μm to about 50 μm, or any range or subrange therebetween. In still further aspects, the coating thickness 509 can range from about 0.1 μm to about 50 μm, from about 0.1 μm to about 30 μm, from about 1 μm to about 25 μm, from about 1 μm to about 20 μm, from about 5 μm to about 15 μm, from about 5 μm to about 10 μm, from about 10 μm to about 30 μm, from about 15 μm to about 30 μm, from about 15 μm to about 25 μm, from about 15 μm to about 20 μm, or any range or subrange therebetween.

In aspects, the coating 507 can comprise a polymeric coating. In further aspects, the polymeric coating can comprise one or more of an ethylene-acid copolymer, a polyurethane-based polymer, an acrylate resin, and a mercapto-ester resin. Example aspects of ethylene-acid copolymers include ethylene-acrylic acid copolymers, ethylene-methacrylic acid copolymers, and ethylene-acrylic-methacrylic acid terpolymers (e.g., Nucrel (DuPont)), ionomers of ethylene acid copolymers (e.g., Surlyn (DuPont)), and ethylene-acrylic acid copolymer amine dispersions (e.g., Aquacer (BYK)). Example aspects of polyurethane-based polymers include aqueous modified polyurethane dispersions (e.g., Eleglas (Axalta)). Example aspects of acrylate resins which can be UV curable include acrylate resins (e.g., Uvekol resin (Allinex)), cyanoacrylate adhesives (e.g., Permabond UV620 (Krayden)), and UV radical acrylic resins (e.g., Ultrabond windshield repair resin, for example, Ultrabond (45CPS)). Example aspects of mercapto-ester resins include mercapto-ester triallyl isocyanurates (e.g., Norland optical adhesive NOA 61). In further aspects, the polymeric coating can comprise ethylene-acrylic acid copolymers and ethylene-methacrylic acid copolymers, which may be ionomerized to form ionomer resins through neutralization of the carboxylic acid residue with typically alkali metal ions, for example sodium, and potassium and also zinc. Such ethylene-acrylic acid and ethylene-methacrylic acid ionomers may be dispersed within water and coated onto the substrate to form an ionomer coating. Alternatively, such acid copolymers may be neutralized with ammonia which, after coating and drying liberates the ammonia to reform the acid copolymer as the coating. By providing a coating comprising a polymeric coating, the foldable apparatus can comprise low energy fracture.

In aspects, the coating 507 can comprise a polymeric coating comprising an optically transparent polymeric coating layer. Suitable materials for an optically transparent polymeric coating layer include, but are not limited to: a cured acrylate resin material, an inorganic-organic hybrid polymeric material, an aliphatic or aromatic hexafunctional urethane acrylate, a siloxane-based hybrid material, and a nanocomposite material, for example an epoxy and urethane material with nanosilicate. In aspects, an optically transparent polymeric coating layer may consist essentially of one or more of these materials. In aspects, an optically transparent polymeric coating layer may consist of one or more of these materials. As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example inorganic particulate dispersed within an organic matrix. More specifically, suitable materials for an optically transparent polymeric (OTP) coating layer include, but are not limited to, a polyimide, a polyethylene terephthalate (PET), a polycarbonate (PC), a poly methyl methacrylate (PMMA), organic polymer materials, inorganic-organic hybrid polymeric materials, and aliphatic or aromatic hexafunctional urethane acrylates. In aspects, an OTP coating layer may consist essentially of an organic polymer material, an inorganic-organic hybrid polymeric material, or aliphatic or aromatic hexafunctional urethane acrylate. In aspects, an OTP coating layer may consist of a polyimide, an organic polymer material, an inorganic-organic hybrid polymeric material, or aliphatic or aromatic hexafunctional urethane acrylate. In aspects, an OTP coating layer may include a nanocomposite material. In aspects, an OTP coating layer may include a nano-silicate at least one of epoxy and urethane materials. Suitable compositions for such an OTP coating layer are described in U.S. Pat. Pub. No. 2015/0110990, which is hereby incorporated by reference in its entirety by reference thereto. As used herein, “organic polymer material” means a polymeric material comprising monomers with only organic components. In aspects, an OTP coating layer may comprise an organic polymer material manufactured by Gunze Limited and having a hardness of 9H, for example Gunze's “Highly Durable Transparent Film.” As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example inorganic particulate dispersed within an organic matrix. In aspects, the inorganic-organic hybrid polymeric material may include polymerized monomers comprising an inorganic silicon-based group, for example, a silsesquioxane polymer. A silsesquioxane polymer may be, for example, an alky-silsesquioxane, an aryl-silsesquioxane, or an aryl alkyl-silsesquioxane having the following chemical structure: (RSiO_{1.5})ₙ, where R is an organic group for example, but not limited to, methyl or phenyl. In aspects, an OTP coating layer may comprise a silsesquioxane polymer combined with an organic matrix, for example, SILPLUS manufactured by Nippon Steel Chemical Co., Ltd. In aspects, an OTP coating layer may comprise from 90 wt % to 95 wt % aromatic hexafunctional urethane acrylate (e.g., PU662NT (Aromatic hexafunctional urethane acrylate) manufactured by Miwon Specialty Chemical Co.) and 10 wt % to 5 wt % photo-initiator (e.g., Darocur 1173 manufactured by Ciba Specialty Chemicals Corporation) with a hardness of 8H or more. In aspects, an OTP coating layer composed of an aliphatic or aromatic hexafunctional urethane acrylate may be formed as a stand-alone layer by spin-coating the layer on a polyethylene terephthalate (PET) substrate, curing the urethane acrylate, and removing the urethane acrylate layer from the PET substrate. An OTP coating layer may have a coating thickness ranging of 1 μm to 150 μm, including subranges; for example, from 10 μm to 140 μm, from 20 μm to 130 μm, 30 μm to 120 μm, from 40 μm to 110 μm, from 50 μm to 100 μm, from 60 μm to 90 μm, from 70 μm to 80 μm, or any range or subrange therebetween. In aspects, an OTP coating layer may be a single monolithic layer. In aspects, an OTP coating layer may be an inorganic-organic hybrid polymeric material layer or an organic polymer material layer having a thickness in the range of 80 μm to 120 μm, including subranges. For example, an OTP coating layer comprising an inorganic-organic hybrid polymeric material or an organic polymer material may have a thickness of from 80 μm to 110 μm, 90 μm to 100 μm, or any range or subrange therebetween. In aspects, an OTP coating layer may be an aliphatic or aromatic hexafunctional urethane acrylate material layer having a thickness within one or more of the thickness ranges discussed above in this paragraph or for the coating thickness 509.

In aspects, the coating 507, if provided, may also comprise one or more of an easy-to-clean coating, a low-friction coating, an oleophobic coating, a diamond-like coating, a scratch-resistant coating, or an abrasion-resistant coating. A scratch-resistant coating may comprise an oxynitride, for example, aluminum oxynitride or silicon oxynitride with a thickness of about 500 micrometers or more. In such aspects, the abrasion-resistant layer may comprise the same material as the scratch-resistant layer. In aspects, a low friction coating may comprise a highly fluorinated silane coupling agent, for example, an alkyl fluorosilane with oxymethyl groups pendant on the silicon atom. In such aspects, an easy-to-clean coating may comprise the same material as the low friction coating. In other aspects, the easy-to-clean coating may comprise a protonatable group, for example an amine, for example, an alkyl aminosilane with oxymethyl groups pendant on the silicon atom. In such aspects, the oleophobic coating may comprise the same material as the easy-to-clean coating. In aspects, a diamond-like coating comprises carbon and may be created by applying a high voltage potential in the presence of a hydrocarbon plasma.

In aspects, although not shown, a coating can be disposed over the first major surface 203 of the foldable substrate 201 with one or more of an adhesive layer, polymer-based portion, release liner, or display device facing the second major surface 205 instead of the first major surface 203. In further aspects, at least a part of the coating can be positioned in the recess 219. In even further aspects, the coating can fill the recess 219.

In aspects, as shown in FIGS. 2 and 4, the foldable apparatus 101 and 401 can comprise the release liner 271 although other substrates (e.g., a glass-based substrate discussed throughout the application) may be used in further aspects rather than the illustrated release liner 271. In further aspects, as shown, the release liner 271, or other substrates, can be disposed over the adhesive layer 261. In even further aspects, as shown, the release liner 271, or other substrates, can directly contact the first contact surface 263 of the adhesive layer 261. As shown, the release liner 271, or other substrates, can be disposed on the adhesive layer 261 by attaching the first contact surface 263 of the adhesive layer 261 to the second major surface 275 of the release liner 271, or other substrates. In aspects, as shown, the first major surface 273 of the release liner 271, or other substrates, can comprise a planar surface. In aspects, as shown, the second major surface 275 of the release liner 271, or other substrates, can comprise a planar surface. A substrate comprising the release liner 271 can comprise a paper and/or a polymer. Exemplary aspects of paper comprise kraft paper, machine-finished paper, poly-coated paper (e.g., polymer coated, glassine paper, siliconized paper), or clay-coated paper. Exemplary aspects of polymers comprise polyesters (e.g., polyethylene terephthalate (PET)) and polyolefins (e.g., low-density polyethylene (LDPE), high-density polyethylene (HDPE), polypropylene (PP)).

In aspects, as shown in FIGS. 3 and 5, the foldable apparatus 301 and 501 can comprise the display device 307. In further aspects, as shown in FIG. 3, the display device 307 can be disposed over the adhesive layer 261. In even further aspects, as shown, the display device 307 can contact the first contact surface 263 of the adhesive layer 261. In further aspects, as shown in FIG. 5, the display device 307 can be disposed over the polymer-based portion 561. In even further aspects, as shown, the display device 307 can contact the first contact surface 563 of the polymer-based portion 561. In aspects, producing the foldable apparatus 301 may be achieved by removing the release liner 271 of the foldable apparatus 101 of FIG. 2 and attaching the display device 307 to the first contact surface 263 of the adhesive layer 261. Alternatively, the foldable apparatus 301 may be produced without the extra step of removing a release liner 271 before attaching the display device 307 to the first contact surface 263 of the adhesive layer 261 or the first contact surface 563 of the polymer-based portion 561, for example, when a release liner 271 is not applied to the first contact surface 263 of the adhesive layer 261. The display device 307 can comprise a first major surface 303 and a second major surface 305 opposite the first major surface 303. As shown in FIG. 3, the display device 307 can be disposed on the adhesive layer 261 by attaching the first contact surface 263 of the adhesive layer 261 to the second major surface 305 of the display device 307. As shown in FIG. 5, the display device 307 can be disposed on the polymer-based portion 561 by attaching the first contact surface 563 of the polymer-based portion 561 to the second major surface 305 of the display device 307. In aspects, as shown, the first major surface 303 of the display device 307 can comprise a planar surface. In aspects, as shown, the second major surface 305 of the display device 307 can comprise a planar surface. The display device 307 can comprise a liquid crystal display (LCD), an electrophoretic display (EPD), an organic light-emitting diode (OLED) display, or a plasma display panel (PDP). In aspects, the display device 307 can be part of a portable electronic device, for example, a consumer electronic product, a smartphone, a tablet, a wearable device, or a laptop.

Aspects of the disclosure can comprise a consumer electronic product. The consumer electronic product can comprise a front surface, a back surface, and side surfaces. The consumer electronic product can further comprise electrical components at least partially within the housing. The electrical components can comprise a controller, a memory, and a display. The display can be at or adjacent to the front surface of the housing. The display can comprise a liquid crystal display (LCD), an electrophoretic display (EPD), an organic light-emitting diode (OLED) display, or a plasma display panel (PDP). The consumer electronic product can comprise a cover substrate disposed over the display. In aspects, at least one of a portion of the housing or the cover substrate comprises the foldable apparatus discussed throughout the disclosure. The consumer electronic product can comprise a portable electronic device, for example, a smartphone, a tablet, a wearable device, or a laptop.

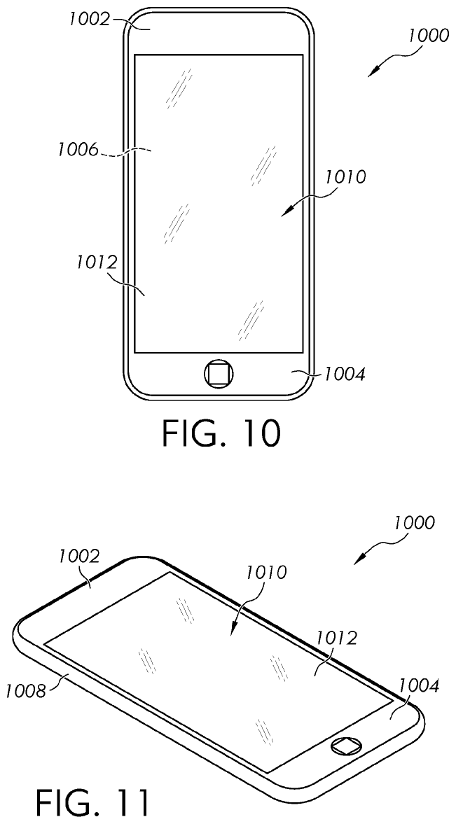

The foldable apparatus disclosed herein may be incorporated into another article, for example, an article with a display (or display articles) (e.g., consumer electronics, including mobile phones, tablets, computers, navigation systems, wearable devices (e.g., watches), and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the foldable apparatus disclosed herein is shown in FIGS. 10-11. Specifically, FIGS. 10-11 show a consumer electronic device 1000 including a housing 1002 having front 1004, back 1006, and side surfaces 1008. Although not shown, the consumer electronic device can comprise electrical components that are at least partially inside or entirely within the housing. For example, electrical components include at least a controller, a memory, and a display. As shown in FIGS. 10-11, the display 1010 can be at or adjacent to the front surface of the housing 1002. The consumer electronic device can comprise a cover substrate 1012 at or over the front surface of the housing 1002 such that it is over the display 1010. In aspects, at least one of the cover substrate 1012 or a portion of housing 1002 may include any of the foldable apparatus disclosed herein, for example, the foldable substrate.

In aspects, the foldable substrate 201 and/or 407 can comprise a glass-based substrate, and the first major surface 203 or 403 and/or second major surface 205 and/or 405 can comprise one or more compressive stress regions. In aspects, a compressive stress region may be created by chemically strengthening. In further aspects, the foldable substrate 201 can comprise a compressive stress region in the first portion 221, second portion 231, and/or central portion 251. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the foldable substrate 201 and/or 407 can enable good impact and/or puncture resistance (e.g., resists failure for a pen drop height of 20 centimeters). Without wishing to be bound by theory, chemically strengthening the foldable substrate 201 and/or 407 can enable small (e.g., smaller than about 10 mm or less) bend radii because the compressive stress from the chemical strengthening can counteract the bend-induced tensile stress on the outermost surface of the substrate. A compressive stress region may extend into a portion of the first portion and/or second portion for a depth called the depth of compression. As used herein, depth of compression means the depth at which the stress in the chemically strengthened substrates and/or portions described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate and/or portion is generated by exchanging potassium ions into the substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than about 400 μm, SCALP is used to measure the depth of compression and central tension (CT). Where the stress in the substrate and/or portion is generated by exchanging both potassium and sodium ions into the substrate and/or portion, and the article being measured is thicker than about 400 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate and/or portion (e.g., sodium, potassium). Through the disclosure, when the maximum central tension cannot be measured directly by SCALP (as when the article being measured is thinner than about 400 μm) the maximum central tension can be approximated by a product of a maximum compressive stress and a depth of compression divided by the difference between the thickness of the substrate and twice the depth of compression, wherein the compressive stress and depth of compression are measured by FSM. Throughout the disclosure, an absolute value of compressive stress is reported as compressive stress, and an absolute value of central tensile stress is reported as central tensile stress.

In aspects, the first major surface 203 or 403 of the foldable substrate 201 or 407 can comprise a first compressive stress region extending to a first depth of compression from the first major surface 203 or 403. In further aspects, the first portion 221 and/or second portion 231 can comprise the first compressive stress region extending from the first surface area 223 and/or third surface area 233. In further aspects, the first compressive stress region of the first portion 221 can be substantially the same as the first compressive stress region of the second portion 231.

In aspects, the second major surface 205 or 405 of the foldable substrate 201 or 407 can comprise a second compressive stress region extending to a second depth of compression from the second major surface 205 or 405. In further aspects, the first portion 221 and/or second portion 231 can comprise the second compressive stress region extending from the second surface area 225 and/or fourth surface area 235. In further aspects, the second compressive stress region of the first portion 221 can be substantially the same as the second compressive stress region of the second portion 231.

In aspects, the first depth of compression and/or the second depth of compression as a percentage of the substrate thickness 222 (e.g., first thickness, second thickness) can be about 1% or more, about 5% or more, about 10% or more, about 30% or less, about 25% or less, or about 20% or less. In aspects, the first depth of compression and/or the second depth of compression as a percentage of the substrate thickness 222 (e.g., first thickness, second thickness) can range from about 1% to about 30%, from about 5% to about 30%, from about 5% to about 25%, from about 5% to about 20%, from about 10% to about 30%, from about 10% to about 25%, from about 10% to about 20%, or any range or subrange therebetween. In further aspects, the first depth of compression and/or the second depth of compression as a percentage of the substrate thickness 222 (e.g., first thickness, second thickness) can be about 10% or less, for example, from about 1% to about 10%, from about 3% to about 8%, from about 5% to about 8%, or any range or subrange therebetween. In aspects, the first depth of compression and/or the second depth of compression can be about 1 μm or more, about 10 μm or more, about 30 μm or more, about 50 μm or more, about 200 μm or less, about 150 μm or less, about 100 μm or less, or about 60 μm or less. In aspects, the first depth of compression and/or the second depth of compression can range from about 1 μm to about 200 μm, from about 10 μm to about 150 μm, from about 30 μm to about 100 μm, from about 50 μm to about 60 μm, or any range or subrange therebetween. By providing a glass-based substrate comprising a first depth of compression and/or the second depth of compression ranging from about 1% to about 30% of the substrate thickness, good impact and/or puncture resistance can be enabled. In aspects, the first depth of compression can be substantially equal to the second depth of compression.

In aspects, the first compressive stress region can comprise a first maximum compressive stress and/or the second compressive stress region can comprise a second maximum compressive stress. In further aspects, the first maximum compressive stress can be substantially equal to the second maximum compressive stress. In further aspects, the first maximum compressive stress and/or second maximum compressive stress can be about 100 MegaPascals (MPa) or more, about 300 MPa or more, about 500 MPa or more, about 600 MPa or more, about 700 MPa or more, about 1,500 MPa or less, about 1,200 MPa or less, about 1,000 MPa or less, or about 800 MPa or less. In further aspects, the first maximum compressive stress and/or second maximum compressive stress can range from about 100 MPa to about 1,500 MPa, from about 300 MPa to about 1,200 MPa, from about 500 MPa to about 1,000 MPa, from about 600 MPa to about 1,000 MPa, from about 700 MPa to about 800 MPa, or any range or subrange therebetween. By providing a first maximum compressive stress and/or second maximum compressive stress ranging from about 100 MPa to about 1,500 MPa, good impact and/or puncture resistance can be enabled.

In aspects, a first depth of layer of one or more alkali metal ions can be associated with the first compressive stress region and the first depth of compression. As used herein, the one or more alkali metal ions of a depth of layer of one or more alkali metal ions can include sodium, potassium, rubidium, cesium, and/or francium. In aspects, a second depth of layer of one or more alkali metal ions can be associated with the second compressive stress region and the second depth of compression. In aspects, the one or more alkali ions of the first depth of layer of the one or more alkali ions and/or the second depth of layer of the one or more alkali ions comprises potassium. In aspects, the first depth of layer can be substantially equal to the second depth of layer. In aspects, the first depth of layer and/or the second depth of layer as a percentage of the substrate thickness 222 (e.g., first thickness, second thickness) can be about 1% or more, about 5% or more, about 10% or more, about 40% or less, about 35% or less, about 30% or less, about 25% or less, or about 20% or less. In aspects, the first depth of layer and/or the second depth of layer as a percentage of the substrate thickness 222 (e.g., first thickness, second thickness) can range from about 1% to about 40%, from about 1% to about 35%, from about 1% to about 30%, from about 5% to about 30%, from about 10% to about 30%, from about 10% to about 25%, from about 10% to about 20%, or any range or subrange therebetween. In further aspects, the first depth of layer and/or the second depth of layer of the one or more alkali metal ions as a percentage of the substrate thickness 222 (e.g., first thickness, second thickness) can be about 10% or less, for example, from about 1% to about 10%, from about 1% to about 8%, from about 3% to about 8%, from about 5% to about 8%, or any range or subrange therebetween. In aspects, the first depth of layer and/or the second depth of layer of the one or more alkali metal ions can be about 1 μm or more, about 10 μm or more, about 30 μm or more, about 50 μm or more, about 200 μm or less, about 150 μm or less, about 100 μm or less, or about 60 μm or less. In aspects, the first depth of layer of the one or more alkali metal ions can range from about 1 μm to about 200 μm, from about 1 μm to about 150 μm, from about 10 μm to about 150 μm, from about 30 μm to about 100 μm, from about 50 μm to about 60 μm, or any range or subrange therebetween.

In aspects, the central portion 251 of the foldable substrate 201 can comprise a first central compressive stress region at the first central surface area 211 that can extend to first central depth of compression from the first central surface area 211. In aspects, the central portion 251 of the foldable substrate 201 can comprise a second central compressive stress region at the second central surface area 213 that can extend to a second central depth of the compression from the second central surface area 213. In aspects, the first central depth of compression can be substantially equal to the second central depth of compression. In aspects, the first central depth of compression and/or the second central depth of compression as a percentage of the central thickness 226 can be about 1% or more, about 5% or more, about 10% or more, about 30% or less, about 25% or less, or about 20% or less. In aspects, the first central depth of compression and/or the second central depth of compression as a percentage of the central thickness 226 can range from about 1% to about 30%, from about 10% to about 25%, from about 10% to about 20%, or any range or subrange therebetween. In further aspects, the first central depth of compression and/or the second central depth of compression as a percentage of the central thickness 226 can be about 10% or more, for example, from about 10% to about 30%, from about 10% to about 25%, from about 15% to about 25%, from about 15% to about 20%, or any range or subrange therebetween. In aspects, the first central depth of compression and/or the second central depth of compression can be about 1 μm or more, about 10 μm or more, about 30 μm or more, about 50 μm or more, about 200 μm or less, about 150 μm or less, about 100 μm or less, or about 60 μm or less. In aspects, the first central depth of compression and/or the second central depth of compression can range from about 1 μm to about 200 μm, from about 1 μm to about 150 μm, from about 10 μm to about 100 μm, from about 30 μm to about 60 μm, from about 50 μm to about 60 μm, or any range or subrange therebetween. By providing a central portion comprising the first central depth of compression and/or the second central depth of compression ranging from about 1% to about 30% of the central thickness, good impact and/or puncture resistance can be enabled.

In aspects, the first central compressive stress region can comprise a first central maximum compressive stress. In aspects, the second central compressive stress region can comprise a second central maximum compressive stress. In aspects, the first central maximum compressive stress can be substantially equal to the second central maximum compressive stress. In aspects, the first central maximum compressive stress and/or the second central maximum compressive stress can be about 100 MegaPascals (MPa) or more, about 300 MPa or more, about 500 MPa or more, about 600 MPa or more, about 700 MPa or more, about 1,500 MPa or less, about 1,200 MPa or less, about 1,000 MPa or less, or about 800 MPa or less. In further aspects, the first central maximum compressive stress and/or the second central maximum compressive stress can range from about 100 MPa to about 1,500 MPa, from about 100 MPa to about 1,200 MPa, from about 300 MPa to about 1,200 MPa, from about 500 MPa to about 1,000 MPa, from about 600 MPa to about 1,000 MPa, from about 700 MPa to about 1,000 MPa, from about 700 MPa to about 800 MPa, or any range or subrange therebetween. By providing a first central maximum compressive stress and/or a second central maximum compressive stress ranging from about 100 MPa to about 1,500 MPa, good impact and/or puncture resistance can be enabled.

In aspects, the central portion 251 can comprise a first central depth of layer of one or more alkali metal ions associated with the first central compressive stress region and first central depth of compression. In aspects, the central portion 251 can comprise a second central depth of layer of one or more alkali metal ions associated with the second central compressive stress region and the second central depth of compression. In aspects, the one or more alkali ions of the first central depth of layer of the one or more alkali ions and/or the second central depth of layer of the one or more alkali ions comprises potassium. In aspects, the first central depth of layer can be substantially equal to the second central depth of layer. In aspects, the first central depth of layer and/or the second central depth of layer as a percentage of the central thickness 226 can be about 1% or more, about 5% or more, about 10% or more, about 40% or less, about 35% or less, about 30% or less, about 25% or less, or about 20% or less. In aspects, the first central depth of layer and/or the second central depth of layer as a percentage of the central thickness 226 can range from about 1% to about 40%, from about 1% to about 35%, from about 1% to about 30%, from about 5% to about 30%, from about 5% to about 25%, from about 10% to about 25%, from about 10% to about 20%, or any range or subrange therebetween. In further aspects, the first central depth of layer and/or the second central depth of layer as a percentage of the central thickness 226 can be about 10% or less, for example, from about 1% to about 10%, from about 3% to about 8%, from about 5% to about 8%, or any range or subrange therebetween. In aspects, the first central depth of layer and/or the second central depth of layer can be about 1 μm or more, about 10 μm or more, about 30 μm or more, about 50 μm or more, about 200 μm or less, about 150 μm or less, about 100 μm or less, or about 60 μm or less. In aspects, the first central depth of layer and/or the second central depth of layer can range from about 1 μm to about 200 μm, from about 1 μm to about 150 μm, from about 10 μm to about 150 μm, from about 30 μm to about 100 μm, from about 50 μm to about 60 μm, or any range or subrange therebetween.

In aspects, the foldable substrate 201 and/or 407 can comprise a first index of refraction. The first refractive index may be a function of a wavelength of light passing through the optically clear adhesive. For light of a first wavelength, a refractive index of a material is defined as the ratio between the speed of light in a vacuum and the speed of light in the corresponding material. Without wishing to be bound by theory, a refractive index of the optically clear adhesive can be determined using a ratio of a sine of a first angle to a sine of a second angle, where light of the first wavelength is incident from air on a surface of the optically clear adhesive at the first angle and refracts at the surface of the optically clear adhesive to propagate light within the optically clear adhesive at a second angle. The first angle and the second angle are both measured relative to a direction normal to a surface of the optically clear adhesive. As used herein, the refractive index is measured in accordance with ASTM E1967-19, where the first wavelength comprises 589 nm. In aspects, the first refractive index of the foldable substrate 201 and/or 407 may be about 1 or more, about 1.3 or more, about 1.4 or more, about 1.45 or more, about 1.49 or more, about 3 or less, about 2 or less, or about 1.7 or less, about 1.6 or less, or about 1.55 or less. In aspects, the first refractive index of the foldable substrate 201 and/or 407 can range from about 1 to about 3, from about 1 to about 2, from about 1.3 to about 1.7, from about 1.4 to about 1.6, from about 1.45 to about 1.55, from about 1.49 to about 1.55, or any range or subrange therebetween.

In aspects, the polymer-based portion 561, if present, can be optically clear. The polymer-based portion 561 can comprise a second index of refraction. In aspects, the second refractive index of the polymer-based portion 561 may be about 1 or more, about 1.3 or more, about 1.4 or more, about 1.45 or more, about 1.49 or more, about 3 or less, about 2 or less, or about 1.7 or less, about 1.6 or less, or about 1.55 or less. In aspects, the second refractive index of the polymer-based portion 561 can range from about 1 to about 3, from about 1 to about 2, from about 1.3 to about 1.7, from about 1.4 to about 1.6, from about 1.45 to about 1.55, from about 1.49 to about 1.55, or any range or subrange therebetween. In aspects, a differential equal to the absolute value of the difference between the second index of refraction of the polymer-based portion 561 and the first index of refraction of the foldable substrate 201 and/or 407 can be about 0.1 or less, about 0.07 or less, about 0.05 or less, about 0.001 or more, about 0.01 or more, or about 0.02 or more. In aspects, the differential ranging from about 0.001 to about 0.1, from about 0.001 to about 0.07, from about 0.01 to about 0.07, from about 0.01 to about 0.05, from about 0.02 to about 0.05, or any range or subrange therebetween. In aspects, the second index of refraction of the polymer-based portion 561 may be greater than the first index of refraction of the foldable substrate 201 and/or 407. In aspects, the second index of refraction of the polymer-based portion 561 may be less than the first index of refraction of the foldable substrate 201 and/or 407.

In aspects, the adhesive layer 261 can comprise a third index of refraction. In aspects, the third index of refraction of the adhesive layer 261 can be within one or more of the ranges discussed above with regards to the second index of refraction of the polymer-based portion 561. In aspects, a differential equal to the absolute value of the difference between the third index of refraction of the adhesive layer 261 and the first index of refraction of the foldable substrate 201 and/or 407 can be about 0.1 or less, about 0.07 or less, about 0.05 or less, about 0.001 or more, about 0.01 or more, or about 0.02 or more. In aspects, the differential ranging from about 0.001 to about 0.1, from about 0.001 to about 0.07, from about 0.01 to about 0.07, from about 0.01 to about 0.05, from about 0.02 to about 0.05, or any range or subrange therebetween. In aspects, the third index of refraction of the adhesive layer 261 may be greater than the first index of refraction of the foldable substrate 201 and/or 407. In aspects, the third index of refraction of the adhesive layer 261 may be less than the first index of refraction of the foldable substrate 201 and/or 407.

In aspects, a differential equal to the absolute value of the difference between the third index of refraction of the adhesive layer 261 and the second index of refraction of the polymer-based portion 561 can be about 0.1 or less, about 0.07 or less, about 0.05 or less, about 0.001 or more, about 0.01 or more, or about 0.02 or more. In aspects, the differential can range from about 0.001 to about 0.1, from about 0.001 to about 0.07, from about 0.001 to about 0.05, from about 0.01 to about 0.05, from about 0.02 to about 0.1, from about 0.02 to about 0.05, or any range or subrange therebetween. In aspects, the third index of refraction of the adhesive layer 261 may be greater than the second index of refraction of the polymer-based portion 561. In aspects, the third index of refraction of the adhesive layer 261 may be less than the second index of refraction of the polymer-based portion 561.

FIGS. 8-9 schematically illustrates aspects of a test foldable apparatus 902 and/or foldable apparatus 301 in accordance with aspects of the disclosure in a folded configuration. As shown in FIG. 9, the test foldable apparatus 902 is folded such that the second major surface 205 of the foldable substrate 201 is on the inside of the folded test foldable apparatus 902. In the folded configuration shown in FIG. 9, a user would view the display device 307 in place of a polyethylene terephthalate (PET) sheet 911 through the foldable substrate 201 and, thus, would be positioned on the side of the second major surface 205. Although not shown, the foldable apparatus can be folded such that the second major surface of the foldable substrate is on the outside of the folded foldable apparatus, where a user would view the display device through the foldable substrate and, thus, would be positioned on the side of the second major surface. In aspects, although not shown in a folded configuration, a foldable apparatus can comprise a coating disposed over the foldable substrate, where a user would view the display device through the coating.

As used herein, “foldable” includes complete folding, partial folding, bending, flexing, or multiple capabilities. As used herein, the terms “fail,” “failure,” and the like refer to breakage, destruction, delamination, or crack propagation. A foldable apparatus achieves an effective bend radius of “X,” or has an effective bend radius of “X,” or comprises an effective bend radius of “X” if it resists failure when the foldable apparatus is held at “X” radius for 24 hours at about 85° C. and about 85% relative humidity. Likewise, a foldable apparatus achieves a parallel plate distance of “X,” or has a parallel plate distance of “X,” or comprises a parallel plate distance of “X” if it resists failure when the foldable apparatus is held at a parallel plate distance of “X” for 24 hours at about 85° C. and about 85% relative humidity. In aspects, the foldable substrate and/or the foldable apparatus can be rollable. As used herein, a foldable substrate or a foldable apparatus is “rollable” if it can achieve a threshold parallel plate distance over a length of the corresponding foldable substrate and/or foldable apparatus that is the greater of 10 mm or 10% of the length of the corresponding foldable substrate and/or foldable apparatus.

As used herein, the “effective minimum bend radius” and “parallel plate distance” of a foldable apparatus is measured with the following test configuration and process using a parallel plate apparatus 901 (see FIG. 9) that comprises a pair of parallel rigid stainless-steel plates 903, 905 comprising a first rigid stainless-steel plate 903 and a second rigid stainless-steel plate 905. When measuring the “effective minimum bend radius” or the “parallel plate distance”, a test adhesive layer 909 comprises a thickness of 50 μm. For the foldable apparatus 101, 301, or 401 shown in FIGS. 2-4, the test adhesive layer 909 is used instead of the adhesive layer 261. For the foldable apparatus 501 shown in FIG. 5, the test adhesive layer 909 is used instead of the polymer-based portion 561. For the foldable apparatus 601 or 701 shown in FIGS. 6-7, the test adhesive layer 909 is used similar to how the adhesive layer 261 is used in FIG. 4 and FIG. 3, respectively. When measuring the “effective minimum bend radius” or the “parallel plate distance”, the test is conducted with a 100 μm thick polyethylene terephthalate (PET) sheet 911 rather than with the release liner 271 of FIGS. 2 and 4 or the display device 307 shown in FIGS. 3 and 5. For the foldable apparatus 601 or 701 shown in FIGS. 6-7, the PET sheet 911 is disposed over the test adhesive layer 909 so that the test adhesive layer 909 is positioned between the foldable substrate 201 or 407 and the PET sheet 911. Thus, during the test to determine the “effective minimum bend radius” or the “parallel plate distance” of a configuration of a foldable apparatus, the test foldable apparatus 902 is produced by using the 100 μm thick PET sheet 911 rather than with the release liner 271 of FIGS. 2 and 4 or the display device 307 shown in FIGS. 3 and 5. When preparing the test foldable apparatus 902, the 100 μm thick PET sheet 911 is attached to the test adhesive layer 909 in an identical manner that the release liner 271 is attached to the first contact surface 263 of the adhesive layer 261 as shown in FIGS. 2 and 4, the display device 307 is attached to the first contact surface 263 of the adhesive layer 261 as shown in FIG. 3, or the display device 307 is attached to the first contact surface 563 of the polymer-based portion 561 as shown in FIG. 5. To the foldable apparatus 601 and/or 701 of FIGS. 6-7, the test adhesive layer 909 and the PET sheet 911 can likewise be installed as shown in the configuration of FIG. 9 to conduct the test on the test foldable apparatus 902. The test foldable apparatus 902 is placed between the pair of parallel rigid stainless-steel plates 903, 905 such that the foldable substrate 201 and/or 407 will be on the inside of the bend, similar to the configuration shown in FIG. 9. For determining a “parallel plate distance”, the distance between the parallel plates is reduced at a rate of 50 μm/second until the parallel plate distance 907 is equal to the “parallel plate distance” to be tested. Then, the parallel plates are held at the “parallel plate distance” to be tested for 24 hours at about 85° C. and about 85% relative humidity. As used herein, the “minimum parallel plate distance” is the smallest parallel plate distance that the foldable apparatus can withstand without failure under the conditions and configuration described above. For determining the “effective minimum bend radius”, the distance between the parallel plates is reduced at a rate of 50 μm/second until the parallel plate distance 907 is equal to twice the “effective minimum bend radius” to be tested. Then, the parallel plates are held at twice the effective minimum bend radius to be tested for 24 hours at about 85° C. and about 85% relative humidity. As used herein, the “effective minimum bend radius” is the smallest effective bend radius that the foldable apparatus can withstand without failure under the conditions and configuration described above.

In aspects, the foldable apparatus 101, 301, 401, 501, 601, and/or 701 and/or test foldable apparatus 902 can achieve a parallel plate distance of 100 mm or less, 50 mm or less, 20 mm or less, 10 mm or less, 5 mm or less, or 3 mm or less. In further aspects, the foldable apparatus 101, 301, 401, 501, 601, and/or 701 and/or test foldable apparatus 902 can achieve a parallel plate distance of 50 millimeters (mm), or 20 mm, or 10 mm, of 5 mm, or 3 mm. In aspects, the foldable apparatus 101, 301, 401, 501, 601, and/or 701 and/or test foldable apparatus 902 can comprise a minimum parallel plate distance of about 40 mm or less, about 20 mm or less, about 10 mm or less, about 5 mm or less, about 3 mm or less, about 1 mm or more, about 1 mm or more, about 3 mm or more, about 5 mm or more, or about 10 mm or more. In aspects, the foldable apparatus 101, 301, 401, 501, 601, and/or 701 and/or test foldable apparatus 902 can comprise a minimum parallel plate distance ranging from about 1 mm to about 40 mm, from about 1 mm to about 20 mm, from about 1 mm to about 10 mm, from about 1 mm to about 5 mm, from about 1 mm to about 3 mm, from about 3 mm to about 40 mm, from about 3 mm to about 40 mm, from about 3 mm to about 20 mm, from about 3 mm to about 10 mm, from about 3 mm to about 5 mm, from about 5 mm to about 10 mm, or any range or subrange therebetween.

In aspects, as shown in FIGS. 2-3, a width 252 of the central portion 251 of the foldable substrate 201 defined between the first portion 221 and the second portion 231 in the direction 106 of the length 105. In aspects, the width 252 of the central portion 251 of the foldable substrate 201 can extend from the first portion 221 to the second portion 231. In aspects, the width 252 of the central portion 251 of the foldable substrate 201 defined between the first portion 221 and the second portion 231 in the direction 106 of the length 105 can be about 1.6 times or more, about 2 times or more, 2.2 times or more, about 2.5 times or more, about 5 times or less, about 3 times or less, or about 2.8 times or less the minimum parallel plate distance. In aspects, the width 252 of the central portion 251 as a multiple of the minimum parallel plate distance can range from about 1.6 times to about 5 times, from about 2 times to about 5 times, from about 2 times to about 3 times, from about 2.2 times to about 3 times, from about 2.2 times to about 2.8 times, from about 2.5 times to about 2.8 times, or any range or subrange therebetween. Without wishing to be bound by theory, the length of a bent portion in a circular configuration between parallel plates can be about 1.6 times the parallel plate distance 907 while the length of a bend portion in an elliptical configuration can be about 2.2 times the parallel plate distance 907. In aspects, the width 252 of the central portion 251 of the foldable substrate 201 can be about 2.8 mm or more, about 6 mm or more, about 9 mm or more, about 60 mm or less, about 40 mm, or less, or about 24 mm or less. In aspects, the width 252 of the central portion 251 of the foldable substrate 201 can range from about 2.8 mm to about 60 mm, from about 2.8 mm to about 40 mm, from about 6 mm to about 40 mm, from about 6 mm to about 24 mm, from about 9 mm to about 24 mm, or any range of subrange therebetween. By providing a width of the central portion between the first portion and the second portion, folding of the foldable apparatus without failure can be facilitated.

The foldable apparatus may have an impact resistance defined by the capability of a region of the foldable apparatus (e.g., a region comprising the first portion 221, a region comprising the second portion 231, a region comprising the central portion 251) to avoid failure at a pen drop height (e.g., 5 centimeters (cm) or more, 10 centimeters or more, 20 cm or more), when measured according to the “Pen Drop Test.” As used herein, the “Pen Drop Test” is conducted such that samples of foldable apparatus are tested with the load (i.e., from a pen dropped from a certain height) imparted to a major surface (e.g., second major surface 205 of the foldable substrate 201, second major surface 405 of the foldable substrate 407, fourth major surface 505 of the coating 507) configured as in the parallel plate test with 100 μm thick PET sheet 911 attached to the test adhesive layer 909 having a thickness of 50 μm instead of the display device 307 shown in FIGS. 3 and 5. As such, the PET layer in the Pen Drop Test is meant to simulate a foldable electronic display device (e.g., an OLED device). During testing, the foldable apparatus bonded to the PET layer is placed on an aluminum plate (6063 aluminum alloy, as polished to a surface roughness with 400 grit paper) with the PET layer in contact with the aluminum plate. No tape is used on the side of the sample resting on the aluminum plate.

A tube is used for the Pen Drop Test to guide a pen to an outer surface of the foldable apparatus. For the foldable apparatus 101, 301, and/or 701 and/or test foldable apparatus 902 shown in FIGS. 2-4, 7, and 9, the pen is guided to the second major surface 205 of the foldable substrate 201, and the tube is placed in contact with the second major surface 205 of the foldable substrate 201 so that the longitudinal axis of the tube is substantially perpendicular to the second major surface 205 with the longitudinal axis of the tube extending in the direction of gravity. For the foldable apparatus 401, 501, and/or 601 shown in FIGS. 4-6, the pen is guided to the second major surface 405 of the foldable substrate 407 or the fourth major surface 505 of the coating 507, if present, and the tube is placed in contact with the second major surface 205 of the foldable substrate 201 or the fourth major surface 505 of the coating 507, if present, so that the longitudinal axis of the tube is substantially perpendicular to the second major surface 405 or the fourth major surface 505, if present, with the longitudinal axis of the tube extending in the direction of gravity. The tube has an outside diameter of 1 inch (2.54 cm), an inside diameter of nine-sixteenths of an inch (1.4 cm), and a length of 90 cm. An acrylonitrile butadiene (ABS) shim is employed to hold the pen at a predetermined height for each test. After each drop, the tube is relocated relative to the sample to guide the pen to a different impact location on the sample. The pen employed in Pen Drop Test is a BIC Easy Glide Pen, Fine, having a tungsten carbide ballpoint tip of 0.7 mm (0.68 mm) diameter, and a weight of 5.73 grams (g) including the cap (4.68 g without the cap).

For the Pen Drop Test, the pen is dropped with the cap attached to the top end (i.e., the end opposite the tip) so that the ballpoint can interact with the test sample. In a drop sequence according to the Pen Drop Test, one pen drop is conducted at an initial height of 1 cm, followed by successive drops in 0.5 cm increments up to 20 cm, and then after 20 cm, 2 cm increments until failure of the test sample. After each drop is conducted, the presence of any observable fracture, failure, or other evidence of damage to the sample is recorded along with the particular pen drop height. Using the Pen Drop Test, multiple samples can be tested according to the same drop sequence to generate a population with improved statistical accuracy. For the Pen Drop Test, the pen is to be changed to a new pen after every 5 drops, and for each new sample tested. In addition, all pen drops are conducted at random locations on the sample at or near the center of the sample, with no pen drops near or on the edge of the samples.

For purposes of the Pen Drop Test, “failure” means the formation of a visible mechanical defect in a laminate. The mechanical defect may be a crack or plastic deformation (e.g., surface indentation). The crack may be a surface crack or a through crack. The crack may be formed on an interior or exterior surface of a laminate. The crack may extend through all or a portion of the foldable substrate 201 and/or 407 and/or coating 507. A visible mechanical defect has a minimum dimension of 0.2 mm or more.

In aspects, the foldable apparatus can resist failure for a pen drop in a region comprising the first portion 221 or the second portion 231 of the foldable substrate 201, the second major surface 405 of the foldable substrate 407, and/or the fourth major surface 505 of the coating at a pen drop height of 10 centimeters (cm), 12 cm, 14 cm, 16 cm, or 20 cm. In aspects, a maximum pen drop height that the foldable apparatus can withstand without failure over a region comprising the first portion 221 or the second portion 231 of the foldable substrate 201, the second major surface 405 of the foldable substrate 407, and/or the fourth major surface 505 of the coating may be about 10 cm or more, about 12 cm or more, about 14 cm or more, about 16 cm or more, about 40 cm or less, or about 30 cm or less, about 20 cm or less, about 18 cm or less. In aspects, a maximum pen drop height that the foldable apparatus can withstand without failure over a region comprising the first portion 221 or the second portion 231 of the foldable substrate 201, the second major surface 405 of the foldable substrate 407, and/or the fourth major surface 505 of the coating can range from about 10 cm to about 40 cm, from about 12 cm to about 30 cm, from about 14 cm to about 30 cm, from about 16 cm to about 20 cm, from about 18 cm to about 20 cm, or any range or subrange therebetween.

In aspects, the foldable apparatus can resist failure for a pen drop in a central portion 251 between the first portion 221 and the second portion 231 at a pen drop height of 1 cm, 2 cm, 3 cm, 4 cm, 5 cm, or more. In aspects, a maximum pen drop height that the foldable apparatus can withstand without failure over the central portion 251 between the first portion 221 and the second portion 231 may be about 1 cm or more, about 2 cm or more, about 3 cm or more, about 4 cm or more, about 20 cm or less, about 10 cm or less, about 8 cm or less, or about 6 cm or less. In aspects, a maximum pen drop height that the foldable apparatus can withstand without failure over the central portion 251 between the first portion 221 and the second portion 231 can range from about 1 cm to about 20 cm, from about 2 cm to about 10 cm, from about 3 cm to about 8 cm, from about 4 cm to about 6 cm, or any range or subrange therebetween. In aspects, a maximum pen drop height that the foldable apparatus can withstand without failure of the central region between the first portion 221 and the second portion 231 can range from about 1 cm to about 10 cm, from about 1 cm to about 8 cm, from about 2 cm to about 5 cm, from about 3 cm to about 5 cm, from about 4 cm to about 5 cm, or any range or subrange therebetween.

In aspects, contacting the first major surface 203 or 403 of the foldable substrate 201 or 407 with any of the solutions described below in steps 1205, 1207, 1211, and/or 1215 can increase a first pen drop threshold height that the foldable apparatus comprising the foldable substrate 201 or 407 can withstand relative to a second pen drop threshold height a foldable apparatus without the contacting the first major surface 203 or 403 of the foldable substrate 201 or 407 with any of the solutions described below in steps 1205, 1207, 1211, 1213, and/or 1215, where the foldable substrates are both chemically strengthened in step 1209 and are identical other than the difference described above. In further aspects, a first pen drop threshold height treated with solution described below in step 1207 can be greater than the second pen drop threshold height as a percentage of the second pen drop threshold height by about 20% or more, about 30% or more, about 50% or more, about 100% or more, about 1,000% or less, about 500% or less, about 300% or less, about 200% or less, or about 100% or less. In further aspects, a first pen drop threshold height treated with solution described below in step 1207 can be greater than the second pen drop threshold height as a percentage of the second pen drop threshold height ranging from about 20% to about 1,000%, from about 20% to about 500%, from about 20% to about 300%, from about 20% to about 200%, from about 20% to about 100%, from about 30% to about 100%, from about 50% to about 100%, or any range or subrange therebetween. In further aspects, a first pen drop threshold height treated with solution described below in step 1207 can be greater than the second pen drop threshold height as a percentage of the second pen drop threshold height ranging from about 20% to about 1,000%, from about 30% to about 500%, from about 50% to about 300%, from about 100% to about 200%, or any range or subrange therebetween. In further aspects, a first pen drop threshold height treated with solution described below in steps 1205, 1211, and 1215 can be greater than the second pen drop threshold height as a percentage of the second pen drop threshold height by an amount within one or more of the ranges discussed above in this paragraph.

In aspects, contacting the first major surface 203 or 403 of the foldable substrate 201 or 407 with any of the solutions described below in steps 1205, 1207, 1211, and/or 1215 can increase a first pen drop threshold height that the foldable apparatus comprising the foldable substrate 201 or 407 can withstand relative to a third pen drop threshold height a foldable apparatus without the contacting the first major surface 203 or 403 of the foldable substrate 201 or 407 with any of the solutions described below in steps 1205, 1207, 1211, 1213, and/or 1215, where the foldable substrate for the first pen drop threshold height is chemically strengthened in step 1209 but the foldable substrate for the third pen drop threshold height is stopped at the end of step 1201, 1203, or 1221; however foldable substrates are identical other than the differences described above. In further aspects, a first pen drop threshold height treated with solution described below in step 1207 can be greater than the third pen drop threshold height as a percentage of the third pen drop threshold height by about 20% or more, about 30% or more, about 50% or more, about 100% or less, about 80% or less, or about 60% or less. In further aspects, a first pen drop threshold height treated with solution described below in step 1207 can be greater than the third pen drop threshold height as a percentage of the third pen drop threshold height ranging from about 20% to about 100%, from about 20% to about 80%, from about 30% to about 60%, from about 50% to about 60%, or any range or subrange therebetween. In further aspects, a first pen drop threshold height treated with solution described below in step 1207 can be greater than the third pen drop threshold height as a percentage of the third pen drop threshold height ranging from about 20% to about 100%, from about 30% to about 100%, from about 50% to about 100%, from about 50% to about 80%, from about 50% to about 60%, or any range or subrange therebetween. In further aspects, a first pen drop threshold height treated with solution described below in steps 1205, 1211, and 1215 can be greater than the third pen drop threshold height as a percentage of the third pen drop threshold height by an amount within one or more of the ranges discussed above in this paragraph.

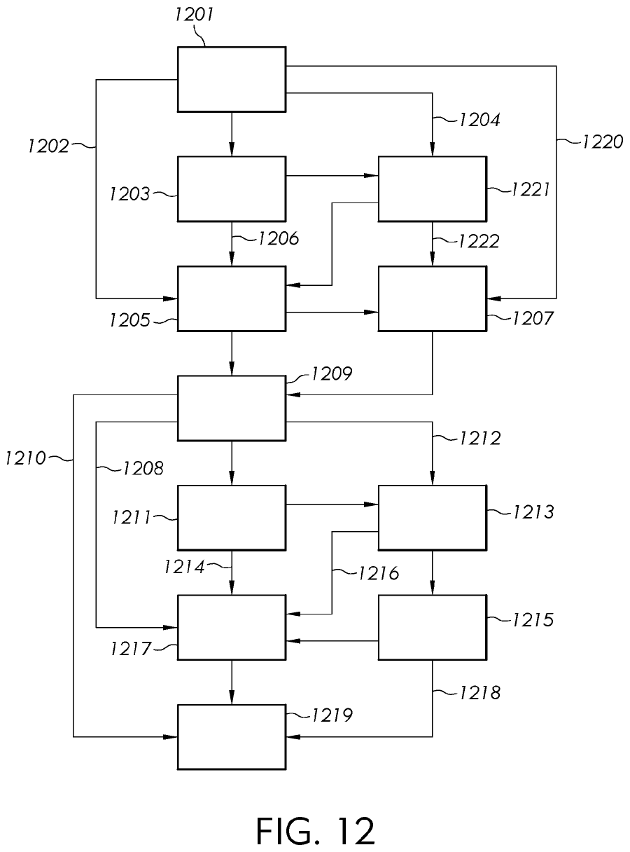

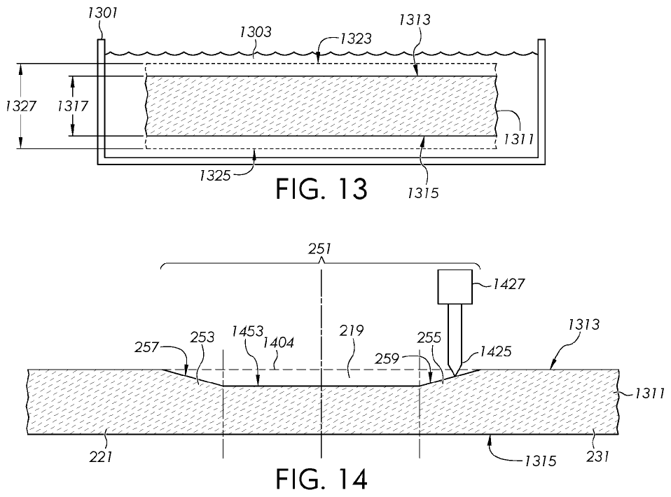

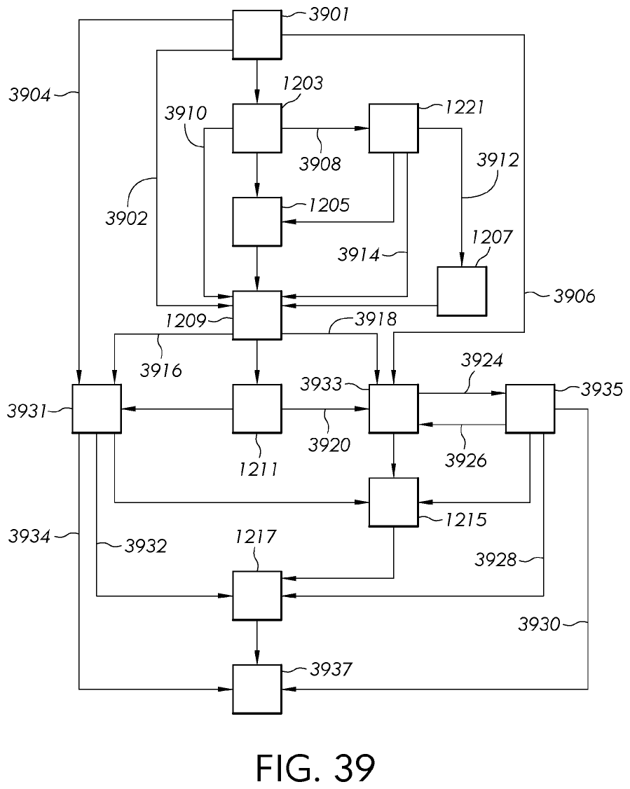

Aspects of methods of making the foldable apparatus 101, 301, 401, 501, 601, and/or 701 and/or test foldable apparatus 902 illustrated in FIGS. 2-7 and 9, in accordance with aspects of the disclosure, will be discussed with reference to the flow chart in FIGS. 12 and 39 and example method steps illustrated in FIGS. 13-18, 20-21, 24-26, and 40-42 along with the cross-sectional views illustrated in FIGS. 17, 19, and 22-23.

First, methods will be discussed with reference to the flow chart in FIG. 12 and example method steps illustrated in FIGS. 13-18, 20-21, and 23-26 along with the cross-sectional views illustrated in FIGS. 17, 19, and 22. In a first step 1201 of methods of the disclosure, as shown in FIGS. 13-15, methods can start with providing a foldable substrate 1311. In aspects, the foldable substrate 1311 may be provided by purchase or otherwise obtaining a substrate or by forming the foldable substrate. In aspects, the foldable substrate 1311 can comprise a glass-based substrate. In further aspects, glass-based substrates can be provided by forming them with a variety of ribbon forming processes, for example, slot draw, down-draw, fusion down-draw, up-draw, press roll, redraw, or float. In further aspects, glass-based substrates comprising ceramic crystals can be provided by heating a glass-based substrate to crystallize one or more ceramic crystals. The foldable substrate 1311 may comprise an initial second major surface 1325 or an existing second major surface 1315 (see FIGS. 13-15) that can extend along a plane. The initial second major surface 1325 or existing second major surface 1315 can be opposite an initial first major surface 1323 or existing first major surface 1313, and the initial first major surface 1323 or the existing first major surface 1313 (see FIGS. 13-15) can extend along a plane. In aspects, the foldable substrate 1311 can comprise a recess 219 in the existing first major surface 1313 of the foldable substrate 201 exposing an existing first central surface area 1453 (see FIG. 14). In further aspects, although not shown, the foldable substrate can comprise an another recess in the second major surface of the foldable substrate exposing an existing second central surface area.

After step 1201, as shown in FIG. 13, methods can proceed to step 1203 comprising reducing a thickness of the foldable substrate 1311. In aspects, as shown, reducing a thickness of the foldable substrate 1311 can comprise contacting the initial first major surface 1323 and/or the initial second major surface 1325 with an etchant to form the existing first major surface 1313 and/or the existing second major surface 1315. Reducing the thickness of the foldable substrate 1311 by removing a layer from the initial second major surface 1325, for example, to remove the skin layer to expose a central layer with more consistent optical properties across the length of foldable substrate 1311 (e.g., glass-based material). Removing the layers from both the existing first major surface and the existing second major surface can remove the outer layers of the foldable substrate 1311 (e.g., glass-based material) that may have inconsistent optical properties than the underlying interior portions of the foldable substrate 1311 (e.g., glass-based material). Consequently, the entire thickness throughout the length and the width of the foldable substrate 1311 may have more consistent optical properties to provide consistent optical performance with little or no distortions across the foldable substrate 1311 (e.g., entire foldable substrate). In further aspects, as shown, the etchant can comprise an etching solution 1303. In even further aspects, as shown, the etching solution 1303 can be contained in an etching bath 1301, and the foldable substrate 1311 can be immersed in the etching solution 1303. In even further aspects, although not shown, the etching solution can be applied by spraying, rolling, or otherwise contacting one or more surfaces of the foldable substrate. In further aspects, as shown, the etchant can comprise a gas. In further aspects, the etchant can comprise an acidic solution, for example, one or more mineral acids (e.g., HCl, HF, H₂SO₄, HNO₃). In further aspects, as shown, step 1203 can reduce the thickness of the foldable substrate 1311 from an initial thickness 1327 to an existing thickness 1317. In even further aspects, the existing thickness 1317 as a percentage of the initial thickness 1327 can be about 1% or more, about 5% or more, about 10% or more, about 20% or more, about 80% or less, about 60% or less, about 50% or less, or about 30% or less. In even further aspects, the existing thickness 1317 as a percentage of the initial thickness 1327 can range from about 1% to about 80%, from about 5% to about 80%, from about 10% to about 60%, from about 10% to about 50, from about 20% to about 30%, or any range or subrange therebetween. In aspects, although not shown, the thickness of the foldable substrate can be reduced by redrawing the foldable substrate.

After step 1201 or 1203, as shown in FIG. 14, methods can proceed to step 1221 comprising forming a recess 219 in the existing first major surface 1313. In further aspects, the recess 219 may be formed by etching, laser ablation or mechanically working the existing first major surface 1313. For example, the existing first major surface 1313 may be mechanically worked by diamond engraving to produce very precise patterns in glass-based substrates. As shown in FIG. 14, diamond engraving can be used to create the recess 219 in the existing first major surface 1313 of the foldable substrate 1311 where a diamond-tip probe 1425 can be controlled using a computer numerical control (CNC) machine 1427. Materials other than diamond can be used for engraving with a CNC machine. Furthermore, other methods of forming the recess include lithography, etching, and laser ablation. For example, etching can comprise disposing a mask over portions of the existing first major surface 1313 not to be etched before exposing the existing first major surface 1313 of the foldable substrate 1311 to an etchant to form the recess 219, and then removing the mask. Forming the recess 219 in the existing first major surface 1313 can provide a central portion 251 between a first portion 221 and a second portion 231 of the foldable substrate 1311. The central portion 251 can comprise an existing first central surface area 1453 wherein the recess 219 can be defined between the existing first central surface area 1453 and the first plane 1404 along which the existing first major surface 1313 extends in the flat configuration shown in FIG. 14. The existing first central surface area 1453 can attach the first portion 221 to the second portion 231. The central portion 251 can optionally comprise a first transition region 253 attaching the first portion 221 to the existing first central surface area 1453 and a second transition region 255 attaching the second portion 231 to the existing first central surface area 1453. In aspects, a thickness of the first transition region 253 can continuously increase from the existing first central surface area 1453 to the first portion 221. In further aspects, a thickness of the second transition region 255 can continuously increase from the existing first central surface area 1453 to the second portion 231. In aspects, as shown in FIG. 14, the existing first central surface area 1453 of the central portion 251 may be planar although nonplanar configurations may be provided in further aspects. Furthermore, the existing first central surface area 1453 can be parallel with respect to the first plane 1404 and/or the existing second major surface 1315 as shown in FIG. 14.

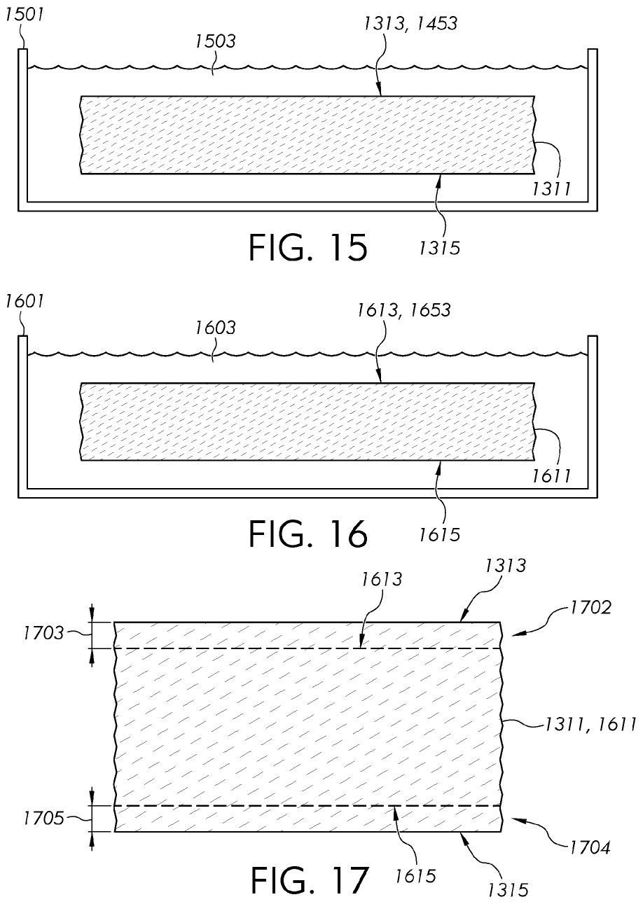

After step 1201, 1203, or 1221, as shown in FIG. 15, method can proceed to step 1205 comprising contacting at least the existing first major surface 1313 of the foldable substrate 1311 with a first alkaline detergent solution comprising a first temperature for a first period of time under sonication. In aspects, as shown, the first alkaline detergent solution 1503 can be contained in a first detergent bath 1501. In further aspects, as shown, contacting the existing first major surface 1313 of the foldable substrate 1311 with the first alkaline detergent solution 1503 can comprise immersing the foldable substrate 1311 in the first alkaline detergent solution 1503 contained in the first detergent bath 1501. In further aspects, as shown, the first alkaline detergent solution 1503 can contact the existing first major surface 1313, the existing first central surface area 1453, and/or the existing second major surface 1315. As used herein, a pH of a solution is measured in accordance with ASTM E70-90 at 25° C. with standard solutions extending to a pH of at least 14. In aspects, the first alkaline detergent solution 1503 can comprise an alkaline detergent and a pH of about 11 or more, about 12 or more, about 12.5 or more, about 12.8 or more, about 14 or less, about 13.5 or less, or about 13.2 or less. In aspects, the first alkaline detergent solution 1503 can comprise a pH ranging from about 11 to about 14, from about 12 to about 14, from about 12.5 to about 13.5, from about 12.8 to about 13.2, or any range or subrange therebetween. In aspects, the first alkaline detergent solution 1503 can comprise an alkaline detergent in a concentration from about 0.5 wt % or more, about 1 wt % or more, about 1.5 wt % or more, about 2 wt % or more, about 4 wt % or less, about 3 wt % or less, or about 2.5 wt % or less. In aspects, the first alkaline detergent solution 1503 can comprise an alkaline detergent in a concentration ranging from about 0.5 wt % to about 4 wt %, from about 1 wt % to about 4 wt %, from about 1.5 wt % to about 3 wt %, from about 2 wt % to about 3 wt %, from about 2.5 wt % to about 3 wt %, or any range or subrange therebetween. An exemplary aspect of an alkaline detergent solution includes SemiClean KG (Yokohama Oils & Fats Industry Co.). Exemplary aspects of sonication include ultrasonication and megasonication. Without wishing to be bound by theory, sonication (e.g., ultrasonication, megasonication) can help remove contaminants (e.g., particles, oils) from a surface by forming microscale bubbles as the surface, by increasing circulation of the alkaline detergent solution through agitation, and/or by loosening contaminants through vibration directly. In aspects, sonication can be applied for at least half of the first period of time, for example, the entire first period of time. In aspects, the first period of time can be about 2 minutes or more, about 3 minutes or more, about 4 minutes or more, about 5 minutes or more, about 60 minutes or less, about 40 minutes or less, about 20 minutes or less, about 10 minutes or less, about 8 minutes or less, or about 6 minutes or less. In aspects, the first period of time can range from about 2 minutes to about 40 minutes, from about 2 minutes to about 20 minutes, from about 3 minutes to about 20 minutes, from about 3 minutes to about 10 minutes, from about 4 minutes to about 8 minutes, from about 4 minutes to about 6 minutes, or any range or subrange therebetween. Providing a first period of time of at least 2 minutes can effectively remove contaminants from the surface. Providing a first period of time less than 40 minutes can keep a chance of damage or breakage withing acceptable ranges. In aspects, the first temperature can be about 20° C. or more, about 25° C. or more, about 30° C. or more, about 35° C. or more, about 65° C. or less, about 60° C. or less, about 55° C. or less, or about 45° C. or less. In aspects, the first temperature can range from about 20° C. to about 65° C., from about 25° C. to about 60° C., from about 30° C. to about 55° C., from about 35° C. to about 45° C., or any range or subrange therebetween. Providing the alkaline detergent solution in step 1205 can neutralize residual etchant from step 1203, which can prevent surface defects and/or produce a more uniform thickness of the foldable substrate. Providing the alkaline detergent solution in step 1205 can neutralize and/or remove hydrogen (e.g., hydronium) enrichment at the surface of the foldable substrate, which might otherwise lead to large flaws as a result of stress corrosion during the subsequent chemical strengthening. Providing the alkaline detergent solution in step 1205 may selectively act on surface flaws (e.g., removing, rounding, blunting) before removing material from other parts of the surface, which can increase the impact resistance of the substrate without removing a substantial thickness from the surface of the foldable substrate.

After step 1201, 1205, or 1221, as shown in FIGS. 16-17, methods can proceed to step 1207 comprising contacting the existing first major surface 1313 of the foldable substrate 1311 with an alkaline solution 1603 (FIG. 16) comprising a second temperature for a second period of time to remove a first outer layer 1702 (FIG. 17) from the existing first major surface 1313 to form a new first major surface 1613. Similarly, contacting the existing first central surface area 1453 with the alkaline solution 1603 can form the new first central surface area 1653. In aspects, as shown in FIGS. 16-17, step 1207 can comprise contacting the existing second major surface 1315 of the foldable substrate 1311 with the alkaline solution 1603 (FIG. 16) to remove a second outer layer 1704 (FIG. 17) from the existing second major surface 1315 to form a new second major surface 1615. In aspects, as shown in FIG. 17, the first outer layer 1702 can comprise an outer thickness 1703 and/or the second outer layer 1704 can comprise an outer thickness 1705. In further aspects, the outer thickness 1703 and/or 1705 can be about 1 nanometer (nm) or more, about 10 nm or more, about 20 nm or more, about 50 nm or more, about 100 nm or more, about 500 nm or less, about 300 nm or less, about 200 nm or less, about 100 nm or less, or about 80 nm or less. In further aspects, the outer thickness 1703 and/or 1705 can range from about 1 nm to about 500 nm, from about 1 nm to about 300 nm, from about 10 nm to about 200 nm, from about 10 nm to about 100 nm, from about 20 nm to about 80 nm, from about 50 nm to about 80 nm, or any range or subrange therebetween. Providing the alkaline detergent solution in step 1205 may selectively act on surface flaws (e.g., removing, rounding, blunting) before removing material from other parts of the surface, which can increase the impact resistance of the substrate without removing a substantial thickness from the surface of the foldable substrate. Removing a low thickness (e.g., about 100 nm or less) from the surface of the foldable substrate may improve properties of the surface with reduced processing expenses than removing a deeper thickness.

In aspects, as shown in FIG. 16, the alkaline solution 1603 can be contained in an alkaline bath 1601. In further aspects, as shown, the foldable substrate 1311 can be contacted by the alkaline solution 1603 to form the foldable substrate 1611 by immersing the foldable substrate 1311 in the alkaline solution 1603. In aspects, the alkaline solution can comprise a hydroxide-containing base in a concentration of about 10 wt % or more, about 20 wt % or more, about 30 wt % or more, about 40 wt % or more, about 54 wt % or less, about 50 wt % or less, about 45 wt % or less, or about 40 wt % or less. In aspects, the alkaline solution can comprise a hydroxide-containing base in a concentration ranging from about 10 wt % to about 54 wt %, from about 10 wt % to about 50 wt %, from about 20 wt % to about 50 wt %, from about 30 wt % to about 50 wt %, from about 40 wt % to about 50 wt %, from about 40 wt % to about 45 wt %, or any range or subrange therebetween. In aspects, the alkaline solution can comprise a hydroxide-containing base in a concentration of about 3 molar (M) or more, about 5 M or more, about 7 M or more, about 9 M or more, about 14 M or less, about 13 M or less, about 12 M or less, or about 11 M or less. In aspects, the alkaline solution can comprise a hydroxide-containing base in a concentration ranging from about 3 M to about 14 M, from about 5 M to about 13 M, from about 7 M to about 12 M, from about 9 M to about 11 M, or any range or subrange therebetween. In aspects, the alkaline solution can comprise a pH of about 14 or more, about 14.2 or more, about 14.4 or more, about 16 or less, about 15 or less, about 14.8 or less, or about 14.6 or less. In aspects, the alkaline solution can comprise a pH ranging from about 14 to about 16, from about 14 to about 15, from about 14.2 to about 14.8, from about 14.4 to about 14.6, or any range or subrange therebetween. In aspects, alkaline solution can comprise a hydroxide-containing base comprising one or more of sodium hydroxide (NaOH), potassium hydroxide (KOH), ammonium hydroxide (NH₄OH), and/or tetramethylammonium hydroxide (N(CH₃)₄OH). In aspects, the alkaline solution can be fluoride-free. As used herein, “fluoride-free” means that a solution comprises less than 0.1 wt %.

In aspects, the second temperature can be about 60° C. or more, about 70° C. or more, about 80° C. or more, about 90° C. or more, about 150° C. or less, about 130° C. or less, from about 110° C. or less, or about 100° C. or less. In aspects, the second temperature can range from about 60° C. to about 150° C., from about from about 70° C. to about 130° C. from about 80° C. to about 110° C., from about 90° C. to about 100° C., or any range or subrange therebetween. In aspects, the second temperature can be about 5 minutes or more, about 7 minutes or more, about 10 minutes or more, about 15 minutes or more, about 20 minutes or more, about 120 minutes or less, about 60 minutes or less, about 30 minutes or less, or about 25 minutes or less. In aspects, the second temperature can range from about 5 minutes to about 120 minutes, from about 5 minutes to about 60 minutes, from about 7 minutes to about 30 minutes, from about 10 minutes to about 30 minutes, from about 15 minutes to about 25 minutes, from about 20 minutes to about 25 minutes, or any range or subrange therebetween. In aspects, the foldable substrate can contact the alkaline solution under sonication. Exemplary aspects of sonication include ultrasonication and megasonication. In further aspects, sonication can be applied for at least half of the first period of time, for example, the entire first period of time. Providing the alkaline solution comprising the hydroxide-containing base can remove a layer from the surface of the foldable substrate, which can remove flaws from the surface and/or change a surface chemistry of the surface. Compared to the alkaline detergent solution, the alkaline solution comprising the hydroxide-containing base can remove more flaws, including those that extend deeper into the foldable substrate, for example, by removing a greater thickness from the surface. Contacting the foldable substrate with the alkaline solution comprising the hydroxide-containing base before the chemical strengthening can reduce the growth of flaws during the chemical strengthening, which can result in increased impact resistance of the chemically strengthened foldable substrate.

In aspects, step 1205 or 1207 can optionally further comprise rinsing the foldable substrate with a rinsing agent after reducing the thickness of the foldable substrate. In further aspects, the foldable substrate can be immersed in a bath comprising a rinsing agent. In further aspects, the rinsing agent can comprise water (e.g., purified, filtered, deionized, distilled) and/or a neutral detergent solution.

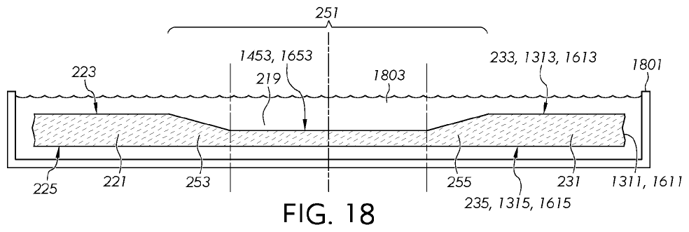

After step 1205 or 1207, as shown in FIG. 18, methods can proceed to step 1209 comprising chemically strengthening the foldable substrate 1611 to form a first compressive stress region extending to a first depth of compression from the new first major surface 1613 of the foldable substrate 1611. Chemically strengthening the foldable substrate 1311 or 1611 (e.g., glass-based material) by ion exchange can occur when a first cation within a depth of a surface of a foldable substrate 1311 or 1611 is exchanged with a second cation within a molten salt or salt solution 1803 that has a larger radius than the first cation. For example, a lithium cation within the depth of the surface of the foldable substrate 1311 or 1611 can be exchanged with a sodium cation or potassium cation within a salt solution 1803. Consequently, the surface of the foldable substrate 1311 or 1611 is placed in compression and thereby chemically strengthened by the ion exchange process since the lithium cation has a smaller radius than the radius of the exchanged sodium cation or potassium cation within the salt solution 1803. Chemically strengthening the foldable substrate 1311 or 1611 can comprise contacting at least a portion of a foldable substrate 1311 or 1611 comprising lithium cations and/or sodium cations with a salt bath 1801 comprising the salt solution 1803 comprising potassium nitrate, potassium phosphate, potassium chloride, potassium sulfate, sodium chloride, sodium sulfate, and/or sodium nitrate, whereby lithium cations and/or sodium cations diffuse from the foldable substrate 1311 or 1611 to the salt solution 1803 contained in the salt bath 1801. In aspects, the temperature of the salt solution 1803 can be about 300° C. or more, about 360° C. or more, about 400° C. or more, about 500° C. or less, about 460° C. or less, or about 400° C. or less. In aspects, the temperature of the salt solution 1803 can range from about 300° C. to about 500° C., from about 360° C. to about 460° C., from about 400° C. to about 460° C., from about 360° C. to about 400° C., or any range or subrange therebetween. In aspects, the foldable substrate 1311 or 1611 can be in contact with the salt solution 1803 for about 5 minutes or more, about 15 minutes or more, about 1 hour or more, about 3 hours or more, about 48 hours or less, about 24 hours or less, or about 8 hours or less. In aspects, the foldable substrate 1311 or 1611 can be in contact with the salt solution 1803 for a time ranging from about 5 minutes to about 48 hours, from about 15 minutes to about 24 hours, from about 3 hours to about 8 hours, or any range or subrange therebetween.

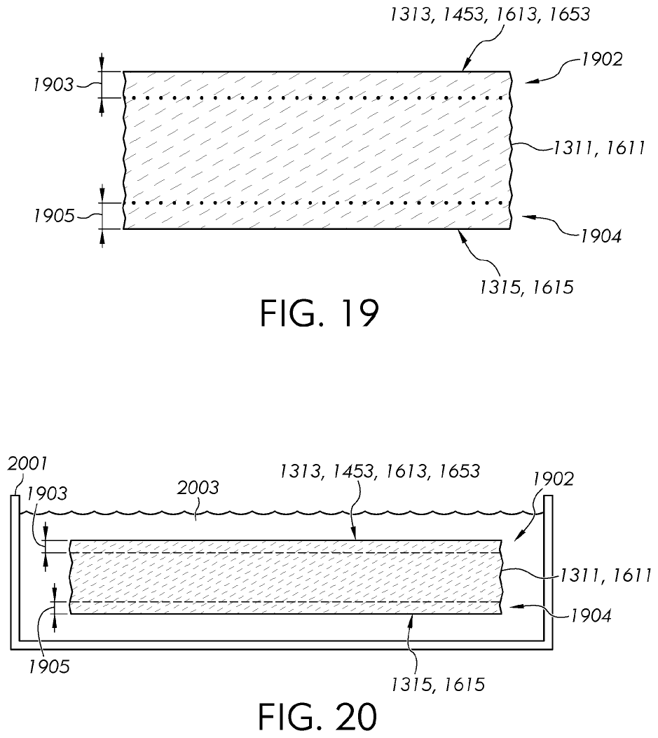

As shown in FIGS. 18-19, chemically strengthening the foldable substrate 1311 or 1611 can comprise chemically strengthening the existing first major surface 1313 or the new first major surface 1613 to form an existing first compressive stress region 1902 extending to an existing first depth of compression 1903 from the first major surface and an existing first depth of layer of one or more alkali metal ions associated with the existing first compressive stress region 1902. In aspects, first portion 221 of the foldable substrate 1311 or 1611 can comprise the existing first compressive stress region 1902 extending to the existing first depth of compression 1903 from the first surface area 223 and/or the second portion 231 of the foldable substrate 1311 or 1611 can comprise the existing first compressive stress region 1902 extending to the existing first depth of compression 1903 from the third surface area 233. In aspects, the chemically strengthening comprises chemically strengthening the existing second major surface 1315 or the new second major surface 1615 the foldable substrate 1311 or 1611 to form an existing second compressive stress region 1904 extending to an existing second depth of compression 1905 from the existing second major surface 1315 or the new second major surface 1615 and an existing second depth of layer of one or more alkali metal ions associated with the existing second compressive stress region 1904. In aspects, the first portion 221 of the foldable substrate 1311 or 1611 can comprise the existing second compressive stress region 1904 extending to the existing second depth of compression 1905 from the second surface area 225 and/or the second portion 231 of the foldable substrate 1311 or 1611 can comprise the existing second compressive stress region 1904 extending to the existing second depth of compression 1905 from the fourth surface area 235. In aspects, the chemically strengthening the foldable substrate 1311 or 1611 can comprise chemically strengthening the existing first central surface area 1453 or the new first central surface area 1653 to form an existing first central compressive stress region extending to an existing first central depth of compression and an existing first central depth of layer of one or more alkali metal ions associated with the existing first depth of compression. In aspects, the chemically strengthening the foldable substrate 1311 or 1611 can comprise chemically strengthening the second central surface area 213 to form an existing second central compressive stress region extending to an existing second central depth of compression and an existing second central depth of layer of one or more alkali metal ions associated with the existing second depth of compression. In aspects, the existing first compressive stress region can comprise an existing first maximum compressive stress, and/or the existing second compressive stress region can comprise an existing second maximum compressive stress. In further aspects, the existing first maximum compressive stress and/or the existing second maximum compressive stress can be within one or more of the ranges discussed above for the first maximum compressive stress and/or second maximum compressive stress. In aspects, the compressive stress regions can comprise a corresponding maximum compressive stress within one or more of the corresponding ranges discussed above, for example, about 500 MPa or more.

In aspects, step 1209 can optionally further comprise rinsing the foldable substrate with a rinsing agent after reducing the thickness of the foldable substrate. In further aspects, the foldable substrate can be immersed in a bath comprising a rinsing agent. In further aspects, the rinsing agent can comprise water (e.g., purified, filtered, deionized, distilled) and/or a neutral detergent solution.

After step 1209, as shown in FIG. 20, methods can proceed to step 1211 comprising contacting the existing first major surface 1313 or the new first major surface 1613 with a second alkaline detergent solution 2003 comprising a third temperature for a third period of time under sonication. In aspects, as shown, the second alkaline detergent solution 2003 can be contained in a second detergent bath 2001. In further aspects, as shown, contacting the existing first major surface 1313, the existing first central surface area 1453, the new first major surface 1613, and/or the new first central surface area 1653 of the foldable substrate 1311 or 1611 with a second alkaline detergent solution 2003. In further aspects, as shown, step 1211 can comprise immersing the foldable substrate 1311 or 1611 in the second alkaline detergent solution 2003 contained in the second detergent bath 2001. In aspects, the second alkaline detergent solution 2003 can comprise an alkaline detergent and a pH within one or more of the ranges discussed above for the pH of the first alkaline detergent solution 1503 in step 1205. In aspects, the second alkaline detergent solution 2003 can comprise an alkaline detergent in a concentration within one or more of the wt % ranges discussed above for the first alkaline detergent solution 1503 in step 1205. An exemplary aspect of an alkaline detergent solution includes SemiClean KG (Yokohama Oils & Fats Industry Co.). Exemplary aspects of sonication include ultrasonication and megasonication. In aspects, sonication can be applied for at least half of the third period of time, for example, the entire third period of time. In aspects, the third period of time can be within one or more of the ranges discussed above for the first period of time in step 1205. In aspects, the third temperature can be within one or more of the ranges discussed above for the first temperature of the first alkaline detergent solution in step 1205. Providing the second alkaline detergent solution in step 1211 can remove residual material from the chemical strengthening, which can enable more even and complete treatment of the surface in subsequent processing. Providing the second alkaline detergent solution in step 1211 can change a surface chemistry (e.g., neutralize and/or remove hydrogen (e.g., hydronium) enrichment that may be present as a result of the chemical strengthening) of the foldable substrate, which can increase an impact resistance of the foldable substrate. Providing the second alkaline detergent solution in step 1211 may selectively act on surface flaws (e.g., removing, rounding, blunting) before removing material from other parts of the surface, which can increase the impact resistance of the substrate without removing a substantial thickness from the surface of the foldable substrate.

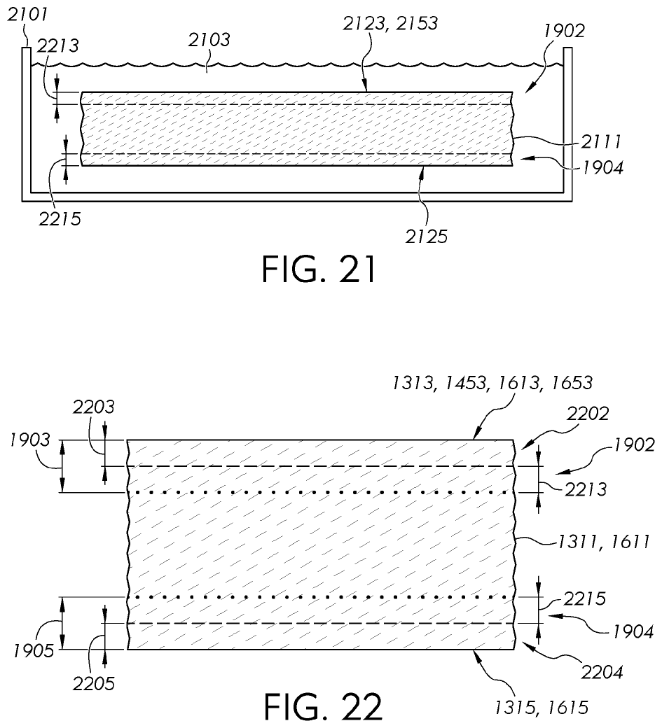

After step 1209 or 1211, as shown in FIGS. 21-22, methods can proceed to step 1213 comprising contacting the existing first major surface 1313 or 1613 with a solution 2103 comprising a fourth temperature for a fourth period of time remove a first outer compressive layer 2202 of the existing first compressive stress region 1902 to form another first major surface 2123. In aspects, as shown, the solution 2103 can be contained in a bath 2101. In aspects, as shown, step 1213 can comprise contacting the existing second major surface 1315 or 1615 with the solution 2103 to remove a second outer compressive layer 2204 of the existing second compressive stress region 1904 to from another second major surface 2125. In aspects, step 1213 can comprise contacting the existing first central surface area 1453 or 1653 with the solution 2103 to remove a first central outer compressive layer of the first central compressive stress region to form another first central surface area 2153. In aspects, a thickness 2203 or 2205 of the first outer compressive layer 2202 or the second outer compressive layer 2204 can be less than the depth of compression 1903 or 1905 of the existing first compressive stress region 1902 and/or the existing second compressive stress region 1904. In aspects, the thickness 2203 or 2205 removed in step 1213 can be within one or more of the ranges discussed above for the thickness of the first outer layer 1702 in step 1207. In aspects, the thickness 2203 or 2205 removed in step 1213 can range from about 10 nm to about 5 μm, from about 50 nm to about 2 μm, from about 100 nm to about 1 μm, from about 100 nm to about 500 nm, from about 100 nm to about 200 nm, or any range or subrange therebetween.

In further aspects, step 1213 can result in a new first depth of compression of the first compressive stress region comprising a new first maximum compressive stress and/or a new second depth of compression of the second compressive stress region comprising a new second maximum compressive stress. In even further aspects, a first thickness 2213 (see FIGS. 21-23) of the existing first compressive stress region 1902 left at the end of step 1213 can be equal to the first depth of compression discussed above with reference to the foldable apparatus, and/or a second thickness 2215 (see FIGS. 21-23) of the existing second compressive stress region 1904 left at the end of step 1213 can be equal to the second depth of compression discussed above with reference to the foldable apparatus. As used herein, a difference between a first value and second value is equal to the first value minus the second value. Further, a difference between compressive stress values is equal to a difference between the absolute value of the first compressive stress value minus the absolute value of the second compressive stress value, and a difference between central tensile stress is equal to a difference between the absolute value of the first central tensile stress value minus the absolute value of the second central tensile stress value. In even further aspects, a difference between the existing maximum compressive stress (e.g., existing first maximum compressive stress, existing second maximum compressive stress) and the corresponding, new maximum compressive stress (e.g., first maximum compressive stress, second maximum compressive stress) can be about −10 MPa or more, about 0 MPa or more, about 5 MPa or more, about 10 MPa or more, about 40 MPa or less, about 30 MPa or less, or about 20 MPa or less. In still further aspects, a difference between the existing maximum compressive stress (e.g., existing first maximum compressive stress, existing second maximum compressive stress) and the corresponding, new maximum compressive stress (e.g., first maximum compressive stress, second maximum compressive stress) (i.e., the new maximum compressive stress minus the existing maximum compressive stress) can range from about −10 MPa to about 40 MPa, from about −10 MPa to about 30 MPa, from about −10 MPa to about 20 MPa, from about 0 MPa to about 20 MPa, from about 5 MPa to about 10 MPa, or any range or subrange therebetween. For example, the new first maximum compressive stress can be less than the first existing maximum compressive stress by about 40 MegaPascals or less.

In aspects, the solution 2103 can comprise a hydroxide-containing base comprising a concentration in wt % or molarity can be within one or more of the corresponding ranges discussed above in step 1207. In further aspects, the hydroxide-containing base can comprise one or more of the materials discussed above in step 1207. In aspects, the solution 2103 can comprise a pH in one or more of the ranges discussed above in step 1207. In aspects, the fourth temperature of the solution 2103 can be within one or more of the temperatures discussed above for the second temperature in step 1207. In aspects, the fourth period of time can be within one or more of the times discussed above for the second period of time in step 1207. In aspects, the fourth period of time can range from about 10 minutes to about 120 minutes, from about 15 minutes to about 90 minutes, from about 20 minutes to about 75 minutes, from about 30 minutes to about 60 minutes, from about 35 minutes to about 50 minutes, from about 40 minutes to about 45 minutes, or any range or subrange therebetween. In further aspects, the period of time that the alkaline solution is in contact with the foldable substrate (e.g., first major surface, second major surface) can range from 30 minutes to about 120 minutes, from about 40 minutes to about 120 minutes, from about 60 minutes to about 120 minutes, from about 75 minutes to about 115 minutes, from about 90 minutes to about 105 minutes, or any range or subrange therebetween. Removing an outer compressive stress layer (e.g., first outer compressive layer, second outer compressive layer, first central outer compressive layer, second central outer compressive layer) can be beneficial to remove surface imperfections generated during forming the foldable substrate, prior processing of the foldable substrate including chemically strengthening the foldable substrate, and/or may be exacerbated by the compressive stress region(s) created by the chemically strengthening the foldable substrate. Indeed, chemically strengthening may result in surface imperfections that can affect the strength and/or optical quality of the foldable substrate. By removing an outer compressive stress layer, surface imperfections generated during chemically strengthening can be removed. Such imperfections (e.g., defects, flaws, inclusions) may generate cracks or other imperfections that can present points of weakness where catastrophic failure of the foldable substrate may occur upon folding. As fewer surface imperfections are present, a smaller bend radius may be achieved without failure of the foldable substrate and/or the foldable substrate may be able to withstand greater pen drop heights, as discussed above. Removal of a small thickness (e.g., 5 micrometers or less) may avoid substantially changing the thickness of the foldable substrate or the surface compression achieved during chemically strengthening.

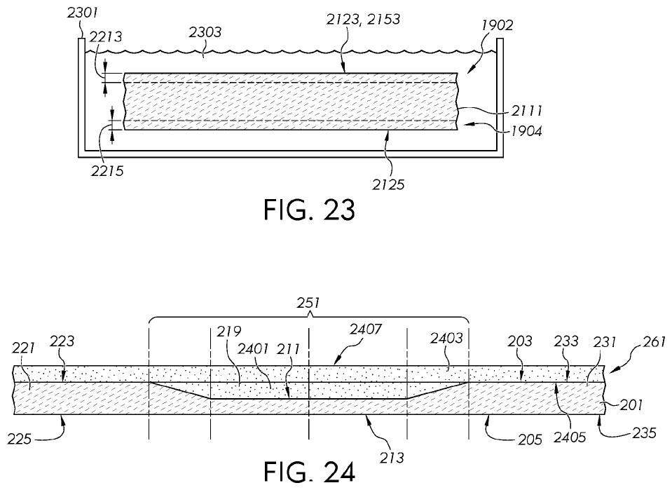

After step 1213, as shown in FIG. 23, methods can proceed to step 1215 comprising contacting the another first major surface 2123 with a third alkaline detergent solution 2303 comprising a fourth temperature for a fourth period of time under sonication. In aspects, as shown, the third alkaline detergent solution 2303 can be contained in a third detergent bath 2301. In further aspects, as shown, contacting the another first major surface 2123, the new first central surface area 2153, and/or the another second major surface 2125 of the foldable substrate 2111 with the third alkaline detergent solution 2303. In further aspects, as shown, step 1215 can comprise immersing the foldable substrate 2111 in the third alkaline detergent solution 2303 contained in the third detergent bath 2301. In aspects, the third alkaline detergent solution 2303 can comprise an alkaline detergent and a pH within one or more of the ranges discussed above for the pH of the first alkaline detergent solution 1503 in step 1205. In aspects, the third alkaline detergent solution 2303 can comprise an alkaline detergent in a concentration within one or more of the wt % ranges discussed above for the first alkaline detergent solution 1503 in step 1205. An exemplary aspect of an alkaline detergent solution includes SemiClean KG (Yokohama Oils & Fats Industry Co.). Exemplary aspects of sonication include ultrasonication and megasonication. In aspects, sonication can be applied for at least half of the fourth period of time, for example, the entire fourth period of time. In aspects, the fourth period of time can be within one or more of the ranges discussed above for the first period of time in step 1205. In aspects, the fourth temperature can be within one or more of the ranges discussed above for the first temperature of the alkaline detergent solution in step 1205. Providing the third alkaline detergent solution in step 1215 can remove residual from step 1213 can prevent surface defects and/or produce a more uniform thickness of the foldable substrate. Providing the third alkaline detergent solution in step 1215 may selectively act on surface flaws (e.g., removing, rounding, blunting) that may have been revealed during step 1213, which can increase the impact resistance of the substrate without removing a substantial thickness from the surface of the foldable substrate.

In aspects, the alkaline detergent solution(s) can be substantially free of a rheology modifier. As used herein, a rheology modifier is a component other than a solvent or a listed component (e.g., acid, hydroxide-containing base, H₂SiF₆, fluoride-containing compound) that modifies the viscosity of the solution or the shear-dependent behavior (e.g., dilatant, thixotropic). Example aspects of rheology modifiers that the solution can be substantially free of include one or more of cellulose, a cellulose derivative (e.g., ethyl cellulose, methyl cellulose, and AQUAZOL (poly 2 ethyl-2 oxazine)), a hydrophobically modified ethylene oxide urethane modifier (HUER), and an ethylene acrylic acid.

After step 1209, 1211, 1213, or 1215, as shown in FIGS. 24-26, methods can proceed to step 1217 comprising assembling the foldable apparatus. In aspects, as shown in FIGS. 24-26, step 1217 can comprise disposing the adhesive layer 261, 2401, or 2403 or the polymer-based portion 561 over the foldable substrate 201 or 407 (e.g., first major surface 203 or 403). In further aspects, step 1217 can further comprise disposing a display device 307 over the adhesive layer 261 (see FIG. 3) or the polymer-based portion 561 (see FIG. 5) disposed earlier in step 1217. For example, as shown in FIG. 3 or 5, the display device 307 can be disposed over the first major surface 203 or 403. In further aspects, step 1217 can further comprise disposing a release liner 271 over the adhesive layer 261 (see FIG. 2 or 4) or the polymer-based portion 561 disposed earlier in step 1217. For example, as shown in FIGS. 2 and 4, the release liner 271 can be disposed over the first major surface 203 or 403.

Disposing the adhesive layer 261 over the foldable substrate 201 or 407 (e.g., first major surface 203 or 403) will be discussed below with reference to FIGS. 24-26 with the understanding that the polymer-based portion 561 could be disposed similar to but in place of the adhesive layer 261 in step 1217. As shown in FIGS. 24 and 26, disposing the adhesive layer 261 can comprise applying a cured adhesive layer 2403 to contact the first major surface 203 (e.g., first surface area 223 and the third surface area 233) of the foldable substrate 201 or the first major surface 403 of the foldable substrate 407. In aspects, although not shown, the cured adhesive layer can be disposed over and/or contact the first major surface 403 of the foldable substrate 407. In aspects, although not shown, the cured adhesive layer can be disposed over the second major surface 205 or 405 instead of or in addition to the first major surface 203 or 403 of the foldable substrate 201 or 407. In aspects, as shown in FIGS. 24 and 26, the cured adhesive layer 2403 can comprise a first contact surface 2407 and a second contact surface 2405 opposite the first contact surface 2407. In further aspects, as shown, second contact surface 2405 of the cured adhesive layer 2403 can contact the first major surface 203 (e.g., first surface area 223 and the third surface area 233) of the foldable substrate 201 or the first major surface 403 of the foldable substrate 407. In aspects, as shown in FIG. 24, the adhesive layer 261 can comprise one or more sheets of an adhesive material (e.g., a cured adhesive layer 2403 and a first adhesive layer 2401). For example, as shown, there can be an integral interface between the one or more sheets comprising the adhesive layer 261, which can reduce (e.g., avoid) optical diffraction and/or optical discontinuities as light travels between the sheets since the one or more sheets can include substantially the same index of refraction. In aspects, as shown in FIG. 24, the adhesive layer 261 can further fill the recess 219. In further aspects, as shown in FIG. 24, the first adhesive layer 2401 can contact the first central surface area 211.

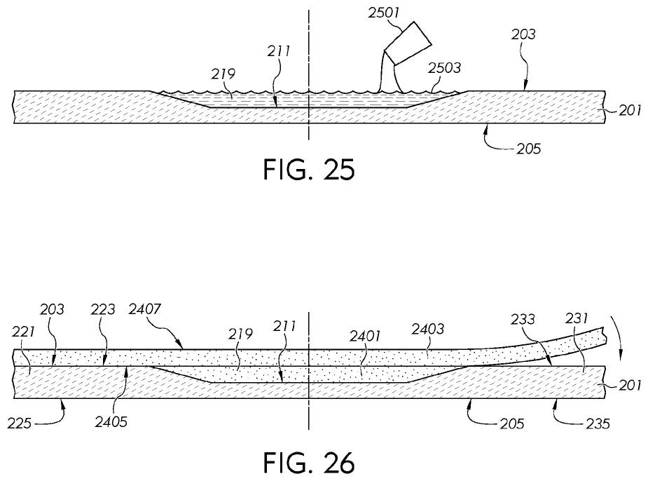

In aspects, as shown in FIG. 25, disposing the adhesive layer can comprise depositing an adhesive liquid 2503 in the recess 219. In further aspects, a conduit (e.g., flexible tube, micropipette, or syringe) may be used to deposit the adhesive liquid 2503 into the recess 219. In further aspects, as shown in FIG. 25, the adhesive liquid 2503 may be deposited in the recess 219 by pouring the adhesive liquid 2503 from a container 2501 into the recess 219. In aspects, depositing the adhesive liquid 2503 into the recess 219 may at least partially (e.g., substantially fully) fill the recess 219. In aspects, the adhesive liquid 2503 may comprise an adhesive precursor, a solvent, particles, nanoparticles, and/or fibers. In aspects, the adhesive precursor that can comprise, without limitation, one or more of a monomer, an accelerator, a curing agent, an epoxy, and/or an acrylate. In aspects, the solvent for the adhesive precursor may comprise a polar solvent (e.g., water, an alcohol, an acetate, acetone, formic acid, dimethylformamide, acetonitrile, dimethyl sulfoxone, nitromethane, propylene carbonate, poly(ether ether ketone)) and/or a non-polar solvent (e.g., pentane, 1,4-dioxane, chloroform, dichloromethane, diethyl ether, hexane, heptane, benzene, toluene, xylene). The adhesive liquid 2503 can be cured to form a first layer of the adhesive layer 261 as shown in FIG. 26 or the polymer-based portion 561 (see FIG. 5). In further aspects, the curing the adhesive liquid 2503 may comprise heating the adhesive liquid 2503. In further aspects, curing the adhesive liquid 2503 may comprise irradiating the adhesive liquid 2503 with ultraviolet (UV) radiation. In further aspects, the curing the adhesive liquid 2503 to form at least a portion of the adhesive layer 261 and/or polymer-based portion 561 can comprise waiting a predetermined amount of time (e.g., from about 30 minutes to 24 hours, from about 1 hour to about 8 hours).

In further aspects, step 1217 can further comprise disposing the coating 507 over the foldable substrate 201 or 407, for example, to form the foldable apparatus 501 shown in FIG. 5. In aspects, the third major surface 503 of the coating 507 can be disposed over the second major surface 205 or 405 of the foldable substrate 201 or 407. In further aspects, the third major surface 503 of the coating 507 can contact the second major surface 205 or 405 of the foldable substrate 201 or 407. In aspects, although not shown, the third major surface 503 of the coating 507 can be disposed over (e.g., contact) the first major surface 203 or 403 of the foldable substrate 201 or 407. In aspects, the coating 507 can be formed similar to the adhesive layer 261, for example, by disposing a liquid (e.g., adhesive liquid) and curing the liquid.

After steps 1207, 1209, 1213, and/or 1215, the method can be complete at step 1219. In aspects, step 1219 can comprise further assembling the foldable apparatus, for example, by disposing a coating opposite a release liner or display device, or by disposing a release liner or display device opposite a coating. At the end of step 1209, 1211, 1213, or 1215, the foldable substrate 1311, 1611, or 2111 can be similar to or identical to the foldable substrate 201 and 407 shown in FIGS. 2-7. For example, at the end of step 1209 or 1211 (e.g., comparing FIG. 18-20 or 22 to FIG. 2-3 or 7), the foldable substrate 1311 or 1611 can be the foldable substrate 201 (or the foldable substrate 407 in FIGS. 4-6), the existing first major surface 1313 or the new first major surface 1613 can comprise the first major surface 203 (or the first major surface 403 in FIGS. 4-6), the new second major surface 1315 or the new second major surface 1615 can comprise the second major surface 205 (or the second major surface 405 in FIGS. 4-6), and/or the existing first central surface area 1453 or the new first central surface area 1653 can comprise the first central surface area 211. For example, at the end of step 1213 or 1215 (e.g., comparing FIG. 21 or 23 to FIG. 2-3 or 7), the foldable substrate 2111 can comprise the foldable substrate 201 (or the foldable substrate 407 in FIGS. 4-6), the another first major surface 2123 can comprise the first major surface 203 (or the first major surface 403 in FIGS. 4-6), the another second major surface 2125 can comprise the second major surface 205 (or the second major surface 405 in FIGS. 4-6), and/or the another first central surface area 2153 can comprise the first central surface area 211.

Throughout the disclosure, the phrase “not further treated” or “not be further treated” excludes treatments to the first major surface other than the stated contacting with a solution and rinsing with water (e.g., purified, filtered, deionized, distilled). Exemplary aspects of treatments that can be excluded under “not further treated” or “not be further treated” include treatment with additional acidic solutions, basic solutions, fluorine-containing solutions, detergents, and mechanical polishing of the foldable substrate. In aspects, the foldable substrate may not be further treated between the contacting the foldable substrate with the alkaline solution in step 1207 and the chemically strengthening the foldable substrate in step 1209. In aspects, the foldable substrate may not be further treated between the chemically strengthening the foldable substrate in step 1209 and assembly of the foldable apparatus (e.g., attaching an adhesive layer to the new first major surface and disposing a release liner over the adhesive layer, attaching the display device to the new first major surface, disposing a coating over the new first major surface) in step 1217. In aspects, the foldable substrate may not be further treated between the reducing a thickness of the foldable substrate in step 1203 and contacting the foldable substrate with the first alkaline detergent solution in step 1205. In aspects, the foldable substrate may not be further treated between the contacting the foldable substrate with the first alkaline detergent solution in step 1205 and the chemically strengthening the foldable substrate in step 1209. In aspects, the foldable substrate may not be further treated between the chemically strengthening the foldable substrate in step 1209 and the contacting the foldable substrate with the second alkaline detergent solution in step 1211. In aspects, the foldable substrate may not be further treated between the contacting the foldable substrate with the second alkaline detergent solution in step 1211 and assembly of the foldable apparatus (e.g., attaching an adhesive layer to the new first major surface and disposing a release liner over the adhesive layer, attaching the display device to the new first major surface, disposing a coating over the new first major surface) in step 1217. In aspects, the foldable substrate may not be further treated between the chemically strengthening the foldable substrate in step 1209 and assembly of the foldable apparatus (e.g., attaching an adhesive layer to the new first major surface and disposing a release liner over the adhesive layer, attaching the display device to the new first major surface, disposing a coating over the new first major surface) in step 1217.

In aspects, methods of making a foldable apparatus in accordance with aspects of the disclosure can proceed along steps 1201, 1203, 1221, 1205, 1207, 1209, 1211, 1213, 1215, 1217, and 1219 of the flow chart in FIG. 12 sequentially, as discussed above. In aspects, as shown in FIG. 12, arrow 1202 can be followed from step 1201 to step 1205, for example, when the foldable substrate 1311 comprises substantially the substrate thickness at the end of step 1201 and the foldable substrate comprises the recess 219 or the foldable substrate is not to comprise a recess 219. In aspects, arrow 1204 can be followed from step 1201 to step 1221, for example, if the foldable substrate 1611 already comprises substantially the substrate thickness 222. In aspects, arrow 1206 can be followed from step 1203 to step 1205, for example, if the foldable substrate 1611 already comprises a recess 219 or will not include a recess 219. In aspects, arrow 1220 can be followed from step 1201 to step 1207, for example, if the foldable substrate 1611 already comprises substantially the substrate thickness and either comprises a recess 219 or will not include a recess 219. In aspects, arrow 1208 can be followed from step 1209 to step 1217, for example, if the foldable substrate is not to be contacted with an alkaline detergent solution or another solution (e.g., alkaline solution) after step 1209. In aspects, arrow 1210 can be followed from step 1209 to step 1219, for example, if the foldable substrate 1611 is the product of the method (see FIGS. 6-7) (e.g., without the adhesive layer 261, without the polymer-based portion 561, without the coating 507, without the release liner 271, and/or without the display device 307) and the foldable substrate 1611 is not to be contacted with an alkaline detergent solution or another solution (e.g., alkaline solution) after step 1209. In aspects, arrow 1212 can be followed from step 1209 to step 1213, for example, if the foldable substrate 1611 is to be contacted with the solution (e.g., alkaline solution) in step 1213 rather than the second alkaline detergent solution (e.g., step 1211). In aspects, arrow 1214 can followed from step 1211 to step 1217, for example, if the foldable substrate 1611 is to be assembled after step 1211 (e.g., without being contacted with the solution (e.g., alkaline solution) in step 1213). In aspects, arrow 1216 can be followed from step 1213 to step 1217, for example, if the foldable substrate is to be assembled after step 1213 (e.g., without being contacted with the third alkaline detergent solution in step 1215). In aspects, arrow 1218 can be followed from step 1215 to step 1219, for example, if the foldable substrate 2111 is the product of the method (see FIGS. 6-7) (e.g., without the adhesive layer 261, without the polymer-based portion 561, without the coating 507, without the release liner 271, and/or without the display device 307). Any of the above options may be combined to make a foldable apparatus in accordance with aspects of the disclosure. An exemplary aspect of the methods includes at least steps 1205, 1209, and 1211. Another exemplary aspect of the methods includes at least steps 1207 and 1209

Second, methods will be discussed with reference to the flow chart in FIG. 39 and example method steps illustrated in FIGS. 13-16, 18, 20, 23-26, and 40-42 along with the cross-sectional views illustrated in FIGS. 17, 19, and 22.

In a first step 3901 of methods of the disclosure, as shown in FIGS. 13-15, methods can start with providing a foldable substrate 1311. In aspects, step 3901 can comprise any one or more of the aspects discussed above with reference to step 1201. After step 3901, methods can proceed to step 1203 comprising reducing a thickness of the foldable substrate 1311, as discussed above with reference to FIG. 13. In aspects, after step 1203, methods can follow arrow 3908 to proceed to step 1221 methods can proceed to step 1221 comprising forming a recess 219 in the existing first major surface 1313, as discussed above with reference to FIG. 14. In aspects, after step 1203 or 1221, methods can proceed to step 1205 comprising rising contacting at least the existing first major surface 1313 of the foldable substrate 1311 with a first alkaline detergent solution comprising a first temperature for a first period of time under sonication, as discussed above with reference to FIG. 15. In aspects, after step 1221, methods can follow arrow 1222 to proceed to step 1207 comprising contacting the existing first major surface 1313 of the foldable substrate 1311 with an alkaline solution 1603 (FIG. 16) comprising a second temperature for a second period of time to remove a first outer layer 1702 (FIG. 17) from the existing first major surface 1313 to form a new first major surface 1613, as discussed above with reference to FIGS. 16-17. In aspects, step 1205 or 1207 can optionally further comprise rinsing the foldable substrate with a rinsing agent after reducing the thickness of the foldable substrate. In aspects, after step 3901, 1203, 1205, or 1207, methods can proceed to step 1209 comprising chemically strengthening the foldable substrate 1611 to form a first compressive stress region extending to a first depth of compression from the new first major surface 1613 of the foldable substrate 1611, as discussed above with reference to FIGS. 18-19. In aspects, step 1209 can optionally further comprise rinsing the foldable substrate with a rinsing agent after reducing the thickness of the foldable substrate. In aspects, after step 1209, methods can proceed to step 1211 comprising contacting the existing first major surface 1313 or the new first major surface 1613 with a second alkaline detergent solution 2003 comprising a third temperature for a third period of time under sonication, as discussed above with reference to FIG. 20.

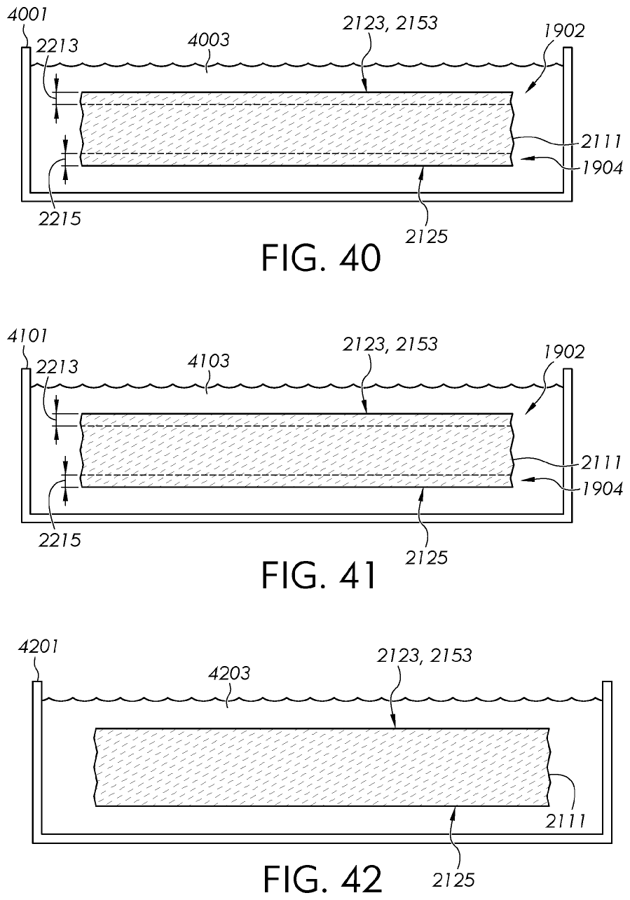

After step 3901, 1209, or 1211, as shown in FIG. 40, methods can proceed to step 3931 comprising contacting the existing first major surface 1313 or 1613 (see FIG. 20) with an acidic solution 4003 comprising a fourth temperature for a fourth period of time remove an outer layer (e.g., outer compressive layer of the existing first compressive stress region 1902) to form another first major surface 2123 or 2153. In aspects, as shown, the acidic solution 4003 can be contained in a bath 4001. In aspects, as shown, step 3931 can comprise contacting the existing second major surface 1315 or 1615 (see FIG. 20) with the acidic solution 4003 to remove an outer layer (e.g., second outer compressive layer of the existing second compressive stress region 1904) to from another second major surface 2125. In aspects, step 3931 can comprise contacting the existing first central surface area 1453 or 1653 (see FIG. 20) with the acidic solution 4003 to remove a first central outer compressive layer of the first central compressive stress region to form another first central surface area 2153. In aspects, a thickness 2203 or 2205 (see FIG. 22) of the first outer compressive layer 2202 or the second outer compressive layer 2204 can be less than the depth of compression 1903 or 1905 of the existing first compressive stress region 1902 and/or the existing second compressive stress region 1904. In aspects, the thickness 2203 or 2205 removed in step 3931 can be within one or more of the ranges discussed above for the thickness of the first outer layer 1702 in step 1207. In aspects, the thickness 2203 or 2205 removed in step 3931 can range from about 1 nm to about 5 μm, from about 1 nm to about 3 μm, from about 10 nm to about 2 μm, from about 100 nm to about 1 μm, from about 300 nm to about 1.8 μm, from about 500 nm to about 1.7 μm, from about 0.7 μm to about 1.5 μm, or any range or subrange therebetween. In aspects, the fourth period of time can be about 3 minutes or more, about 5 minutes or more, about 8 minutes or more, about 10 minutes or more, about 12 minutes or more, about 30 minutes or less, about 25 minutes or less, about 20 minutes or less, about 18 minutes or less, about 15 minutes or less, or about 12 minutes or less. In aspects, the fourth period of time can range from about 3 minutes to about 30 minutes, from about 5 minutes to about 25 minutes, from about 8 minutes to about 20 minutes, from about 10 minutes to about 18 minutes, from about 12 minutes to about 15 minutes, or any range or subrange therebetween. In aspects, the fourth temperature can be about 20° C. or more, about 25° C. or more, about 30° C. or more, about 50° C. or less, about 40° C. or less, or about 35° C. or less. In aspects, the fourth temperature can range from about 20° C. to about 50° C., from about 25° C. to about 40° C., from about 30° C. to about 35° C., or any range or subrange therebetween.

In aspects, the acidic solution 4003 can comprise at least one fluorine-containing compound. In further aspects, the acidic solution can comprise one or more of HF, NH₄F, and combinations thereof. In even further aspects, the acidic solution can comprise both HF and NH₄F. In further aspects, an amount of the at least one fluoride-containing compound, as a wt % of the acidic solution 4003, can be about 1 wt % or more, about 2 wt % or more, about 3 wt % or more, about 4 wt % or more, about 10 wt % or less, about 8 wt % or less, about 6 wt % or less, or about 5 wt % or less. In further aspects, an amount of the at least one fluoride-containing compound, as a wt % of the acidic solution 4003, from about 1 wt % to about 10 wt %, from about 2 wt % to about 8 wt %, from about 3 wt % to about 6 wt %, from about 4 wt % to about 5 wt %, or any range or subrange therebetween. Providing a fluoride-containing compound in the acidic solution can enable etching of the foldable substrate.

Without wishing to be bound by theory, the acidic solution can leach cations (e.g., alkali metal ions, transition metal ions, metallic ions) from the surface to produce a leached layer. For example, the hydrogen (e.g., hydronium ions) in the acidic solution can undergo a form of reverse ion-exchange at the surface to replace the cations in the foldable substrate with hydrogen. Also, the fluorine-containing compound in the acidic solution of the present disclosure can etch match from the surface by removing material (e.g., removing the leached layer and/or removing the material of the foldable substrate). Consequently, a leached layer can be formed and/or accumulate at a surface of the foldable substrate when the rate of leaching exceeds the rate of etching. In contrast, a leached layer may not be formed when the rate of etching is substantially equal to or greater to the rate of leaching. At the same time, fluorine-containing crystals can be deposited when the pH of the acidic solution is too high, and the fluorine-containing crystals can cause portions of the surface to be etched (or leached) unevenly. In view of the above considerations and as shown in the Examples below, it has been unexpectedly discovered that providing the acidic solution 4003 with a pH of about 3 or more, about 3.3 or more, about 3.35 or more, about 3.5 or less, about 3.45 or less or 3.4 or less can provide a substantially uniform surface that is substantially free from a leached surface layer. In aspects, the pH of the acidic solution can range from about 3 to about 3.5, from about 3.3 to about 3.5, from about 3.3 to about 3.45, from about 3.35 to about 3.4, or any range or subrange therebetween.

Throughout the disclosure, CIE color coordinates describe the CIELAB 1976 color space established by the International Commission on Illumination (CIE). Unless otherwise indicated, CIE color coordinates are measured in transmission through the glass article using an F02 illuminant and an observer angle of 10°. The CIELAB 1976 color space expresses color as three values: L* for the lightness from black (0) to white (100), a* from green (−) to red (+), and b* from blue (−) to yellow (+). Throughout the disclosure, “color shift” or “AE” value is measured between two points on the glass article corresponding to subscripts 1 and 2 using the CIE 1976 color space of L*, a*, and b* values as ΔE=√((L*₁−L*₂)²+(a*₁−a*₂)²+ (b*₁−b*₂)²).

Without wishing to be bound by theory, a surface of the foldable substrate with a leached layer may comprise an increased transmittance at lower optical wavelengths (e.g., from 360 nm to 400 nm), for example, greater than 93% or 1% or more than the transmittance at higher optical wavelengths (e.g., from 700 nm to 750 nm), or decreasing CIE a* or CIE b* values of the foldable substrate. In aspects, at the end of step 3931, the foldable substrate can comprise an average transmittance for optical wavelengths from 360 nm to 400 nm can be about 93% or less, about 92.8% or less, or about 92.5% or less. In aspects, at the end of step 3931, the foldable substrate can comprise an absolute value of a difference between a first average transmittance between 360 nm to 400 nm and a second average transmittance between 700 nm and 750 nm that is 1% or less, 0.9% or less, or 0.8% or less. In aspects, the first average transmittance between 360 nm to 400 nm can be less than the second average transmittance between 700 nm and 750 nm. In aspects, at the end of step 3931, the foldable substrate can comprise a CIE a* value of about −0.01 or more, about −0.008 or more, about −0.005 or more, about −0.003 or more, about 0.01 or less, about 0.008 or less, about 0.005 or less, about 0.001 or less, or about 0 or less. In aspects, at the end of step 3931, the foldable substrate can comprise a CIE a* value ranging from about −0.01 to about 0.01, from about −0.008 to about 0.008, from about −0.005 to about 0.005, from about −0.003 to about 0.001, from about −0.003 to about 0, or any range or subrange therebetween. In aspects, at the end of step 3931, the foldable substrate can comprise a CIE b* value of about −0.15 or more, about −0.12 or more, about −0.10 or more, about −0.08 or more, about −0.05 or more, about −0.03 or more, about 0.1 or less, about 0.08 or less, about 0.05 or less, about 0.02 or less, or about 0 or less. In aspects, at the end of step 3931, the foldable substrate can comprise a CIE b* value ranging from about −0.15 to about 0.1, from about −0.12 to about 0.08, from about −0.08 to about 0.05, from about −0.05 to about 0.02, from about −0.03 to about 0, or any range or subrange therebetween. In aspects, at the end of step 3931, the foldable substrate can comprise a color shift AE of about 0.3 or less, about 0.25 or less, or about 0.2 or less.

After step 3901, 1209, or 1211, as shown in FIG. 41, methods can proceed to step 3933 comprising contacting the existing first major surface 1313 or 1613 (see FIG. 20) with a solution 4103 comprising fluorosilicic acid at a fourth temperature for a fourth period of time remove an outer layer (e.g., outer compressive layer of the existing first compressive stress region 1902) to form another first major surface 2123 or 2153. In aspects, as shown, the solution 4103 comprising fluorosilicic acid can be contained in a bath 4101. In aspects, as shown, step 3933 can comprise contacting the existing second major surface 1315 or 1615 (see FIG. 20) with the solution 4103 comprising fluorosilicic acid to remove an outer layer (e.g., second outer compressive layer of the existing second compressive stress region 1904) to from another second major surface 2125. In aspects, step 3933 can comprise contacting the existing first central surface area 1453 or 1653 (see FIG. 20) with the solution 4103 comprising fluorosilicic acid to remove a first central outer compressive layer of the first central compressive stress region to form another first central surface area 2153. In aspects, a thickness 2203 or 2205 (see FIG. 22) of the first outer compressive layer 2202 or the second outer compressive layer 2204 can be less than the depth of compression 1903 or 1905 of the existing first compressive stress region 1902 and/or the existing second compressive stress region 1904. In aspects, the thickness 2203 or 2205 removed in step 3931 can be within one or more of the ranges discussed above for the thickness of the first outer layer 1702 in step 1207. In aspects, the thickness 2203 or 2205 removed in step 3933 can be within one or more of the ranges discussed above with reference to step 3931. In aspects, the fourth period of time in step 3933 can be within one or more of the ranges discussed above with reference to step 3931. In aspects, the fourth temperature can be about 20° C. or more, about 24° C. or more, about 30° C. or more about 32° C. or more, about 55° C. or less, about 40° C. or less, about 32° C. or less, or about 30° C. or less. In aspects, the fourth temperature can range from about 20° C. to about 55° C., from about 24° C. to about 40° C., from about 24° C. to about 32° C., from about 30° C. to about 32° C., or any range or subrange therebetween. In aspects, the concentration of fluorosilicic acid in the solution can be about 0.01 molar (M) or more, about 0.1 M or more, about 0.3 M or more, about 0.5 M or more, about 0.7 M or more, about 3.3 M or less, about 2.5 M or less, about 2 M or less, about 1.5 M or less, about 1 M or less, or about 0.8 M or less. In aspects, the concentration of fluorosilicic acid in the solution can range from about 0.01 M to about 3.3 M, from about 0.1 M to about 2.5 M, from about 0.3 M to about 2 M, from about 0.5 M to about 1.5 M, from about 0.5 M to about 1 M, or any range or subrange therebetween.

Unlike a solution with HF, NH₄F, or similar compounds directly added, a solution of fluorosilicic acid contains relatively little HF or F at any one point in time due to the equilibrium between HF or SiF₆⁻ and H₂SiF₆ and that more weight of SiF₆⁻ than F⁻ is required to have the same molar amount of the corresponding anion. Also, unlike a solution with HF, NH₄F, or similar compounds directly added, a solution of fluorosilicic acid forms a silica layer through redeposition of previously etched silicon atoms instead of and/or in addition to the leaching see in a solution with HF, NH₄F, etc. As the inventors of the present disclosure have unexpectedly discovered, the formation of a silica layer during treatment with a fluorosilicic acid solution can be minimized by (1) reducing the concentration of SiF₆⁻ anions (e.g., by increasing a concentration of H⁺ or hydronium ions and/or by decreasing the temperature of the solution), (2) reducing the water content of solution (e.g., using a solution containing an organic glycol), or (3) decreasing supersaturation of silica-like compounds near the surface (e.g., through agitation and/or rinsing the substrate).

Without wishing to be bound by theory, increasing the concentration of H⁺ or hydronium ions can reduce the concentration of SiF₆⁻ anions by shifting the equilibrium between H₂SiF₆ and 2H⁺+SiF₆⁻ towards H₂SiF₆. In aspects, a pH of the solution of fluorosilicic acid can be about 2 or less, about 1.5 or less, about 1 or less, or about 0.5 or less. In aspects, the solution of fluorosilicic acid can further comprise a mineral acid (e.g., strong acid), for example, HCl, HBr, HI, H₂SO₄, HNO₃, or HClO₄. In further aspects, a concentration of the mineral acid can be about 1 molar (M) or more, about 2 M or more, about 3 M or more, about 4 M or more, about 5 M or more, about 15 M or less, about 10 M or less, about 8 M or less, or about 5 M or less.

Without wishing to be bound by theory, decreasing the temperature of solution can decrease the concentration of SiF₆⁻ anions since the reaction from H₂SiF₆ and 2H⁺+SiF₆⁻ is endothermic. In aspects, the temperature of the solution of fluorosilicic acid can be about 32° C. or less, about 30° C. or less, about 28° C. or less, about 26° C. or less, about 20° C. or more, about 22° C. or more, or about 24° C. or more. In aspects, the temperature of the solution of fluorosilicic acid can range from about 20° C. to about 32° C., from about 22° C. to about 30° C., from about 24° C. to about 28° C., from about 24° C. to about 26° C., or any range or subrange therebetween.

Without wishing to be bound by theory, reducing the water content of solution (e.g., using a solution containing an organic glycol) can decrease the rate of reaction for the redeposition of the silica layer from the solution. While it is believed that a source of H⁺ or hydronium ions is important to the etching process, the amount of water can be reduced relative to a pure aqueous solution of fluorosilicic acid. In aspects, a mass ratio of water to an organic glycol in the solution can be about 0.5 or less, about 0.45 or less, about 0.4 or less, about 0.35 or less, about 0.05 or more, about 0.10 or more, about 0.2 or more, or about 0.3 or more. In aspects, a mass ratio of water to an organic glycol in the solution can range from about 0.05 to about 0.5, from about 0.10 to about 0.45, from about 0.2 to about 0.4, from about 0.3 to about 0.35, or any range or subrange therebetween.

Without wishing to be bound by theory, agitating the foldable substrate during step 3933 can decrease a supersaturation of silica-like compounds near the surface. In aspects, step 3933 can comprise agitating the foldable substrate during the contacting. As used herein, a total distance travelled by the foldable substrate in a second through the agitation can be determined as the product of the frequency of the agitation times twice the displacement of the foldable substrate in half of a cycle. For the Examples discussed below, a vertical displacement of 50 mm was used with the frequency of agitation adjusted to achieve the reported agitation in mm/s (e.g., 50 mm×2×0.55 s⁻¹=55 mm/s), although side-to-side displacement or a combination of vertical and side-to-side displacement can be used in other aspects. In aspects, the total distance travelled by the foldable substrate in a second by the agitation can be about 35 millimeters per second (mm/s) or more, about 55 mm/s or more, about 70 mm/s or more, about 100 mm/s or more, about 150 mm/s or more, about 200 mm/s or more. Alternatively or additionally, as discussed with reference to step 3935 in the next paragraph, in aspects, the foldable substrate can be rinsed at least once during step 3933 (or between step 3933 and returning to step 3933 one or more times).

After (or during) step 3933, as shown in FIG. 42, methods can proceed to step 3935 comprising rinsing the foldable substrate 2111 with a solution 4203. In aspects, as shown, the solution 4203 can be contained in a bath 4201 when rinsing the foldable substrate 2111. In aspects, although not shown, rinsing the foldable substrate can comprise flowing (e.g., spraying, pouring) the solution onto and/or along the another first major surface 2123 and/or the another second major surface 2125 of the foldable substrate 2111. In aspects, the solution 4203 can comprise water (e.g., deionized water), although the solution can comprise an alkaline solution (e.g., alkaline detergent solution) in other aspects. In aspects, methods can go between step 3933 and step 3935 one or more times. For example, the foldable substrate 2111 can be rinsed (step 3935) one or more times during the contact in step 3933. In further aspects, the foldable substrate 2111 can be rinsed at least every 10 minutes, at least every 8 minutes, or at least every 5 minutes during the contacting. Viewed another way, the total time that the foldable substrate 2111 contacts the solution 4103 of fluorosilicic acid can comprise multiple sessions (e.g., in step 3933) of about 10 minutes or less, about 8 minutes or less, or about 5 minutes or less with rinsing (e.g., in step 3935) in between these sessions. For example, if a total time in step 3933 is to be 25 minutes and the foldable substrate is to be rinsed with deionized water every 10 minutes, steps 3933 and 3935 can comprise immersing the foldable substrate for 10 minutes in the solution of fluorosilicic acid, rinsing the foldable substrate, immersing the foldable substrate for another 10 minutes in the solution of fluorosilicic acid, rinsing the foldable substrate again, and then immersing the foldable substrate for a final 5 minutes in the solution of fluorosilicic acid.

After step 3931, 3933, or 3935, as shown in FIGS. 24-26, methods can proceed to step 1217 comprising assembling the foldable apparatus. In aspects, as shown in FIGS. 24-26, step 1217 can comprise one or more of the aspects discussed above with reference to step 1217. After step 3931, 3935, or 1217, methods can be complete at step 3937.

In aspects, methods of making a foldable apparatus in accordance with aspects of the disclosure can proceed along steps 3901, 1203, 1205, 1209, 1211, 3931, 1215, 1217, and 3937 of the flow chart in FIG. 39 sequentially, as discussed above. In aspects, arrow 3902 can be followed from step 3901 to step 1209, for example, when the foldable substrate 1311 comprises substantially the substrate thickness at the end of step 3901 and the foldable substrate comprises the recess 219 or the foldable substrate is not to comprise a recess 219. In aspects, arrow 3904 can be followed from step 1201 to step 3931, for example, if the foldable substrate 1611 already comprises substantially the substrate thickness 222 and is already chemically strengthened or is not to be chemically strengthened before step 3931. In aspects, arrow 3906 can be followed from step 3901 to step 3933, for example, if the foldable substrate 1611 already comprises substantially the substrate thickness 222 and is already chemically strengthened or is not to be chemically strengthened before step 3933. In aspects, arrow 3908 can be followed from step 1203 to step 1211, for example, if a recess 219 is to be formed in the foldable substrate. In aspects, arrow 3910 can be followed from step 1203 to step 1209, for example, if the foldable substrate is not to be contacted with an alkaline detergent solution (or another solution) before chemically strengthening the foldable substrate in step 1209. In aspects, arrow 3912 can be followed from step 1221 to step 1207, for example, if the foldable substrate 1611 is to be treated with an alkaline solution after forming the recess 219 in step 1221 and/or before chemically strengthening the foldable substrate 1611 in step 1209. In aspects, arrow 3914 can be followed from step 1221 to step 1209, for example, if the foldable substrate is not to be contacted with an alkaline solution (or another solution) before chemically strengthening the foldable substrate in step 1209. In aspects, arrow 3916 can be followed from step 1209 to step 3931, for example, if the foldable substrate is to be treated with the acidic solution 4003 without treating the foldable substrate with the second alkaline detergent solution in step 1211. In aspects, arrow 3918 can be followed from step 1209 to step 3933, for example, if the foldable substrate is to be treated with the solution 4103 of fluorosilicic acid without treating the foldable substrate with the second alkaline detergent solution in step 1211. In aspects, arrow 3920 can be followed from step 1211 to step 3933, for example, if the foldable substrate is to be treated with the solution 4103 of fluorosilicic acid (instead of the acidic solution 4003). In aspects, arrow 3924 can be followed from step 3933 to step 3935, for example, if the foldable substrate is to be rinsed during (or after) contacting the foldable substrate with the solution 4103 of fluorosilicic acid. In aspects, arrow 3926 can be followed from step 3935 to step 3933, for example, if the foldable substrate is to be further contacted with the solution 4103 of fluorosilicic acid after the foldable substrate is rinsed. In aspects, arrow 3928 can be followed from step 3935 to step 1217, for example, if the foldable apparatus is to be assembled without treating the foldable substrate with the third alkaline detergent solution. In aspects, arrow 3930 can be followed from step 3935 to step 3937, for example, if methods are complete at the end of step 3935. In aspects, arrow 3932 can be followed from step 3931 to step 1217, for example, if the foldable apparatus is to be assembled without treating the foldable substrate with the third alkaline detergent solution. In aspects, arrow 3934 can be followed from step 3931 to step 3937 if methods are complete at the end of step 3931. Any of the above options may be combined to make a foldable apparatus in accordance with aspects of the disclosure. An exemplary aspect of the methods includes at least step 3931 or steps 3933 and 3935.

While the methods discussed above with reference to the flow chart in FIG. 39 are generally applicable to glass-based substrates (and/or ceramic-based substrate), such methods may be especially useful for glass-based substrates with 12 mol % or more of Al₂O₃ (e.g., from about 12 mol % to 20 mol %, from about 13 mol % to about 18 mol %, from about 14 mol % to about 16 mol %), R₂O−RO of about 11 mol % or more (e.g., from about 11 mol % to about 16 mol %, from about 12 mol % to about 14 mol %), and/or Al₂O₃+RO−R₂O of about 1 mol % or more (e.g., from about 1 mol % to about 5 mol %, from about 2 mol % to about 4 mol %), where RO refers to alkaline earth metal oxides (e.g., CaO) and R₂O refers to alkali metal oxides (e.g., Na₂O). Composition 2 (Examples 1-31 and KK-MM), as compared to Composition 1 (A-H, K-Y, and AA-HH), comprised additional Al₂O₃, CaO, and Na₂O while a total amount of alkali metal oxides (R₂O, e.g., Na₂O) plus alkaline earth oxides (RO=MgO+CaO) was about the same. Although not shown below, the leached layers, redeposited silica, and discoloration observed for Composition 2 (Examples 1, 5, 11-14 and LL-MM) were not necessarily encountered when the same treatments were applied to Composition 1. This difference was unexpected given the similarity of Composition 1 and Composition 2. Without wishing to be bound by theory, it is believed that the increased amount of multivalent cations (e.g., Al₂O₃, RO) in Composition 2 (relative to Composition 1) can facilitate the redeposition of silica (for the fluorosilicic acid solutions) by reacting with the non-silica products of the redeposition reaction and/or by increasing a rate of the leaching reaction (for fluorine-containing acidic solution).

### EXAMPLES

Various aspects will be further clarified by the following examples. Examples A-H, K-Y, and AA-HH all comprise a glass-based substrate (having a Composition 1 of, nominally, in mol % of: 69.1 SiO₂; 10.1 Al₂O₃; 15.4 Na₂O; 4.85 MgO; 0.52 CaO; 0.08 SnO₂). Examples A-H and K-Y comprise a substrate thickness of 30 μm, and Examples AA-HH comprise a substrate thickness of 100 μm. Table 1 presents treatment conditions for Examples A-H and demonstrates the effect of time and temperature of the thickness removed and/or etch rate (e.g., rate of thickness removal). Tables 2 and 4-5 present the pen drop height of Examples K-Y. The pen drop threshold height (“Pen Drop Height”) reported in Tables 2 and 4-5 for Examples K-Y is the average of at least 9 samples. Table 3 presents the thickness removed during the treatment and pen drop height of Examples AA-HH.

Examples A-H comprised glass-based substrates comprising Composition 1 that were treated by contacting the first major surface with an alkaline solution comprising 45 wt % KOH at the temperature and time presented in Table 1. Table 1 also presents the thickness removed from the first major surface and the etch rate. As shown, the thickness removed increased as the time was increased at the same concentration. Likewise, the thickness removed increased as the temperature was increased at the same concentration. At 75° C., the etching rate was between 1.3 nm/min and 1.6 nm/min and the thickness removed ranged from 40 nm to 190 nm. At 90° C., the etching rate was between 4.7 nm/min and 5.5 nm/min and the thickness removed ranged from 142 nm to 648 nm.

TABLE 1
Treatment Conditions and Properties of Examples A-H

| | Temperature | Time | Thickness | Etch Rate |
|---|---|---|---|---|
| Example | (° C.) | (min) | Removed (nm) | (nm/min) |
| A | 75 | 30 | 40 | 1.34 |
| B | 75 | 60 | 93 | 1.55 |
| C | 75 | 90 | 131 | 1.46 |
| D | 75 | 120 | 190 | 1.58 |
| E | 90 | 30 | 142 | 4.74 |
| F | 90 | 60 | 329 | 5.48 |
| G | 90 | 90 | 446 | 4.96 |
| H | 90 | 120 | 648 | 5.40 |

Examples K-R comprised glass-based substrates comprising Composition 1 that were treated as shown in Table 2. Examples L-R were chemically strengthened (“IOX”) in a bath comprising 100% molten KNO₃ at 410° C. for 7 minutes while Example K was not. Example K was not further treated. Examples M-N were treated with an alkaline solution comprising 45 wt % KOH at 90° C. for 60 minutes. Example O was treated with an H₂SiF₆-containing solution comprising 0.5 M H₂SiF₆ at 40° C. for 7.75 minutes. Example P was treated with a fluoride-containing solution comprising 10 wt % ammonium fluoride (NH₄F) and 3 M sulfuric acid (H₂SO₄) at 25° C. for 10 minutes. Example Q was treated with a fluoride-containing solution comprising 10 wt % ammonium fluoride (NH₄F) without an acid at 25° C. for 10 minutes. Example R was treated with a fluoride-containing solution comprising 0.58 M HF and 0.8 M HNO₃ and a temperature of 24° C. for 117 seconds. In Table 2, the arrow→indicates the treatment to the left of the arrow occurs before the treatment to the right of the arrow.

TABLE 2
Thickness Removed and Pen Drop Results for Examples K-R

| | | Thickness | Pen Drop |
|---|---|---|---|
| Example | Treatment Condition | Removed (nm) | Height (cm) |
| K | No IOX | 0 | 17.0 |
| L | IOX (only) | 0 | 11.5 |
| M | KOH (only) | 446 | 22.0 |
| N | KOH → IOX | 446 | 17.0 |
| O | H₂SiF₆ → IOX | 239 | 6.5 |
| P | IOX → NHF₄ + H₂SO₄ | 500 | 13.50 |
| Q | IOX → NH₄F | 250 | 14.25 |
| R | IOX → HF + HNO₃ | 860 | 14.0 |

As shown in Table 2, the pen drop height decreased from 17.0 cm in Example K to 11.5 cm in Example L by chemically strengthening the foldable substrate. Example O comprising treatment with the H₂SiF₆-containing solution before the chemical strengthening further decreased the pen drop height to 6.5 cm (compared to Examples K-L). In contrast, Example N comprising treatment the alkaline solution (KOH) before the chemical strengthening increased the pen drop height compared to Example L. Indeed, treatment with the alkaline solution (KOH) in Example N increased the pen drop height relative to Example L by 5.5 cm (47% increase). Comparing Examples K and M, treatment with the alkaline solution (KOH) in Example M increased the pen drop height relative to Example K by 5.0 cm (29% increase). As with Example K to Example L, the pen drop decreased as a result of the chemically strengthening from Example M to Example N. Without wishing to be bound by theory, crack growth can occur in the presence of a corrosive environment, at elevated temperatures, and/or when the material is subject to stress, for example, via stress corrosion cracking-all of which can occur during chemical strengthening. For example, the presence of water (e.g., from ambient humidity or in the salt bath during chemical strengthening) can lead to the formation and/or growth of flaws (e.g., cracks) during chemical strengthening, for example, by disrupting silica-oxygen bonds in a glass-based or ceramic-based substrate. Consequently, providing an alkaline detergent solution or an alkaline solution before chemical strengthening can reduce the extent and density of flaws (e.g., cracks) present during chemical strengthening.

Examples P-Q comprise treatment with a fluoride-containing solution, which increased the pen drop height relative to Example L. However, the increase of Examples P-Q was about 2.75 cm or less (less than about 24% increase). Examples P and R comprises treatment with an acidic solution, which increased the pen drop height relative to Example L. However, the increase of Examples P and R was about 2.75 cm or less (less than about 24% increase). Comparing the treatments before the chemical strengthening, it is unexpected that the alkaline solution (Example M) increases the pen drop height after the chemical strengthening given that the treatment with the H₂SiF₆-containing solution did not-let alone that the pen drop height would increase by more than 20%, more than 30%, or more than 40%. Comparing treatment with the alkaline solution before the chemical strengthening (Example M) to the acidic and fluoride-containing treatments after the chemical strengthening (Examples P-R), it is unexpected that Example M would provide a greater increase in pen drop height.

Table 3 presents properties of Examples AA-HH. The maximum compressive stress (CS), depth of layer (DOL), depth of compression (DOC), and maximum central tension (CT) for Examples AA-HH were measured after the stated treatment was performed and changes (A) in these properties were calculated relative to the properties of the compressive stress region in Example AA (e.g., the ΔCS for Example BB is calculated as the CS for Example AA minus the CS for Example BB, whereby a negative ΔCS indicates an increase in CS relative to Example AA, and a positive ΔCS indicates a decrease in CS relative to Example AA; ΔDOL, ΔDOC, and ΔCT are calculated in a manner similar to that as explained for ΔCS). As discussed above, CS and CT values are reported as absolute values, a difference between compressive stress values is equal to a difference between the absolute value of the first compressive stress value minus the absolute value of the second compressive stress value, and a difference between central tensile stress is equal to a difference between the absolute value of the first central tensile stress value minus the absolute value of the second central tensile stress value. Example AA was treated identically to Example B. Example BB was treated comprising 0.58 M HF and 0.8 M HNO₃ and a temperature of 24° C. for 117 seconds before the chemical strengthening of Example AA. Examples CC-EE were treated with the H₂SiF₆-containing solution comprising the stated concentration at 40° C. for 134 seconds, 64 seconds, or 33 seconds, respectively before the chemical strengthening of Example AA. Examples FF-HH were treated with an alkaline solution comprising 45 wt % KOH at 90° C. for the stated time.

TABLE 3
Properties of Treated, Chemically Strengthened Examples AA-HH

| | | Thickness | CS | DOL | DOC | CT |
|---|---|---|---|---|---|---|
| Example | Treatment Condition | removed (nm) | (MPa) | (μm) | (μm) | (MPa) |
| AA | IOX (only) | 0 | 890.4 | 18.28 | 17.67 | 243.4 |
| BB | HF/HNO₃ → IOX | 650 | 906.5 | 17.86 | 17.52 | 244.4 |
| CC | 0.5M H₂SiF₆ → IOX | 540 | 886.5 | 17.60 | 17.26 | 233.6 |
| DD | 1.0M H₂SiF₆ → IOX | 690 | 892.0 | 17.79 | 17.45 | 239.0 |
| EE | 1.5M H₂SiF₆ → IOX | 650 | 892.1 | 17.75 | 17.41 | 238.2 |
| FF | KOH (10 min) → IOX | 65 | 888.8 | 18.20 | 17.84 | 246.6 |
| GG | KOH (45 min) → IOX | 125 | 875.7 | 18.32 | 17.96 | 245.4 |
| HH | KOH (90 min) → IOX | 165 | 879.3 | 18.10 | 17.75 | 242.0 |

| | | ΔCS | ΔDOL | ΔDOC | ΔCT |
|---|---|---|---|---|---|
| Example | Treatment Condition | (MPa) | (μm) | (μm) | (MPa) |
| AA | IOX (only) | 0 | 0 | 0 | 0 |
| BB | HF/HNO₃ → IOX | −16.1 | 0.42 | 0.15 | −1.0 |
| CC | 0.5M H₂SiF₆ → IOX | 3.9 | 0.68 | 0.41 | 9.8 |
| DD | 1.0M H₂SiF₆ → IOX | −1.6 | 0.49 | 0.22 | 4.4 |
| EE | 1.5M H₂SiF₆ → IOX | −1.7 | 0.53 | 0.26 | 5.2 |
| FF | KOH (10 min) → IOX | 1.6 | 0.08 | −0.17 | −3.2 |
| GG | KOH (45 min) → IOX | 14.7 | −0.04 | −0.29 | −2.0 |
| HH | KOH (90 min) → IOX | 11.1 | 0.18 | −0.08 | 1.4 |

As shown in Table 3, the average thickness removed the acidic solution of Example BB was about 650 nm. The average thickness removed by the H₂SiF₆-containing solutions of Examples CC-EE were from about 500 nm to about 700 nm. The average thickness removed by the alkaline solution (KOH) of Examples FF-HH ranged from about 50 nm to about 175 nm. Comparing the thickness removed in Table 3 with the pen drop heights of Table 2, it is unexpected that the alkaline solution (KOH) can provide the increased pen drop height given that the treatment with the alkaline solution removes less than 200 nm.

As shown in Table 3, Examples AA-HH comprise a maximum compressive stress from about 870 MPa to about 910 MPa. However, treatment with the acidic solution in Example BB increased the resulting compressive stress by about 15 MPa (about 1.7%). For Examples CC-EE, treatment with the H₂SiF₆-containing solution changed the maximum compressive stress by less than 5 MPa (less than 0.5%). For Examples FF-HH, treatment with the alkaline solution (KOH) decreased the maximum compressive stress by less than 15 MPa (about 1.7% or less). Examples BB-FF and HH all decreased the resulting depth of layer. Examples BB-EE (treatment with the acidic solution or the H₂SiF₆-containing solution) decreased the resulting depth of compression. However, treatment with the alkaline solution (KOH) actually increased the depth compression, which may explain the decrease in maximum compressive stress since the compressive region extends to a deeper depth. Without wishing to be bound by theory, the KOH solution may selectively remove flaws near the surface before removing other portions of the substrate, which would explain why the change in DOC is less for Example HH and Examples FF-GG; Example HH may correspond to when an entire surface, including the ions from chemically strengthening the surface may be removed, while Examples FF-GG may correspond to the removal of flaws without also removing all the ions from the chemically strengthening. Examples CC-EE and HH decreased the maximum CT while Examples BB and FF-GG increased the maximum CT. Examples GG is notable because it is the only one of Examples BB-HH to increase the depth of layer, increase the depth of compression, and increase the maximum CT.

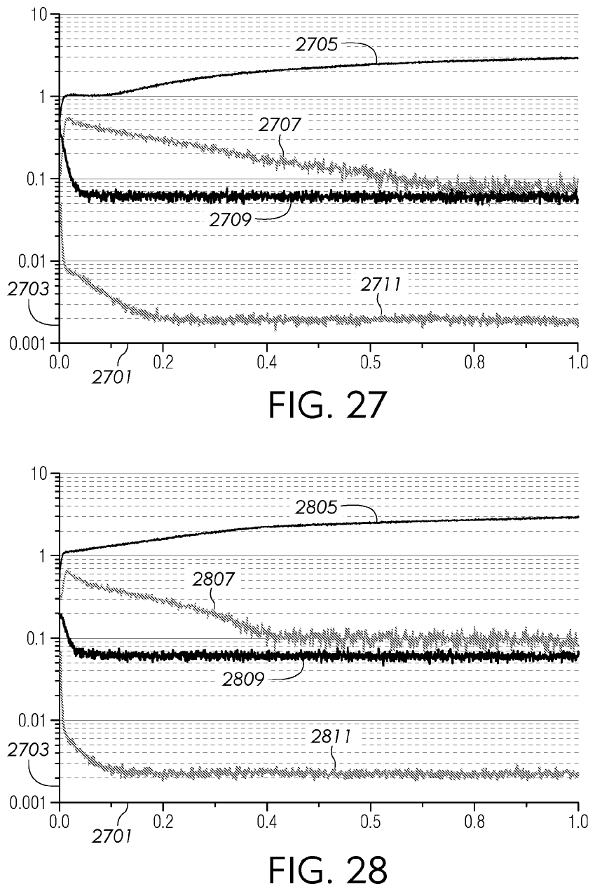

The results of analyzing Examples AA, BB, CC, and GG were analyzed using secondary ion mass spectrometry (SIMS) are presented in FIGS. 27-30, respectively. In FIGS. 27-30, the horizontal axis 2701 (i.e., x-axis) is a depth from the first major surface of the glass-based substrate in micrometers, and the vertical axis 2703 (i.e., y-axis) is a detected amount on a log axis. For Na₂O and CaO, the vertical axis 2703 corresponds to mole % while the vertical axis 2703 corresponds to atom % for H (hydrogen) and F (fluorine). Curves 2705, 2805, 2905, and 3005 correspond to Na₂O. Curves 2707, 2807, 2907, and 3007 correspond to H. Curves 2709, 2809, 2909, and 3009 correspond to CaO. Curves 2711, 2811, 2911, and 3011 correspond to F.

In FIG. 27, for Example AA, curve 2705 shows that Na₂O is depleted at the surface (e.g., about 0.35 μm) as a result of the chemical strengthening process, where the sodium ions were exchanged with potassium ions. Consequently, curve 2709 shows that CaO is enriched at the surface. Curve 2707 shows that H is elevated (greater than about 0.09 atom % H) out to about 0.6 μm or more from the surface while curve 2711 shows that F is elevated (greater than about 0.002 atom % F) out to about 0.2 μm from the surface.

In FIG. 28, for Example BB, curve 2805 shows that Na₂O is less depleted with 0.2 μm of the surface than for curve 2705. Curve 2809 is less elevated within about 0.05 μm of the surface than curve 2709. Curve 2807 is more elevated within about 0.08 μm of the surface than curve 2707. For example, the maximum of curve 2807 is about 0.7 atom % H while the maximum of curve 2707 is about 0.5 atom % H. The elevation of curve 2811 decays less steeply within about 0.1 μm of the surface than curve 2711. Consequently, it is expected that the treatment of Example BB changes the composition of the sample near the surface (e.g., within about 0.2 μm from the surface, within about 0.1 μm, within about 0.05 μm).

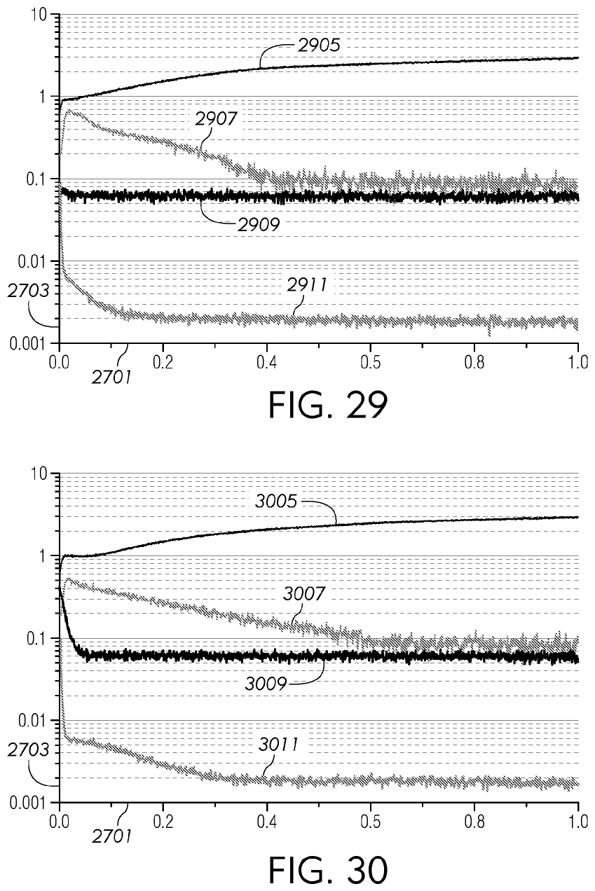

In FIG. 29, for Example CC, curve 2905 resembles curve 2705. Compared to curves 2709 and 2809, curve 2909 is not elevated near the surface. However, curves 2907 and 2911 resemble curves 2807 and 2811, respectively. Based on Examples BB and CC, removing 650 nm (Example BB) or 540 nm (Example CC) with an acidic solution (e.g., HF/HNO₃, H₂SiF₆) changes the concentration of hydrogen (e.g., hydronium) at the surface as well as the concentration of fluorine at the surface. Without wishing to be bound by theory, it is expected that removing a hydronium-enriched layer (elevated H concentration) from the surface would remove flaws and increase pen drop performance. As discussed above, Example CC decreased the pen drop height relative to Examples AA-BB. Based on this theory, it is unexpected that Example CC does not increase the pen drop height relative to Example AA. Based on the performance of Example CC relative to Example AA, it would be expected that treatments before the chemical strengthening might not improve pen drop heights.

In FIG. 30, for Example GG, curve 3005 shows that Na₂O is depleted for about 0.3 μm to about 0.3 μm from the first major surface. The curvature of curve 3005 is similar to curve 2705, but the depletion does not extend as far in curve 3005. Curve 3009 resembles curve 2709, but the depletion does not extend as far in curve 3009 (e.g., about 0.03 μm versus about 0.05 μm). Curve 3007 has the same maximum atom % H as curve 2707; however curve 3007 is enriched for a shorter distance than curve 3007 (e.g., about 0.6 μm versus about 0.7 μm). The enrichment near the surface (e.g., from about 0.05 μm to about 0.1 μm) shown in curve 3011 decays more slowly than curves 2707, 2807, and 2907; however, the surface enrichment of curve 3011 is less than that in curve 2711. Overall, curves 3005, 3009, and 3007 closely resemble curve 2705, 2709, and 2707. On the one hand, it is expected that the concentrations of Example GG would closely resemble those of Example AA since only 125 nm was removed by the treatment of Example GG, which is less than the thickness removed by Examples BB and CC. On the other hand, it unexpected that the pen drop performance of the KOH treatment before the chemical strengthening (Example N) is improved relative to no treatment before the chemical strengthening (Example K). Indeed, based on the theory of hydronium enrichment discussed above in view of curve 3007 compared to curve 2707, it would be expected that the KOH treatment would not significantly change the pen drop performance. However, as shown in Table 2, KOH unexpectedly increases the pen drop performance.

The treatments of Examples S-T were applied to a glass-based substrate comprising a high total thickness variation (TTV) of about 5 μm or more and a low TTV of about 3 μm or less. The treatment of Example S was identical to Example A. Example T comprised treatment with an alkaline detergent solution of 1 wt % SemiClean KG (Yokohama Oils & Fats Industry Co.). The low TTV samples comprised a higher pen drop height than the high TTV for the treatments of both Examples S-T. For the high TTV samples, the pen drop height increased by 9 cm (90%) with the alkaline detergent treatment (comparing Examples S-T). For the low TTV, the pen drop height increased by 4 cm (21%) with the alkaline detergent treatment (comparing Examples S-T).

TABLE 4
Pen Drop Results for Examples S-T

| | | Pen Drop | Pen Drop |
|---|---|---|---|
| | | Height (cm) - | Height (cm) - |
| Example | Treatment Condition | High TTV | Low TTV |
| S | No IOX | 10 | 19 |
| T | Alkaline Detergent (only) | 19 | 23 |

TABLE 5
Pen Drop Results for Examples U-Y

| | | Pen Drop |
|---|---|---|
| Example | Treatment Condition | Height (cm) |
| U | Etch | 2.5 |
| V | Etch → Alkaline Detergent | 5.0 |
| W | Etch → Alkaline Detergent → | 1.0 |
| | IOX → Alkaline Detergent | |
| X | Etch → Alkaline Detergent → | 4.0 |
| | IOX → Alkaline Detergent → | |
| | HF + HNO₃ | |
| Y | Etch → Alkaline Detergent → | 7.0 |
| | IOX → Alkaline Detergent → | |
| | HF + HNO₃ → Alkaline Detergent | |

Examples U-Y were etched using an HF solution to obtain the substrate thickness of 30 μm. Examples V-Y were treated with a first alkaline detergent solution (1 wt % SemiClean KG) at 50° C. for 3 minutes under ultrasonication following the etching. Examples W-Y were further treated by chemically strengthening the foldable substrate in a bath comprising 100% molten KNO₃ at 410° C. for 7 minutes and then a second alkaline detergent solution (1 wt % SemiClean KG) at 50° C. for 3 minutes under ultrasonication, where the chemical strengthening treatment occurred after treatment with the first alkaline detergent solution. Examples X-Y were further treated with a solution comprising 0.58 M HF and 0.8 M HNO₃ at 24° C. for 117 seconds after treatment with the second alkaline detergent solution. Example Y was further treated with a third alkaline detergent (1 wt % SemiClean KG) at 50° C. for 3 minutes under ultrasonication after treatment with the HF treatment at the end of Example X.

As shown in Table 5, the treatment with the first alkaline detergent solution (comparing Examples U-V) increased the pen drop height by 2.5 cm (100% increase). Similar results were obtained when the treatment with the alkaline detergent solution under ultrasonication was 5 minutes or 10 minutes as compared to 3 minutes. Comparing Examples W-X, the HF treatment after the chemical strengthening increased the pen drop height by 3 cm (300% increase). However, treatment with the third alkaline detergent solution (comparing Examples X-Y) further increases the pen drop height by 3 cm (75% increase). Comparing Examples W and Y, the post-chemical strengthening treatments together increased the pen drop height by 6 cm (600% increase). It is unexpected that the third alkaline detergent solution could further increase the pen drop height after the HF treatment since the HF treatment is conventionally used to increase the pen drop height after the chemical strengthening, for example by removing flaws from the surface of the glass-based substrate.

Examples 1-31 and KK-MM all comprise a glass-based substrate (having a Composition 2 of, nominally, in mol % of: 65.1 SiO₂; 14.05 Al₂O₃; 16.41 Na₂O; 3.35 MgO; 0.96 CaO; 0.13 SnO₂) and a substrate thickness of 75 μm. Table 6 presents treatment conditions for Examples 1-3 and KK-LL and demonstrates the effect of pH on the properties of foldable substates treated with a fluorine-containing acidic solution. Table 7 presents the treatment conditions and appearance of Examples 4-11 and MM. Table 8 presents the treatment conditions and appearance of Examples 12-21. Table 9 presents conditions and the pen drop height of Examples 22-31, where the pen drop threshold height (“Pen Drop Height”) reported in Table 9 is the average of at least 5 samples. The agitation for Examples 6-21 was achieved by moving the foldable substrate a distance of 50 mm with the frequency of agitation adjusted to achieve the stated rate in mm/s.

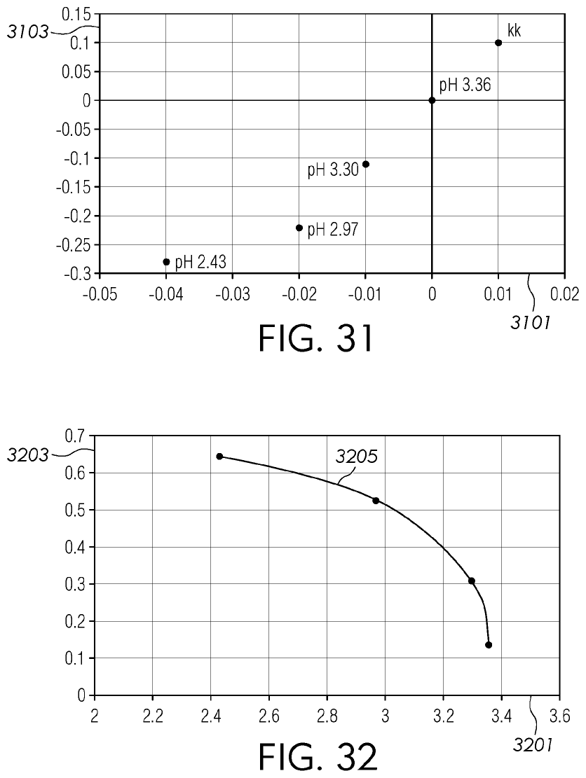

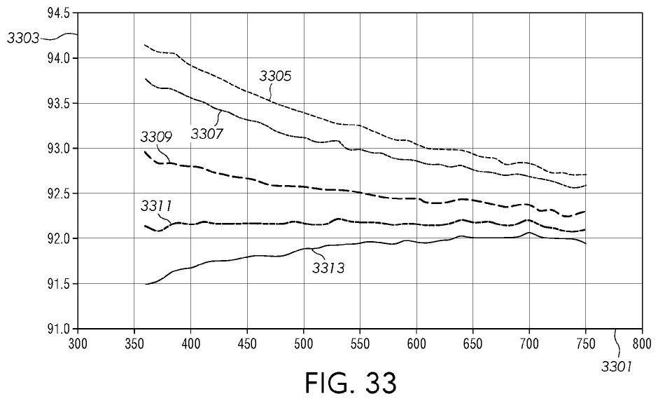

FIGS. 31-33 graphically represent the properties shown in Table 6. In FIG. 31, the horizontal axis 3101 corresponds to the CIE a* value, and the vertical axis 3103 corresponds to the CIE b* value. In FIG. 32, the horizontal axis 3201 corresponds to pH of the acidic solution, and the vertical axis 3203 corresponds to the color shift AE. In FIG. 33, the horizontal axis 3301 corresponds to optical wavelength in nanometers (nm), and the vertical axis 3303 represents transmittance in percent (%). Curve 3313 corresponds to Example KK, curve 3305 corresponds to Example LL, and curves 3307, 3309, and 3311 correspond to Examples 1-3, respectively.

TABLE 6
Properties of Examples 1-3 and KK-LL

| | | | | | | | | ave % |
|---|---|---|---|---|---|---|---|---|
| | Treatment | | | | | | ave % | T₇₀₀₋₇₅₀ − |
| Ex. | Condition | pH | L* | a* | b* | ΔE | T₃₆₀₋₄₀₀ | T₃₆₀₋₄₀₀ |
| KK | none | n/a | 96.79 | 0.01 | 0.1 | n/a | 91.6 | 0.4 |
| LL | 1 wt % HF | 2.43 | 97.32 | −0.04 | −0.28 | 0.65 | 94.0 | −1.3 |
| 1 | 2.5 wt % HF + | 2.97 | 97.22 | −0.02 | −0.22 | 0.53 | 93.6 | −1.3 |
| | 2 wt % NH₄F | | | | | | | |
| 2 | 1.25 wt % HF + | 3.3 | 96.89 | 0 | 0 | 0.14 | 92.8 | −0.5 |
| | 2 wt % NH₄F | | | | | | | |
| 3 | 2.5 wt % HF + | 3.36 | 97.03 | −0.01 | −0.11 | 0.31 | 92.2 | 0.4 |
| | 4 wt % NH₄F | | | | | | | |

Table 6 presents the properties of Examples 1-3 and KK-LL. Example KK is the untreated sample, which is used as the baseline for calculating the color shift AE. Example LL was treated with a 1 wt % HF solution with a pH of 2.43. As shown in Table 6 and FIGS. 31-32, Example LL is the furthest from Example KK with a CIE a* value of −0.04, a CIE b* value of −0.28, and a color shift AE of 0.65. As discussed above, it is believed that this difference in CIE coordinates (and color shift AE) are associated with a leached layer at the surface of the foldable substrate after treatment with the acidic solution. Going from Example 1 to Example 3, the pH increases and the CIE color coordinates (and color shift AE) get closer to Example KK. As shown in FIG. 31, there is a qualitative change between the trend of Example LL and 1 versus Examples 2-3. While there is a 0.5 pH difference between Example KK and Example 1, there is a larger change in color coordinates and color shift between Example 1 and 2 with a 0.33 pH difference. Examples 2-3 have a CIE a* value from −0.01 to 0.01 (e.g., from −0.01 to 0), a CIE b* value from −0.15 to 0.1 (e.g., from −0.11 to 0), and a color shift AE from 0 to about 0.3 (e.g., from about 0.1 to about 0.3). Further, there is a dramatic change in color coordinates and color shift going from 3.3 pH to 3.36 pH. Indeed, FIG. 32 shows that there is an asymptotic curve 3205 between color shift and pH with an asymptote around 3.4 pH. As discussed above, it is believed that increasing pH (e.g., towards 3.4) increases the etching rate relative to the leaching rate to the point where the etching rate is eventually equal to or greater than the leaching rate. However, as discussed above, increasing the pH too far beyond that point (e.g., to about 3.5) is expected to cause uneven etching from deposition of fluorine-containing crystals.

FIG. 33 shows how transmission changes over optical wavelength for Examples 1-3 and KK-LL. Curve 3313 (Example KK) has the lowest transmittance. Without wishing to be bound by theory, it is believed that the different refractive index of the leached layer decreases reflection by decreasing the refractive index between the bulk of the substrate and air. As shown in FIG. 33 and Table 6, the average transmission over optical wavelengths from 360 nm to 400 nm decreases from Example LL and through Examples 1-3. Consequently, the decrease in average transmission over optical wavelengths from 360 nm to 400 nm as the pH increases further supports the position that increasing pH reduces the thickness of the leached layer. Also, Examples LL and 1 have an average transmission over optical wavelengths from 360 nm to 400 nm greater than 93% while Examples 2-3 and KK have an average transmission over optical wavelengths from 360 nm to 400 nm less than 93%. Likewise, the absolute value of the difference between the average transmission over optical wavelengths from 700 nm to 750 nm and the average transmission over optical wavelengths from 350 nm to 400 nm is about 0.5 or less for Examples 2-3 and KK while it is greater than 1 for Examples LL and 1.

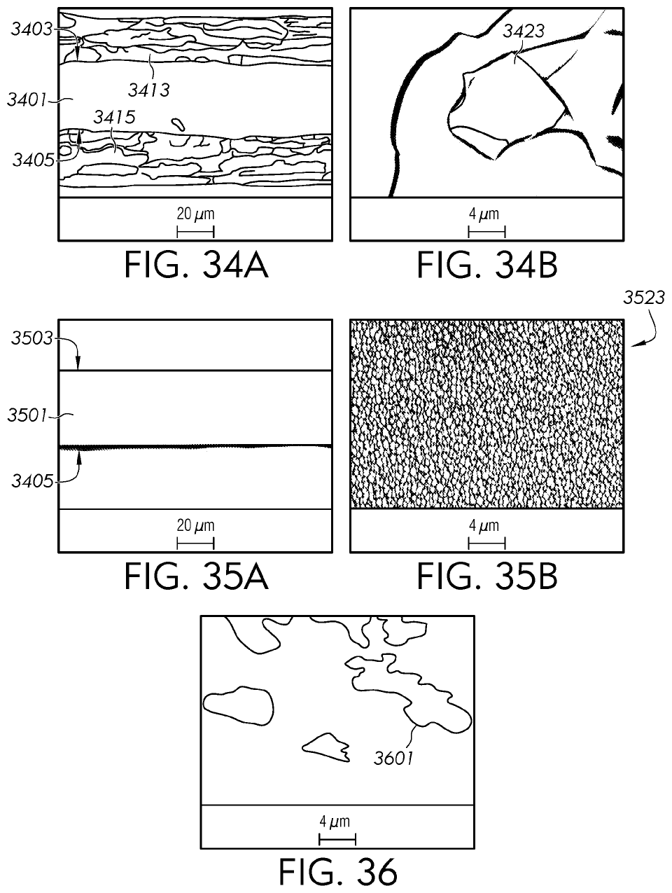

FIGS. 34A and 34B schematically represents SEM images of Example MM, where the foldable substrate was treated with a solution of 0.5 M H₂SiF₆ at 50° C. without agitation for 30 minutes. FIGS. 35A and 35B schematically represents SEM images of Example 4, where the foldable substrate was treated with a solution of 0.5 M H₂SiF₆ and 3 M H₂SO₄ at 50° C. without agitation for 30 minutes. As shown in FIG. 34A, there are layers 3413 and 3415 of redeposited silica formed on the first major surface 3403 and the second major surface 3405 of the foldable substrate 3401. In contrast, FIG. 35A shows substantially no silica material redeposited on the first major surface 3503 or the second major surface 3405 of the foldable substrate 3501. This is confirmed by the fine texture 3523 shown on the first major surface in FIG. 35B compared to the large surface irregularities 3423 of the redeposited silica layer on the first major surface in FIG. 34B. Consequently, adding a mineral acid (e.g., 1 M or more) can reduce redeposition of silica when using a solution of fluorosilicic acid.

TABLE 7
Conditions and Appearance of Examples 4-11 and MM

| | | Temp | Time | | | |
|---|---|---|---|---|---|---|
| Ex. | Solution | (° C.) | (min) | Agitation | | Appearance |
| MM | 0.5M H₂SiF₆ | 50 | 30 | n/a | | Large silica |
| | | | | | | redeposition |
| 4 | 0.5M H₂SiF₆ + 5M H₂SO₄ | 50 | 30 | n/a | | Clear, |
| | | | | | | fine texture |
| 5 | 0.5M H₂SiF₆ + 3M H₂SO₄ | 20 | 30 | n/a | | Visible stains |
| 6 | 0.5M H₂SiF₆ + 3M H₂SO₄ | 20 | 30 | 55 | mm/s | Small particles |
| 7 | 0.5M H₂SiF₆ + 4.5M H₂SO₄ | 20 | 30 | 200 | mm/s | Clear |
| 8 | 0.5M H₂SiF₆ + 4.5M H₂SO₄ | 25 | 30 | 55 | mm/s | Clear |
| 9 | 0.5M H₂SiF₆ + 4.5M H₂SO₄ | 25 | 30 | 35 | mm/s | Small particles |
| 10 | 0.5M H₂SiF₆ + 4.5M H₂SO₄ | 30 | 30 | 55 | mm/s | Clear |
| 11 | 0.5M H₂SiF₆ + 4.5M H₂SO₄ | 30 | 30 | 35 | mm/s | Large streaks |

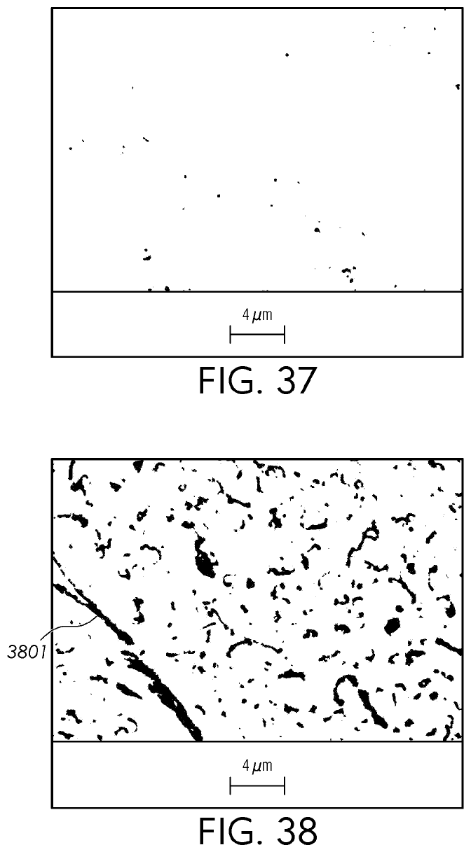

FIG. 36 schematically represents an SEM image of Example 6, which was treated without agitation at the conditions shown in Table 7. As shown in FIG. 36, there are stains 3601 that are noticeably lighter than the rest of the surface. In contrast, only small particles are visible in FIG. 37 corresponding to Example 7 that was treated with agitation of 55 mm/s. Consequently, agitation is able to reduce the redeposition of silica on the surface of the foldable substrate. As discussed above, it is believed that agitation reduces the buildup of silica in the solution near the surface, which reduces redeposition on the surface.

The conditions for Examples 7-11 are also shown in Table 7. As noted in Table 7, Examples 7-8 and 10 are clear, demonstrating that agitation of 55 mm/s is sufficient to avoid redeposition of silica when using a 0.5 M H₂SiF₆+4.5 M H₂SO₄ solution at 25° C. or 30° C. Although not shown, Example 9 had small particles (similar to FIG. 37), which suggests that lower agitation rates than that of Example 9 (35 mm/s) may not be sufficient to avoid redeposition of silica. Examples 10-11 were treated at 30° C. instead of 25° C. (as for Examples 8-9). FIG. 38 schematically represents an SEM image of Example 11, where large streaks 3801 are visible. Example 11 was agitated at 35 mm/s while Example 10 was agitated at 55 mm/s. This indicates that 55 mm/s is sufficient to avoid redeposition while 35 mm/s is not under these conditions.

Table 8 present the conditions and appearance of Examples 12-21. In Tables 8-9, the designation “X+Y” for time indicates that the foldable substrate was treated with the solution for “X” minutes, rinsed with deionized water, and then further treated with the solution for “Y” minutes. Examples 12-14 were treated with a 0.1 M H₂SiF₆ solution. Example 14 (treated at 40° C.) was hazy while Examples 12-13 (treated at 25° C. or 32° C.) were not hazy. This suggests that decreasing the temperature of the solution reduces the extent of silica redeposition. Further, Examples 12-14 (0.1 M H₂SiF₆) have noticeable discoloration while Examples 15-17 (0.5 M H₂SiF₆) and Examples 18-20 (1 M H₂SiF₆) do not have noticeable discoloration. This suggests that increasing the concentration of H₂SiF₆ (e.g., above 0.1 M H₂SiF₆, 0.3 M H₂SiF₆ or more, from 0.5 M H₂SiF₆ to 1 M H₂SiF₆) reduces the redeposition of silica.

TABLE 8
Conditions and Appearance of Examples 12-21

| | | Temp | | | | |
|---|---|---|---|---|---|---|
| Ex. | Solution | (° C.) | Time (min) | Agitation | | Appearance |
| 12 | 0.1M H₂SiF₆ | 25 | 10 + 10 | 55 | mm/s | Pink |
| 13 | 0.1M H₂SiF₆ | 32 | 10 + 10 | 55 | mm/s | Light pink |
| 14 | 0.1M H₂SiF₆ | 40 | 10 + 10 | 55 | mm/s | Iridescent |
| | | | | | | and hazy |
| 15 | 0.5M H₂SiF₆ | 25 | 10 + 10 | 55 | mm/s | OK |
| 16 | 0.5M H₂SiF₆ | 32 | 10 + 10 | 55 | mm/s | OK |
| 17 | 0.5M H₂SiF₆ | 40 | 10 + 10 | 55 | mm/s | OK |
| 18 | 1M H₂SiF₆ | 25 | 10 + 10 | 55 | mm/s | OK |
| 19 | 1M H₂SiF₆ | 32 | 10 + 10 | 55 | mm/s | OK |
| 20 | 1M H₂SiF₆ | 40 | 5 + 5 | 55 | mm/s | OK |
| 21 | 0.5M H₂SiF₆ | 20 | 30 | 55 | mm/s | OK |

with 75 vol %
ethylene glycol

Example 21 was treated with 0.5 M H₂SiF₆ solution in 25 vol % water and 75 vol % ethylene glycol solvent. Compared to Examples MM and 15 (same H₂SiF₆ concentration as Example 21, with Example 21 having a longer treatment time than Example 15), Example 21 does not have any noticeable discoloration or haziness despite the increase duration of the treatment. This suggests that reducing the water content with an organic glycol can reduce redeposition of silica.

Table 9 presents the conditions and pen drop height of Examples 22-31. Examples 22-26 were not treated with an alkaline detergent solution while Examples 27-31 were treated with an alkaline detergent solution (2 wt % SemiClean with a pH of 13) at 60° C. for 5 min after treatment with the stated “solution” in Table 9. As shown in Table 9 for Examples 22-25, without the alkaline detergent solution has a pen drop height less than 5 cm. In contrast, Examples 28-30 has a pen drop height greater than 7 cm (more than 100% greater than the corresponding Example without treatment with the alkaline detergent solution). Also, the pen drop height of Examples 27-31 is greater than the corresponding pen drop height for Examples 22-26. This suggests that treatment with the alkaline detergent solution following treatment by the fluoride containing solution provides an unexpected benefits of increased pen drop height.

TABLE 9
Conditions and Pen Drop Height of Examples 22-31

| | | | | Pen Drop Height | Pen Drop Height |
|---|---|---|---|---|---|
| | | Temp | Time | (cm) without | (cm) with |
| Ex. | Solution | (° C.) | (min) | Alkaline Detergent | Alkaline Detergent |
| 22/27 | 0.1M H₂SiF₆ | 24 | 11 + 11 | 2.8 | 3.2 |
| 23/28 | 0.1M H₂SiF₆ | 24 | 3.9 + 3.9 | 4.6 | 9.6 |
| 24/29 | 0.1M H₂SiF₆ | 40 | 2.8 + 2.7 | 2.8 | 9.8 |
| 25/30 | 0.5M H₂SiF₆ | 40 | 0.9 + 0.8 | 2.6 | 7.6 |
| 26/31 | 0.5M H₂SiF₆ | 40 | 1.4 + 1.3 | 10.6 | 11.4 |

The above observations can be combined to provide methods of forming a foldable apparatus with improved impact resistance and/or good folding performance. Providing a glass-based substrate and/or a ceramic-based substrate can provide good dimensional stability, reduced incidence of mechanical instabilities, and/or good impact and puncture resistance. Methods of the aspects of the disclosure can increase a pen drop height that the foldable apparatus and/or foldable substrate can withstand (e.g., from about 20% to about 1000%, from about 20% to about 500%, from about 20% to about 100%). Methods of the aspects of the disclosure can use an alkaline solution and/or an alkaline detergent solution that is substantially free from fluorine, which can reduce materials handling costs both during treatment and for disposal of the solution. Solution of methods of the disclosure can be easily applied and then removed (e.g., rinsed away), for example, when the solution is substantially free of rheology modifiers. Methods of the disclosure can improve properties of the glass-based substrate by removing an outer layer without substantially reducing a substrate thickness of the foldable substrate (e.g., removing less than 500 nanometers, less than 100 nanometers). Removal of a substantially uniform outer layer while minimizing a treatment time can be facilitated through the choice of solution composition and concentrations therein.

In aspects, the foldable substrate can be contacted with an alkaline solution comprising a hydroxide-containing base before the foldable substrate is chemically strengthened. Providing the alkaline solution comprising the hydroxide-containing base can remove a layer from the surface of the foldable substrate, which can remove flaws from the surface and/or change a surface chemistry of the surface. The alkaline solution comprising the hydroxide-containing base can remove flaws extending more than 10 nm into the foldable substrate, for example, by removing a corresponding thickness from the surface. Contacting the foldable substrate with the alkaline solution comprising the hydroxide-containing base before the chemical strengthening can reduce the growth of flaws during the chemical strengthening, which can result in increased impact resistance and/or puncture resistance of the chemically strengthened foldable substrate while simultaneously facilitating good folding performance of the chemically strengthened foldable substrate. Removing a low thickness (e.g., about 100 nanometers or less) from the surface of the foldable substrate may improve properties of the surface with reduced processing expenses than removing a deeper thickness.

In aspects, the foldable substrate can be contacted with an alkaline detergent solution before the foldable substrate is chemically strengthened. Providing the alkaline detergent solution after an etching step can neutralize residual etchant, which can prevent surface defects and/or produce a more uniform thickness of the foldable substrate. Providing the alkaline detergent solution (e.g., after an etching step and/or before a chemical strengthening process) can neutralize and/or remove hydrogen (e.g., hydronium) enrichment at the surface of the foldable substrate, which might otherwise lead to large flaws as a result of stress corrosion during a subsequent chemical strengthening process. Providing the alkaline detergent solution (e.g., after an etching step and/or before a chemical strengthening process) may selectively act on surface flaws (e.g., removing, rounding, blunting) before removing material from other parts of the surface, which can increase the impact resistance and/or puncture resistance of the chemically strengthened foldable substrate without removing a substantial thickness from the surface of the foldable substrate. Removing a low thickness (e.g., about 100 nanometers or less) from the surface of the foldable substrate may improve properties of the surface with reduced processing expenses than removing a deeper thickness.

In aspects, the foldable substrate can be contacted with an alkaline detergent solution (e.g., second alkaline detergent solution) after the foldable substrate is chemically strengthened. Providing the second alkaline detergent solution after the chemical strengthening can remove residual material from the chemical strengthening, which can enable more even and complete treatment of the surface in subsequent processing. Providing the second alkaline detergent solution after the chemical strengthening can change a surface chemistry (e.g., neutralize and/or remove hydrogen (e.g., hydronium) enrichment that may be present as a result of the chemical strengthening) of the foldable substrate, which can increase an impact resistance and/or a puncture resistance of the chemically strengthened foldable substrate while simultaneously facilitating good folding performance of the chemically strengthened foldable substrate. Providing the second alkaline detergent solution after the chemical strengthening may selectively act on surface flaws (e.g., removing, rounding, blunting) before removing material from other parts of the surface, which can increase the impact resistance and/or the puncture resistance of the substrate without removing a substantial thickness from the surface of the foldable substrate. Removing a low thickness (e.g., about 100 nanometers or less) from the surface of the foldable substrate may improve properties of the surface with reduced processing expenses than removing a deeper thickness.

In aspects, the foldable substrate can be contacted with an alkaline detergent solution before the foldable apparatus is assembled. For example, the foldable substrate may not be further treated between being contacted with the alkaline detergent solution and the foldable apparatus being assembled, which can minimize complexity of the processing and associated costs. Providing the alkaline detergent solution at this position in methods can facilitate good bonding to the surface, for example, by providing a surface substantially free from contaminants, with desirable surface chemistry, and/or with a reduced extent and/or density of flaws. In further aspects, assembling the foldable apparatus can have the treated surface be opposite a display device (e.g., facing a user). In further aspects, a release liner, a display device, and/or a coating can be disposed over (e.g., attached using an adhesive, directly contacting) the treated surface of the foldable substrate.

The inventors of the present disclosure have unexpectedly discovered that increasing the pH of an acidic solution can reduce the formation of leached layer. Without wishing to be bound by theory, the acidic solution can leach cations (e.g., alkali metal ions, transition metal ions, metallic ions) from the surface to produce a leached layer. The fluorine-containing compound in the acidic solution of the present disclosure can etch match from the surface by removing material. Consequently, a leached layer may not be formed when the rate of etching is substantially equal to or greater to the rate of leaching. At the same time, fluorine-containing crystals can be deposited when the pH of the acidic solution is too high, and the fluorine-containing crystals can cause portions of the surface to be etched (or leached) unevenly. In view of the above considerations and as shown in the Examples below, it has been unexpectedly discovered that providing the acidic solution with a pH of about 3 or more (e.g., from about 3.3 to about 3.5) can provide a foldable substrate that is substantially free from a leached surface layer.

Also, the inventors of the present disclosure have unexpectedly discovered methods for decreasing the redeposition of silica when etching with a fluorosilicic acid solution. For example, the formation of a silica layer during treatment with a fluorosilicic acid solution can be minimized by (1) reducing the concentration of SiF₆⁻ anions (e.g., by increasing a concentration of H⁺ or hydronium ions and/or by decreasing the temperature of the solution), (2) reducing the water content of solution (e.g., using a solution containing an organic glycol), or (3) decreasing supersaturation of silica-like compounds near the surface (e.g., through agitation and/or rinsing the substrate). Without wishing to be bound by theory, increasing the concentration of H⁺ or hydronium ions can reduce the concentration of SiF₆⁻ anions by shifting the equilibrium between H₂SiF₆ and 2H⁺+SiF₆ towards H₂SiF₆. Without wishing to be bound by theory, decreasing the temperature of solution can decrease the concentration of SiF₆ anions since the reaction from H₂SiF₆ and 2H⁺+SiF₆⁻ is endothermic. Without wishing to be bound by theory, agitating the foldable substrate during step 3933 can decrease a supersaturation of silica-like compounds near the surface.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error, and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

1. A method of forming a foldable apparatus comprising:
chemically strengthening an existing first major surface of a foldable substrate to form a first compressive stress region extending to a first depth of compression from the existing first major surface of the foldable substrate; and then
contacting the existing first major surface of the foldable substrate with an acidic solution comprising a first temperature for a first period of time to remove an outer layer from the existing first major surface to form a new first major surface, the outer layer comprising a thickness ranging from about 1 nanometer to about 3 micrometers, the first temperature ranges from about 20° C. to about 55° C., and the acidic solution comprises a pH ranging from about 3.3 to about 3.5 and a fluorine-containing compound.

2. The method of claim 1, wherein the fluorine-containing compound comprises one or more of HF, NH₄F, or combinations thereof.

3. The method of claim 1, wherein a weight percent (wt %) of the fluorine-containing compound in the acidic solution ranges from about 1 wt % to about 10 wt %.

4. The method of claim 1, wherein an average transmittance of the foldable apparatus from 360 nm to 400 nm is less than 93%.

5. The method of claim 1, wherein an absolute value of a difference between a first average transmittance between 360 nm to 400 nm and a second average transmittance between 700 nm and 750 nm is 1% or less.

6. The method of claim 1, wherein the foldable apparatus comprises a CIE a* value from about −0.01 to about 0.01, a CIE b* value from about −0.15 to about 0.1, or combinations thereof.

7. The method of claim 1, wherein a color difference ΔE of the foldable apparatus to an identical foldable substrate subjected to the chemically strengthening but not further treated is about 0.3 or less.

8. The method of claim 1, wherein the foldable substrate comprises a first thickness defined between the existing first major surface and an existing second major surface ranges from about 25 micrometers to about 200 micrometers.

9. The method of claim 1, wherein the first compressive stress region comprises a maximum first compressive stress of about 500 MegaPascals or more.

10. A method of forming a foldable apparatus comprising:
contacting an existing first major surface of a foldable substrate with a solution comprising fluorosilicic acid at a first temperature for at least a first period of time to remove an outer layer from the existing first major surface to form a new first major surface, the outer layer comprising a thickness ranging from about 1 nanometer to about 3 micrometers, the first temperature ranges from about 20° C. to about 55° C., wherein a concentration of the fluorosilicic acid is 0.3 molar or more; and
agitating the foldable substrate during the contacting.

11. The method of claim 10, wherein the first temperature is from about 24° C. to about 40° C.

12. The method of claim 10, further comprising rinsing the foldable substrate with deionized water at least once during the contacting.

13. The method of claim 10, wherein the rinsing occurs at least every 10 minutes during the contacting.

14. The method of claim 10, wherein the solution further comprises 1 molar or more of a mineral acid.

15. The method of claim 1, wherein the solution comprises a pH or 2 or less.

16. The method of claim 10, wherein the solution further comprises an organic glycol, wherein a ratio of water to the organic glycol is about 0.5 or less.

17. The method of claim 10, wherein the foldable substrate comprises a first thickness defined between the existing first major surface and an existing second major surface ranges from about 25 micrometers to about 200 micrometers.

18. The method of claim 10, further comprising, after the contacting, contacting the first major surface with an alkaline detergent solution comprising a second temperature for a second period of time under agitation.

19. The method of claim 18, wherein the alkaline detergent solution comprises a pH ranges from about 12 to about 14.

20. The method of claim 10, wherein a first pen drop threshold height of the foldable substrate after the contacting the first major surface of the foldable substrate with the alkaline detergent solution is from about 20% to about 1,000% more than a second pen drop threshold height of a second foldable substrate that is subject treated identically to the foldable substrate but is not contacted with the alkaline detergent solution.
